(19) United States
(12) Patent Application Publication
(10) Pub. No.: US 2019/0228675 A1
(43) Pub. Date: Jul. 25, 2019

(54) METHOD AND SYSTEM FOR PROVIDING PHYSICAL ACTIVITY INSTRUCTION

(71) Applicant: Swing AI, Inc., COLUMBIA, MD (US)

(72) Inventors: RICK GERITZ, Baltimore, MD (US); JOSEPH PLECKER, BALTIMORE, MD (US); JOHN BARBER, RESTON, VA (US); GEORGE HERON, BALTIMORE, MD (US)

(73) Assignee: Swing AI, Inc., COLUMBIA, MD (US)

(21) Appl. No.: 16/256,541

(22) Filed: Jan. 24, 2019

Related U.S. Application Data
(60) Provisional application No. 62/621,339, filed on Jan. 24, 2018.

(51) Int. Cl. G09B 19/00; G06F 16/78; A63B 71/06

(52) U.S. Cl. CPC G09B 19/0038; G06F 16/7867; A63B 2102/32; A63B 2071/0647; A63B 2071/065; A63B 71/0622

(57) ABSTRACT

Methods and systems described herein may provide a scalable capability for generating personalized analytics and a personalized multi-lesson roadmap of two-way interactive digital instruction for a physical activity for a multiplicity of physical activity participants by a multiplicity of physical activity instructors.

### CROSS REFERENCE TO RELATED APPLICATIONS

This application claims priority from U.S. Provisional Application No. 62/621,339, titled “Method and System for Providing Physical Activity Instruction,” filed Jan. 24, 2018, the entirety of which is incorporated by reference herein.

### BRIEF DESCRIPTIONS OF THE DRAWINGS

FIG. 1 depicts a process for transmitting a physical activity participant's current performance level and performance goal to a central repository according to an embodiment of the disclosure.

FIG. 2 depicts a process for transmitting multi-perspective videos of a physical activity participant's movements to a central repository according to an embodiment of the disclosure.

FIG. 3 depicts a representative embodiment of a process for transmitting multi-perspective videos of a physical activity participant's movements to a central repository according to an embodiment of the disclosure.

FIG. 4 depicts a hierarchical taxonomy that defines movements and submovements within a physical activity according to an embodiment of the disclosure.

FIG. 5 depicts a representative embodiment of a standardized evaluative scoring framework for movements and submovements within a physical activity according to an embodiment of the disclosure.

FIG. 6 depicts a process for obtaining a personalized, performance-level-based pass or fail status associated with the numeric score for specific submovements within the physical activity according to an embodiment of the disclosure.

FIG. 7 depicts a representative embodiment of the process for obtaining a personalized, performance-level-based pass or fail status associated with the numeric score for specific submovements within the physical activity according to an embodiment of the disclosure.

FIG. 8A depicts a hierarchical taxonomy that defines faults associated with movements and submovements within a physical activity according to an embodiment of the disclosure.

FIG. 8B depicts a hierarchical taxonomy that defines faults associated with movements and submovements within a physical activity according to an embodiment of the disclosure.

FIG. 9 depicts a representative embodiment of a hierarchical taxonomy that defines faults associated with movements and submovements within a physical activity according to an embodiment of the disclosure.

FIG. 10 depicts a process for expert review and quantitative assessment of the physical activity participant's movements within a physical activity according to an embodiment of the disclosure.

FIG. 11 depicts a representative embodiment of a technology-enabled workflow solution to achieve highly-scalable efficiency and speed in standardized scoring of the movements and submovements of a multiplicity of physical activity participants according to an embodiment of the disclosure.

FIG. 12 depicts a process for regionally pooling the collective instructive capacity of a multiplicity of physical activity instructors to handle the demand to evaluate, score and instruct a multiplicity of physical activity participants according to an embodiment of the disclosure.

FIG. 13 depicts a process for regionally aggregating the multi-perspective physical activity videos transmitted by a multiplicity of physical activity participants into a centralized repository where a multiplicity of regional physical activity instructors can view, score and provide instruction on the videos and/or participants according to an embodiment of the disclosure.

FIG. 14 depicts a process in which a personalized multi-lesson roadmap of digital instruction for a physical activity participant is generated by an algorithm according to an embodiment of the disclosure.

FIG. 15A depicts a step of an algorithm for the generation of a personalized multi-lesson roadmap of digital instruction for a physical activity participant according to an embodiment of the disclosure.

FIG. 15B depicts a step of an algorithm for the generation of a personalized multi-lesson roadmap of digital instruction for a physical activity participant according to an embodiment of the disclosure.

FIG. 15C depicts a supporting function of an algorithm for the generation of a personalized multi-lesson roadmap of digital instruction for a physical activity participant according to an embodiment of the disclosure.

FIG. 15D depicts a supporting function of an algorithm for the generation of a personalized multi-lesson roadmap of digital instruction for a physical activity participant according to an embodiment of the disclosure.

FIG. 16 depicts an embodiment of the personalized lesson delivery process for a personalized multi-lesson roadmap of digital instruction that is mapped to an individual physical activity participant's movement subelements and profile elements according to an embodiment of the disclosure.

FIG. 17 depicts an embodiment of a personalized, multi-lesson roadmap of digital instruction for a physical activity participant according to an embodiment of the disclosure.

FIG. 18 depicts a process for automatically aggregating instructional content that comprises and automatically generates the lessons within the personalized multi-lesson roadmap of digital instruction for a physical activity participant according to an embodiment of the disclosure.

FIG. 19 depicts a representative embodiment of the workflow for an automated coaching script engine according to an embodiment of the disclosure.

FIG. 20 depicts an embodiment of an annotation manager interface for instructors to use to create instructional annotations associated with the physical activity movement videos transmitted by physical activity participants according to an embodiment of the disclosure.

FIG. 21 depicts an embodiment of a personalized lesson in participant facing interface according to an embodiment of the disclosure.

FIG. 22 depicts a goal-driven index score generation process in which a personalized, goal-driven index score analytic is created for a physical activity participant according to an embodiment of the disclosure.

FIG. 23A depicts steps of an algorithm for the generation of a personalized, goal-driven index score analytic for a physical activity participant according to an embodiment of the disclosure.

FIG. 23B depicts steps of an algorithm for the generation of a personalized, goal-driven index score analytic for a physical activity participant according to an embodiment of the disclosure.

FIG. 23C depicts a step of an algorithm for the generation of a personalized, goal-driven index score analytic for a physical activity participant according to an embodiment of the disclosure.

FIG. 24 depicts a process for recursive goal-driven index score calculation and updating to maintain a current, living index score with new inputs over time according to an embodiment of the disclosure.

FIG. 25 depicts an embodiment of an index score interface for physical activity participants, showing a high level composite score as a circular graph and individual movement subelement scores as a table view where each failed subelement (indicated by an upward pointing arrow) is tied to a personalized lesson to help pass the participant on that subelement and improve the participant's index score according to an embodiment of the disclosure.

FIG. 26 depicts an automated generation process that produces a regressed movement checklist for a physical activity participant according to an embodiment of the disclosure.

FIG. 27 depicts an automated generation process that produces a regressed movement checklist for a physical activity participant according to an embodiment of the disclosure.

FIG. 28 depicts a retroactive failing capability in an instructor facing interface which causes an item to appear on the participant-facing regressed movement checklistaccording to an embodiment of the disclosure.

FIG. 29 depicts a retroactive failing capability in an instructor facing interface which causes an item to appear on the participant-facing regressed movement checklistaccording to an embodiment of the disclosure.

FIG. 30 depicts an embodiment of a regressed movement checklist interface for a physical activity participant according to an embodiment of the disclosure.

FIG. 31 depicts an embodiment of a table defining the attributes of a physical activity participant enabling the functioning of the method and system for providing physical activity instruction according to an embodiment of the disclosure.

FIG. 32 depicts an embodiment of a table defining other entities related to a physical activity participant enabling the functioning of the method and system for providing physical activity instruction according to an embodiment of the disclosure.

FIG. 33 depicts an embodiment of a table defining the attributes of a lead instructor and assistant instructor enabling the functioning of the method and system for providing physical activity instruction according to an embodiment of the disclosure.

FIG. 34 depicts an embodiment of a table defining other entities related to a lead instructor enabling the functioning of the method and system for providing physical activity instruction according to an embodiment of the disclosure.

FIG. 35 depicts an embodiment of a table defining the attributes of a physical activity participant video enabling the functioning of the method and system for providing physical activity instruction according to an embodiment of the disclosure.

FIG. 36 depicts an embodiment of a table defining the attributes of a physical activity participant video enabling the functioning of the method and system for providing physical activity instruction according to an embodiment of the disclosure.

FIG. 37 depicts an embodiment of a table defining the attributes of a physical activity participant video enabling the functioning of the method and system for providing physical activity instruction according to an embodiment of the disclosure.

FIG. 38 depicts an embodiment of a table defining the attributes of a physical activity participant video enabling the functioning of the method and system for providing physical activity instruction according to an embodiment of the disclosure.

FIG. 39 depicts an embodiment of a table defining other entities related to a physical activity participant video enabling the functioning of the method and system for providing physical activity instruction according to an embodiment of the disclosure.

FIG. 40 depicts a taxonomy of physical activity movements, submovements, and submovement faults utilized for instructor evaluation, scoring and assignment of submovement faults on physical activity participant movement videos according to an embodiment of the disclosure.

FIG. 41 depicts a mapping table of perspectives (e.g., video camera angles) for various movement subelements for video capture according to an embodiment of the disclosure.

FIG. 42 depicts an embodiment of a table defining the attributes of a personalized multi-lesson roadmap of digital lessons enabling the functioning of the method and system for providing physical activity instruction according to an embodiment of the disclosure.

FIG. 43 depicts an embodiment of a table defining the attributes of a personalized multi-lesson roadmap of digital lessons enabling the functioning of the method and system for providing physical activity instruction according to an embodiment of the disclosure.

FIG. 44 depicts an embodiment of a table defining other entities related to a personalized multi-lesson roadmap of digital lessons enabling the functioning of the method and system for providing physical activity instruction according to an embodiment of the disclosure.

FIG. 45 depicts an embodiment of a table defining the attributes of a personalized lesson enabling the functioning of the method and system for providing physical activity instruction according to an embodiment of the disclosure.

FIG. 46 depicts an embodiment of a table defining other entities related to a personalized lesson enabling the functioning of the method and system for providing physical activity instruction according to an embodiment of the disclosure.

FIG. 47 depicts a mapping table of primary drill videos mapped to physical activity submovement faults according to an embodiment of the disclosure.

FIG. 48 depicts a mapping table of primary drill videos mapped to physical activity submovement faults according to an embodiment of the disclosure.

FIG. 49 depicts a mapping table of primary drill videos mapped to physical activity submovement faults according to an embodiment of the disclosure.

FIG. 50 depicts a mapping table of primary drill videos mapped to physical activity submovement faults according to an embodiment of the disclosure.

FIG. 51 depicts a mapping table of secondary drill videos mapped to physical activity submovement faults according to an embodiment of the disclosure.

FIG. 52 depicts a mapping table of secondary drill videos mapped to physical activity submovement faults according to an embodiment of the disclosure.

FIG. 53 depicts an embodiment of a table defining the attributes of a primary drill video enabling the functioning of the method and system for providing physical activity instruction according to an embodiment of the disclosure.

FIG. 54 depicts an embodiment of a table defining the attributes of a secondary drill video enabling the functioning of the method and system for providing physical activity instruction according to an embodiment of the disclosure.

FIG. 55 depicts a mapping table of law of ball flight videos mapped to physical activity submovement faults according to an embodiment of the disclosure.

FIG. 56 depicts a mapping table of law of ball flight videos mapped to physical activity submovement faults according to an embodiment of the disclosure.

FIG. 57 depicts a mapping table of law of ball flight videos mapped to physical activity submovement faults according to an embodiment of the disclosure.

FIG. 58 depicts a mapping table of law of ball flight videos mapped to physical activity submovement faults according to an embodiment of the disclosure.

FIG. 59 depicts an embodiment of a table defining the attributes of a law of ball flight video enabling the functioning of the method and system for providing physical activity instruction according to an embodiment of the disclosure.

FIG. 60 depicts a mapping table of coaching scripts mapped to physical activity submovement faults and annotation types that are used by the coaching script engine, the coaching scripts mapping table and the coaching script engine workflow function together to prompt instructors with coaching content within an individual participant's lesson that is personalized for the participant's specific subelement fault, pass/fail status, and numeric count of additional participant movement videos transmitted to the instructor within the lesson according to an embodiment of the disclosure.

FIG. 61 depicts an embodiment of a table defining the attributes of an instructor voice annotation audio file enabling the functioning of the method and system for providing physical activity instruction according to an embodiment of the disclosure.

FIG. 62 depicts an embodiment of a table defining other entities related to an instructor voice annotation audio file enabling the functioning of the method and system for providing physical activity instruction according to an embodiment of the disclosure.

FIG. 63 depicts an embodiment of a table defining the attributes of an instructor drawing annotation image file enabling the functioning of the method and system for providing physical activity instruction according to an embodiment of the disclosure.

FIG. 64 depicts an embodiment of a table defining other entities related to an instructor drawing annotation image file enabling the functioning of the method and system for providing physical activity instruction according to an embodiment of the disclosure.

FIG. 65 depicts an index score boost factor table utilized by the index score generation algorithm to calculate the goal-driven index score analytic for a physical activity participant according to an embodiment of the disclosure.

FIG. 66 depicts an embodiment of a table defining the attributes of a goal-driven index score analytic enabling the functioning of the method and system for providing physical activity instruction according to an embodiment of the disclosure.

FIG. 67 depicts an embodiment of a table defining entities related to a goal-driven index score analytic enabling the functioning of the method and system for providing physical activity instruction according to an embodiment of the disclosure.

FIG. 68 depicts an embodiment of a table defining the attributes of a regressed movement checklist enabling the functioning of the method and system for providing physical activity instruction according to an embodiment of the disclosure.

FIG. 69 depicts an embodiment of a table defining other entities related to a regressed movement checklist enabling the functioning of the method and system for providing physical activity instruction according to an embodiment of the disclosure.

FIGS. 70A-70D depict an example embodiment of a movement subelement weighting table that may be utilized by a supporting function of the algorithm for generation of personalized roadmap of digital lessons called the swing improvement percentage pie chart according to an embodiment of the disclosure.

FIG. 71 shows a computer system according to an embodiment of the disclosure.

FIG. 72 shows a computer system according to an embodiment of the disclosure.

### DETAILED DESCRIPTION OF SEVERAL EMBODIMENTS

Digital instruction in physical activities for masses of participants may be improved by precise, expert-driven personalized analytics of an individual's physical activity movements and/or by a personalized, multi-lesson roadmap of two-way interactive instruction between participant and instructor that is based upon those personalized analytics. It may be of further benefit to embody systems for providing digital instruction and analytics experience for physical activities in a pervasive consumer platform, such as the smartphone, while offering expert-driven, personalized analytics of individual participant movements and a personalized, multi-lesson roadmap of two-way interactive instruction between participant and instructor that is based upon those personalized analytics. When compared with expensive, on-premise digital analytics and instruction systems that enable two-way interactive instruction between instructor and participant but reach only a small percentage of the mass numbers of physical activity participants due to their expense and inconvenient, time-consuming requirement to travel to an instructor's premises, disclosed systems may provide more efficient and widespread employment. When compared with inexpensive, or free, advertising-supported, digital instruction content for physical activities limited to one-way, instructor-to-participant broadcast instruction, disclosed systems may enhance the functionality with expert-driven personalized analytics on the participant's physical activity movements and/or with a personalized multi-lesson roadmap of two-way interactive instruction between participant and instructor based on those personalized participant analytics.

Example embodiments are discussed in detail below. While specific example embodiments are discussed, it should be understood that this is done for illustration purposes only. In describing and illustrating the example embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

Some embodiments disclosed herein may include a digital instruction and analytics system for physical activities that provides expert-driven, personalized analytics of the physical activity participants' movements and/or a personalized, multi-lesson roadmap of two-way interactive digital instruction between participant and instructor that is based upon those personalized analytics and widely available to millions of participants and thousands of instructors over a network connection via a pervasive consumer platform such as the smartphone.

Some embodiments may provide a digital experience for physical activity instruction between physical activity instructors and physical activity participants, such as, for example, golf instructors and golf players.

Some embodiments may provide an interactive process between physical activity instructors and physical activity participants, such as, for example, golf instructors and golf players, that may transmit the current performance level and performance goal of a physical activity participant, for example the average score and score goal of a golf player, to a central repository and/or may transmit multi-perspective videos of a physical activity participant's movements within the activity, for example multi-perspective videos of a golf player's golf swing capturing all swing elements and swing subelements, to a central repository.

Some embodiments may capture metadata about participant multi-perspective videos and transmit it to a central repository; for example, in golf: capturing the club used as selected from a normalized taxonomy of clubs such as driver, fairway wood, hybrid, iron, wedge; capturing the club type used as selected from a normalized taxonomy of club types such as driver, fairway wood (3 fairway wood, 4 fairway wood, 5 fairway wood, 7 fairway wood, 9 fairway wood), hybrid (19-20 loft, 21-22 loft, 23-24 loft, 25-26 loft, 27-28 loft, 29+ loft)), iron (2 long iron, 3 long iron, 4 long iron, 5 mid iron, 6 mid iron, 7 mid iron, 8 short iron, 9 short iron), wedge (gap wedge, lob wedge, pitching wedge, sand wedge); in addition capturing what happened to the ball as selected from a normalized list of attributes including shot shape (left, straight, right), trajectory (high, medium, low) and contact (solid, poor); capturing where the physical activity took place based on normalized data selection including golf course or practice range; capturing the geolocation where the swing took place; capturing the local weather conditions where the swing took place.

Some embodiments may define movements within a physical activity according to a hierarchical taxonomy of movements, for example, in golf, a taxonomy of movements may include 5 swing elements: Setup, Turn, Lever, Path and Release; where these swing elements contain 21 swing subelements: Setup (Lead Hand Grip, Trail Hand Grip, Posture, Stance, Ball Position, Knee Flex and Alignment), Turn (Upper Body, Lower Body, Footwork and Tempo), Lever (Hinge, Lead Arm, Trail Arm, Lead Wrist/Club Face and Trail Wrist), Path (Shaft and Lead Arm), Release (Body Sequence, Arms and Hands, Shaft). These movements and submovements may be defined in a data attribute table.

Some embodiments may define the physical activity faults associated with movements in the physical activity taxonomy via a corresponding taxonomy of faults. For example in golf the taxonomy of golf swing faults may include 51 faults, within 21 swing subelements, within 5 swing elements as listed here; faults are shown in parentheses and a right arrow separates element from subelement: Setup>Lead Hand Grip (Strong, Weak), Setup>Trail Hand Grip (Strong, Weak), Setup>Posture (C Posture, Rigid Posture, Basic), Setup>Stance (Wide, Narrow), Setup>Ball Position (Forward, Back), Setup>Knee Flex (Straight, Flexed), Setup>Alignment (Open, Closed), Turn>Upper Body (Sway Back, Sway Forward, Dropping, Basic), Turn>Lower Body (Sway Back, Sway Forward, Basic), Turn>Footwork (Rolling), Turn>Tempo (Backswing, Downswing, Basic), Lever>Hinge (Early, Late), Lever>Lead Arm (Bent), Lever>Trail Arm (Tucked, Flying), Lever>Lead Wrist/Club Face (Bowed/Closed, Cupped/Open), Lever>Trail Wrist (Flexed, Extended), Path>Shaft (Steep, Shallow), Path>Lead Arm (High, Low), Release>Body Sequence (Hang Back, Sway Forward, Early Extension, Basic), Release>Arms and Hands (Casting, Chicken Wing, Tucked, Flipping, Basic), Release>Shaft (Over and Low, Over and High, Basic). These physical activity faults may be defined in a data attribute table.

Some embodiments may provide a standardized evaluative scoring framework for movements within a physical activity, for example a numeric scale of 1 to 10 for scoring a participant's aptitude at a multiplicity of specific swing subelements, like Lead Hand Grip, that are associated with a swing element, like Setup, in the physical movement taxonomy of a golf swing.

Some embodiments may provide a personalized pass or fail status associated with the numeric score for each specific movement within the physical activity; where personalized pass and fail statuses may be obtained via a data attribute table that associates tiered thresholds for pass and fail status with different individual participants' performance goal inputs; for example, in golf, providing a pass threshold for numeric scores of “4 out of 10” and higher on specific swing subelements when the participant's performance goal input is “Break 100”, providing a pass threshold for numeric scores of “6 out of 10” and higher on specific swing subelements when the participant's performance goal input is “Break 90”, and providing a pass threshold for numeric scores of “8 out of 10” and higher on specific swing subelements when the participant's performance goal input is “Break 80.”

Some embodiments may provide review and subjective quantitative assessment of the physical activity participant's movements within the activity, for example a quantitative assessment using a standard scoring framework based on numeric scores on a scale of 1 to 10 for each swing subelement, a personalized pass or fail status for each swing subelement, and a fault associated with each failed swing subelement of a golf player's golf swing.

Some embodiments may utilize a technology-enabled workflow solution to achieve highly scalable efficiency and speed in standardized scoring of the movements of a multiplicity of physical activity participants, for example a technology-enabled workflow solution for golf instructors to assign numeric scores, personalized pass and fail statuses, and faults on failed subelements across all the swing subelements of a player's golf swing.

Some embodiments may regionally pool the collective instructive capacity of a multiplicity of physical activity instructors, such as golf instructors, to handle the demand to score, evaluate and instruct a multiplicity of physical activity participants, for example golf players, scaling without limit to the demand of any number of physical activity participants.

Some embodiments may regionally aggregate the multi-perspective physical activity videos submitted by a multiplicity of physical activity participants, for example the swing videos of golf players, into a centralized queue where a multiplicity of physical activity instructors, for example a multiplicity of golf instructors, can claim them to maximize instructor utilization and teaching time to near 100% and to maximize instructor earning potential.

Some embodiments may generate a personalized multi-lesson roadmap of digital instruction for physical activity participants via a personalized roadmap generation algorithm and/or may automatically create a personalized roadmap of lessons, where the roadmap is a logical container for a collection of personalized lessons and each personalized lesson is a logical container for a collection of personalized instructional content.

Some embodiments may utilize a roadmap generation algorithm that may perform some or all of the following functions: reading in the outputs of the instructor's subjective quantitative assessment of the physical activity participant's movements within the activity; specifically reading in a list of movements that have a status of failed and have a fault associated with each of these failed movements during the instructor's evaluation and scoring of the participant's submitted multi-perspective movement videos; creating a series of logical containers called personalized lessons where each lesson corresponds to one of the failed movement elements and its associated movement subelement fault as evaluated by the instructor; for example, in golf, a golf player who has failed the Lead Hand Grip subelement of the Setup element of a golf swing with an associated “Strong” fault may have a lesson container created by the personalized roadmap generation algorithm that contains a lesson to correct the “Strong” fault in the Lead Hand Grip movement; creating a sequential locking and unlocking access permission mechanism that ensures that a participant must have a lesson status of passed or skipped on the first lesson in their personalized roadmap of lessons in order to access the second, must have a lesson status of passed or skipped on the second lesson in order to access the third, and so forth; provides a physical activity improvement analytic that shows the participant the relative weight and importance that improving different elements of movement within the physical activity will have upon the overall improvement in the physical activity; for example, in golf, providing a pie chart visualization that shows a golfer that 38% of their overall swing improvement will come from improvements within the Setup element, 24% of overall swing improvement will come from improvement within the Turn element, 14% of overall swing improvement will come from improvement within the Lever element, and 24% of overall swing improvement will come from improvement within the Release element; provides a percent completion metric showing the participant how far through the lessons in their personalized roadmap of instruction they are at present.

In some embodiments, the algorithm may utilize an automated personalized lesson creation process that may include some or all of the following functions: uses an automated instructional content aggregation function that maps the movement subelement fault associated with a lesson to a primary drill video containing instruction on that specific subelement fault via a drill video data attribute table; uses an automatic instructional content aggregation function that maps the movement subelement fault associated with a lesson to a secondary drill video containing extended instruction on that specific subelement fault via a drill video data attribute table; provides a video capture path within the lesson for participant to capture an additional participant movement video of himself or herself and upload it to their instructor for re-evaluation and re-scoring and a reassessment of the pass or fail status on the movement subelement addressed by the lesson; utilizes a rules engine to govern and track the number of additional participant movement videos a participant is permitted to upload to their instructor for re-evaluation and re-scoring before a status of skipped is applied to the lesson; utilizes logic to hide or expose the secondary drill video associated with the lesson on a subelement fault where the logic hides the secondary drill video if the participant has failed the movement subelement one time and exposes the secondary drill video if the participant has failed the movement subelement two times; utilizes an automatic ball flight law content aggregation function that maps the movement subelement associated with a lesson to an explanatory video about the physical law of ball flight that is relevant to that movement subelement via a ball flight law video data attribute table; places an access mechanism such as hyperlink or video player to access drill videos and ball flight law videos within the lesson container of the participant; places a score and pass/fail visualization within the lesson container of the participant that reflects the current numeric score (1-10) and associated pass or fail status that the instructor has given the participant based on their most recently uploaded participant movement video; automatically provides access for the participant to the personalized instructor annotations of the participant's movement video created in the system by their instructor; annotation components automatically added to the lesson container include instructor drawings (markup) upon still images excerpted from the participant's movement video, an instructor voice annotation audio file introducing the lesson, an instructor voice annotation audio file complimenting the participant on what is positive in their most recent participant movement video, an instructor voice annotation audio file offering a primary critique of what is wrong in the participant's most recent participant movement video, and an instructor voice annotation audio file offering a secondary critique of what is wrong in the participant's most recent participant movement video; maintains a status of the participant's interaction with the lesson, including statuses of locked, unlocked, current, passed, failed, skipped; an example of the overall automated personalized lesson creation process in golf would be the ability to automatically aggregate into a lesson container for inclusion in the personalized roadmap of digital instruction the following items: instructional voice annotation and drawing (markup) annotation of the participant's motion video on a failed swing subelement such as Lead Hand Grip with a fault such as “Strong”; primary and secondary drill videos focused on correcting the “Strong” fault on the Lead Hand Grip swing subelement; a visualization showing a numeric score of “3 out of 10” and a status of “Fail” on the Lead Hand Grip subelement; workflow statuses on the lesson such as unlocked, current, and count of additional participant videos sent back to the instructor for the lesson; and a mechanism for the participant to transmit an additional video on the Lead Hand Grip subelement of their golf swing back to a centralized repository for further evaluation, scoring, and pass or fail statusing by the instructor.

In some embodiments, the algorithm may access a library of video instructional content maintained in a storage device and accessible via a network connection that may include some or all of the following: individual primary drill videos that are mapped 1:1 to movement subelement faults in the movement taxonomy where this mapping is maintained in the data attribute model; individual secondary drill videos that are mapped 1:1 to movement subelement faults in the movement taxonomy where this mapping is maintained in the data attribute model; individual ball flight law videos that are mapped 1:1 to movement subelements in the movement taxonomy where this mapping is maintained in the data attribute model.

In some embodiments, the algorithm may utilize a technology-enabled workflow solution to achieve highly scalable efficiency and speed in annotating the physical activity participant's movements with instructional inputs. Components of the instructional annotation that are made more efficient by the technology-enabled workflow solution may include: instructor drawings (markup) upon still images excerpted from the participant's movement video, an instructor voice annotation audio file introducing the lesson, an instructor voice annotation audio file complimenting the participant on what is positive in their most recent participant movement video, an instructor voice annotation audio file offering a primary critique of what is wrong in the participant's most recent participant movement video, and an instructor voice annotation audio file offering a secondary critique of what is wrong in the participant's most recent participant movement video.

In some embodiments, the algorithm may utilize an automated coaching script engine within the technology-enabled workflow solution for annotation that prompts instructors with personalized messages relevant to the individual participant's lesson, associated subelement fault, most recently uploaded participant movement video, numeric score and pass/fail/skip status on the lesson, and number of additional participant movement videos that have been uploaded for instructor re-evaluation and rescoring; the automated coaching script engine draws from a coaching script knowledge base containing professional coaching scripts written by top teaching professionals. The automated coaching script engine may match scripts from this knowledge base to each individual participant's lesson, associated subelement fault, most recently uploaded participant movement video, numeric score and pass/fail/skip status on the lesson, and number of additional participant movement videos that have been uploaded for instructor re-evaluation and rescoring using a data attribute table for coaching scripts. The automated coaching script may be state-based and capable of directing flow of instruction and media from wherever the players may be in their individual roadmap progression of instructive lessons; taking coaching scripts specifically written for each permutation in the coaching script data attribute table and matching them with the lesson attributes of lessons for individual participants enables the coaching script engine to guide instructors to record highly personalized voice annotations for delivery to participants.

In some embodiments, the algorithm may transmit the personalized multi-lesson roadmap of digital instruction, including the lesson content contained within the lesson containers within the roadmap, via a network connection, to the physical activity participant for lesson consumption, practice, submission of additional videos of movements to a centralized repository for further evaluation, instruction, scoring and pass or fail statusing, leading to learning and improvement of the physical activity.

In some embodiments, the algorithm may sequentially unlock and make available individual lessons on a physical activity participant's multi-lesson roadmap of personalized digital instruction when the physical activity participant has received a status of either passed or skipped on the previous lesson in their roadmap; for example, in golf, “Lesson 2” about the failed “Posture” subelement within the “Setup” element of their golf swing remains locked and unavailable to access until the player receives a status of either passed or skipped on “Lesson 1” in their roadmap about the “Lead Hand Grip” subelement within the “Setup” element of their golf swing; Once “Lesson 1” is associated with a passed or skipped status, then “Lesson 2” unlocks and becomes available for the player to access; the skipped status is automatically placed upon a participant's lesson when the instructor has reviewed two additional participant movement videos associated with the lesson and failed them both; a message recommending an in-person lesson on a skipped digital lesson is automatically sent to the participant when a digital lesson is failed twice and skipped.

In some embodiments, the algorithm may provide an interactive two-way (participant-to-instructor and instructor-to-participant) digital learning experience within a personalized multi-lesson roadmap of digital instruction for a physical activity where, for example; the interactive two-way digital learning experience begins with the instructor's evaluation, numeric scoring, and pass/fail statusing of movement subelements within the physical activity participant's initial multi-perspective movement videos. After the automated roadmap generation algorithm creates a personalized roadmap of digital instruction for the physical activity participant based upon these instructor inputs, the roadmap may be transmitted to the participant via a network connection and described as being sent to the participant by the instructor. The interactive two-way digital learning experience may continue as the physical activity participant reviews the first personalized lesson delivered to them from their instructor within the personalized roadmap of instruction, practices the instruction, captures an additional movement video, and transmits it to the instructor. The instructor may receive this additional movement video in the centralized repository, evaluate the movement subelement associated with the current lesson, score it, assign a pass/fail status to it, and, if failed, add personalized coaching annotation to it. The two-way digital learning experience then may transmit the instructor's continuing status of failed back to the participant along with additional coaching annotation content and a secondary drill video appended by the automated content aggregation engine, or, if passed, pass a status of passed back to the participant and the rules engine unlocks the next digital lesson in the participant's personalized roadmap of digital instruction. This two-way (participant-to-instructor and instructor-to-participant) interactive learning experience may continue through the player's completion of all lessons in their personalized roadmap of digital instruction. An example of the interactive two-way digital learning experience as it may occur in golf follows: a golf player consumes a personalized digital lesson on how to correct the “Strong” fault in the Lead Hand Grip swing subelement that they failed in the instructor's evaluation of their initial golf swing multiperspective videos; the golf player transmits a new golf swing video of their Lead Hand Grip to the instructor via the central repository where the instructor views the new movement video; the instructor may increase the numeric score for this player's performance on Grip and change the pass/fail status on the player's Grip lesson from fail to pass; the automated coaching script engine guides the instructor to communicate relevant, personalized audio annotation messages to the player; the player-facing interface is updated with the new numeric score and passing status; the workflow engine unlocks the next lesson on the player's personalized roadmap of instruction, for example a Lesson #2 on the Stance subelement of the Setup element of their golf swing.

In some embodiments, the algorithm may provide a personalized, goal-driven index score analytic, for example in golf a swing index, for an individual physical activity participant, such as a golf player, that may include an average of the player's numeric scores for all specific movements within the physical activity movement taxonomy compared against a goal-driven perfect score of 10 and/or may utilize a goal-driven index score algorithm to calculate this index; and;

In some embodiments, the algorithm may calculate the personalized index score analytic via a goal-driven index score algorithm that may operate as follows: the score of each component movement that the physical activity participant has failed during evaluation is augmented by a goal-driven boost factor before the index score average calculation is performed; the goal-driven boost factor ensures each physical activity participant receives a personalized index score that is presented in context of achieving the personalized goal which the participant entered into the system; for example, in golf, a player with a personalized goal of “break 100” in the system would receive a swing index where achieving a 10 means mastering the swing skills required to break a score of 100 in golf; continuing the example, if this player received failing scores of 1, 2 and 3 on several distinct swing elements, the goal-driven index score algorithm would boost these failing scores by a boost factor of 3 as established in a data attribute table to produce boosted swing element scores of 4, 5 and 6 respectively; if this player received passing scores of 4, 5, 6, 7, 8, or 9 on several other distinct swing elements, the goal-driven index score algorithm would boost these failing scores by a boost factors of 2, 2, 1, 1 and 1 as established in a data attribute table to produce boosted swing element scores of 6, 7, 7, 8, 9 and 10 respectively; similarly, if the player entered a goal of “break 90” into the system, they would receive a swing index where achieving a 10 means mastering the swing skills required to break a score of 90 in golf; the boost factors applied by the goal-driven index score algorithm for failing swing element scores of 1, 2, 3, 4 and 5 would be 3, 2, 2, 2 and 2 as established in a data attribute table to produce boosted scores of 4, 4, 5, 6 and 7 respectively; the boost factors applied by the goal-driven index score algorithm for passing swing element scores of 6, 7, 8 and 9 would be 2, 1, 1 and 1 as established in a data attribute table to produce boosted scores of 8, 8, 9 and 10 respectively; and so on with different goals receiving different boost factors applied to failing swing elements as specified by the boost factor data attribute table; the algorithm's use of the boost factor in calculating the goal-driven index score is analogous to grading test scores on a curve in a school classroom; both techniques are designed to assess human performance using a scoring mechanism that motivates and encourages learning by considering both the difficulty of the material and the performance level and goal of the learners.

In some embodiments, the algorithm may ensure that each time a physical activity participant, such as a golf player in golf, passes a lesson in their personalized roadmap of digital instruction their index score increases to reflect the passing score; this may connect the participant's index score directly to the participant's progress in passing personalized lessons as they make their way through their roadmap of personalized instruction.

In some embodiments, the algorithm may provide physical activity instructors the ability to reassess and retroactively fail physical activity participants on movement subelements that the physical activity participant has passed in prior instructor evaluations and to automatically add these retroactive fails to a participant-facing regressed movement checklist.

In some embodiments, each participant's personalized multi-lesson roadmap of digital instruction may include a sequence of lessons mapped to movement subelement faults identified by the instructor. Each lesson as part of the two-way, interactive instructor-to-participant and participant-to-instructor instruction mechanism may provide the capability for participants to transmit additional movement videos to the instructor to demonstrate improvement and try to achieve a status of pass on the lesson. Therefore participants may transmit multiple additional movement videos to the instructor over the course of time during their progress through the lessons of their personalized multi-lesson roadmap of instruction. While evaluating a transmitted participant movement video associated with a lesson and its associated movement subelement nearer the end of participant's roadmap, an instructor may notice a regression in another movement subelement associated with a lesson earlier in the participant's roadmap. A retroactive fail is the assignment of a fail status by an instructor to a participant on a movement subelement that the participant has passed in a previously transmitted movement video; when an instructor retroactively fails a participant on a movement subelement that the participant has previously passed, the retroactive fail capability may prompt the instructor to record a personalized retroactive fail voice annotation audio file and triggers the retrieval from the physical activity participant videos database of a video showing the participant passing the retroactively failed subelement, The retroactive fail capability may add the personalized voice annotation and the video of the participant passing the movement subelement to the participant's regressed movement checklist. The instructor-facing retroactive fail capability together with the participant-facing regressed movement checklist capability may enable the two-way, interactive instructor-to-participant and participant-to-instructor digital instruction process to guide participants when the movement subelements they have previously passed have shown regression and need instruction to return them to passing status. The capability may enable each participant's passing movement videos to become their own standard for correct movements going forward in time.

Some embodiments may provide a scalable, hierarchical resourcing capability that allows top national professionals in physical activity instruction, for example PGA Top 100 Golf Instructors, to recruit beneath them a large and extensible number of regional physical activity instructors, such as regional golf coaches, to support a high-volume of digital, instructional-roadmap-based physical activity instruction.

Some embodiments may provide a Physical Activity Instructor-facing process and interface, such as a process and interface for golf instructors, that may regionally pool instructive capacity via an Instructor-facing interface available via a network connection to a multiplicity of physical activity instructors, such as golf instructors, where a limitless number of instructors contribute their instructive capacity in one centralized service.

Some embodiments may regionally aggregate multi-perspective physical activity videos submitted by a multiplicity of physical activity participants, for example the swing videos of golf players, into a centralized queue within an Instructor-facing interface available via a network connection to a multiplicity of physical activity instructors, for example a multiplicity of golf instructors, who can access, view and score these videos and provide personalized instruction to physical activity participants; and;

Some embodiments may provide a taxonomy of movements and faults for a physical activity via an Instructor-facing interface available via a network connection to physical activity instructors, such as golf instructors, where for example in golf the taxonomy of movements includes 5 swing elements: Setup, Turn, Lever, Path and Release; 21 swing subelements within these swing elements: Setup (Lead Hand Grip, Trail Hand Grip, Posture, Stance, Ball Position, Knee Flex and Alignment), Turn (Upper Body, Lower Body, Footwork and Tempo), Lever (Hinge, Lead Arm, Trail Arm, Lead Wrist/Club Face and Trail Wrist), Path (Shaft and Lead Arm), Release (Body Sequence, Arms and Hands, Shaft); and 51 faults associated with these swing subelements: Setup>Lead Hand Grip (Strong, Weak), Setup>Trail Hand Grip (Strong, Weak), Setup>Posture (C Posture, Rigid Posture, Basic), Setup>Stance (Wide, Narrow), Setup>Ball Position (Forward, Back), Setup>Knee Flex (Straight, Flexed), Setup>Alignment (Open, Closed), Turn>Upper Body (Sway Back, Sway Forward, Dropping, Basic), Turn>Lower Body (Sway Back, Sway Forward, Basic), Turn>Footwork (Rolling), Turn>Tempo (Backswing, Downswing, Basic), Lever>Hinge (Early, Late), Lever>Lead Arm (Bent), Lever>Trail Arm (Tucked, Flying), Lever>Lead Wrist/Club Face (Bowed/Closed, Cupped/Open), Lever>Trail Wrist (Flexed, Extended), Path>Shaft (Steep, Shallow), Path>Lead Arm (High, Low), Release>Body Sequence (Hang Back, Sway Forward, Early Extension, Basic), Release>Arms and Hands (Casting, Chicken Wing, Tucked, Flipping, Basic), Release>Shaft (Over and Low, Over and High, Basic).

Some embodiments may provide a capability to score a physical activity participant's movements, as defined by the taxonomy of movements, via an Instructor-facing interface available via a network connection to physical activity instructors, such as golf instructors; for example a quantitative assessment of a participant's movements as reviewed via a video of those movements using a standard scoring framework based on numeric scores on a scale of 1 to 10 for each swing subelement, as defined by the taxonomy of swing subelements, and a personalized pass or fail status for each swing subelement.

Some embodiments may provide a capability to identify faults, as defined by the taxonomy of faults, in the movements of a physical activity participant via an Instructor-facing interface available via a network connection to physical activity instructors; for example in golf, the capability for a golf instructor using an Instructor-facing interface to review a video of a golf player's swing and identify the “Strong” fault associated with a failing status for the Lead Hand Grip swing subelement in the taxonomy of swing subelements and swing faults.

Some embodiments may provide a technology-enabled workflow via an Instructor-facing interface available over a network connection to achieve highly scalable efficiency and speed in scoring, passing, failing and fault identification of the movements of physical activity participants; for example, a Golf-Instructor-Facing workflow interface that displays a Participant's golf swing video adjacent to an interactive scoring interface with slider bars for selecting numeric scores (on a 1 to 10 scale) for each of the 5 swing elements and 21 swing subelements in the taxonomy of golf swing elements. This may visually inform the Golf Instructor via the workflow interface as to the personalized pass or fail statuses associated with these numeric scores in the passing threshold data attribute table and/or may provide a fault-selection interface for all swing subelements with a failing status that presents a menu of the swing faults associated with that swing element in the swing fault taxonomy.

Some embodiments may generate a personalized multi-lesson roadmap of digital instruction for each physical activity participant which may be displayed in an Instructor-facing interface available over a network connection and may be created by a roadmap generation algorithm. For example, in golf, the roadmap generation algorithm may create a personalized roadmap for a participant by identifying the swing subelements in the swing subelement taxonomy that have a failing status for that participant and that have an associated fault in the fault taxonomy for that participant. The roadmap generation algorithm may automatically create multiple personalized digital lessons associated with each of the participant's individual failed swing subelements and faults where each generated digital lesson focuses on one of the failed swing subelements and associated swing faults of the individual participant. The algorithm may automatically associate each lesson with lesson content assets, including specialized instructional drill videos, matched to the lesson based upon the swing fault attribute as defined in a swing element lessons data attribute table. The participant's personalized score and pass or fail status on the swing subelement associated with the lesson, the algorithm may associate functional capabilities with each generated lesson, including a personalized annotation capability for golf instructors to draw instructional markup upon still images extracted from the participant's videos, to record instructional audio associated with still images extracted from the participant's video, to type instruction text associated with still images extracted from the participant's video. The algorithm may associate with the lesson a mechanism for participants to submit additional videos of their swing focusing on the swing subelement in the lesson, to a centralized repository for further re-evaluation, instruction, scoring and pass or fail statusing. In golf, for example, the personalized multi-lesson roadmap of digital instruction may include: a personalized roadmap statistics section indicating the player's percent completion of the lessons in the roadmap, a personalized percent improvement analysis calculating what percent improvement to the player's overall swing will result from improvement in the swing elements that contain swing subelements that the individual player has failed in the instructor's evaluation, and an interactive list of the personalized digital lessons in the player's personalized roadmap.

Some embodiments may automatically define and aggregate the lesson content for each personalized lesson in the physical activity participant's personalized multi-lesson roadmap of digital instruction via in an Instructor-facing interface available over a network connection. For example, in golf, lesson content may be matched to a specific swing fault from the fault taxonomy that is associated with a swing subelement scored with a failing status for an individual player. Lesson content may include specialized instructional drill videos, matched to the lesson based upon the swing fault attribute as defined in a swing element lessons data attribute table. The participant's personalized score on the swing subelement may be associated with the lesson. Functional capabilities may be provided, including a personalized annotation capability for golf instructors to draw instructional markup upon still images extracted from the participant's videos, to record instructional audio associated with still images extracted from the participant's video, to type instruction text associated with still images extracted from the participant's video; and a mechanism for participants to submit additional videos of their swing focusing on the swing subelement in the lesson, to a centralized repository for further re-evaluation, instruction, scoring and pass or fail statusing.

Some embodiments may provide a scalable workflow for physical activity instructors to create instructional annotations on the movements of a physical activity participant as defined in the movement taxonomy via an Instructor-facing interface available via a network connection. For example, golf instructors may utilize an annotation management capability within an Instructor-facing interface with purpose-built interactive tools designed to reduce time and effort in drawing of instructional markup upon still images extracted from the participant's videos, suggested personalized coaching scripts that are matched to attributes of the participant and their status, the ability to record instructional audio associated with still images extracted from the participant's video, and the ability to type instructional text associated with still images extracted from the participant's video.

Some embodiments may provide physical activity instructors the ability via an Instructor-facing interface available over a network connection to reassess and retroactively fail physical activity participants on movement subelements that the physical activity participant has passed in prior instructor evaluations and to automatically add these retroactive fails to a participant-facing regressed movement checklist. Each lesson as part of the two-way, interactive instructor-to-participant and participant-to-instructor instruction mechanism may provide the capability for participants to transmit additional movement videos to the instructor to demonstrate improvement and try to achieve a status of pass on the lesson. Therefore participants may transmit multiple additional movement videos to the instructor over the course of time during their progress through the lessons of their personalized multi-lesson roadmap of instruction. While evaluating a transmitted participant movement video associated with a lesson and its associated movement subelement nearer the end of participant's roadmap, an instructor may notice a regression in another movement subelement associated with a lesson earlier in the participant's roadmap. A retroactive fail may be the assignment of a fail status by an instructor to a participant on a movement subelement that the participant has passed in a previously transmitted movement video. When an instructor retroactively fails a participant on a movement subelement that the participant has previously passed, the retroactive fail capability may prompt the instructor to record a personalized retroactive fail voice annotation audio file and trigger the retrieval from the physical activity participant videos database of a video showing the participant passing the retroactively failed subelement. The retroactive fail capability may add the personalized voice annotation and the video of the participant passing the movement subelement to the participant's regressed movement checklist.

Some embodiments may provide a Physical Activity Participant process and interface that may provide learning in a physical activity via displaying a personalized multi-lesson roadmap of digital instruction via a participant-facing interface available via a network connection. For example, in golf, a Player mobile application presents a personalized multi-lesson roadmap of digital instruction consisting of a sequence of interactive, two-way, personalized digital lessons, where each lesson is associated with a swing subelement for which the participant was given a failing status during scoring and a swing fault that is associated with the failed swing subelement.

Some embodiments may provide learning in a physical activity via displaying a personalized Lesson screen for each of the lessons on the physical activity participant's personalized multi-lesson roadmap of digital instruction via a participant-facing interface available via a network connection. For example, in golf, a Player mobile application may display a Lesson screen when the Player taps on the corresponding lesson element on the Player's personalized multi-lesson roadmap of digital instruction. The Lesson screen may have a personalized focus on a swing subelement for which the participant was given a failing status during scoring of their initial golf swing multi-perspective video. The Lesson screen may have a personalized focus on the swing fault that was selected by the instructor in association with this swing subelement during the instructor's scoring of the player's initial golf swing multiperspective video. The Lesson screen may display drill videos matched to the player's swing subelement and fault by the automated personalized lesson creation process. The Lesson screen may display a law of ball flight video matched to the player's swing subelement by the automated personalized lesson creation process. The Lesson screen may display personalized drawing (markup) annotations made by the instructor on still images taken from the player's swing video within the instructor-facing technology-enabled annotation workflow. The Lesson screen may contain playable audio files of personalized coaching annotations recorded by the instructor within the instructor-facing technology-enabled annotation workflow. The Lesson screen may display the player's current numeric score on their aptitude on the lesson's associated swing subelement and current performance-score-driven pass or fail status on the lesson. The Lesson screen may contain a context-sensitive mechanism for the player to capture an additional swing video and transmit it back to the instructor for re-evaluation and rescoring in a two-way interactive learning process.

Some embodiments may display a goal-driven index score, for example in golf a swing index, for an individual physical activity participant, such as a golf player, that may include an average of the player's numeric scores for all specific movements within the physical activity movement taxonomy compared against a goal-driven perfect score of 10; display the ability for player to view their unadjusted index score with no goal-based boost factors applied on a scale where 10 represents a perfect score for the very best amateur players; include an automated index score updating function where the index score increases by including the updated numeric score for the lesson's sub-movement in the index score algorithm each time a participant is passed by their instructor on one of the personalized lessons in the personalized multi-lesson roadmap of instruction. This may ensure that the index score is a living, dynamically updated metric in the participant-facing interface.

Some embodiments may provide learning in a physical activity via personalized two-way interactive participant-to-instructor and instructor-to-participant digital lessons on physical activity instruction within a personalized multi-lesson roadmap of digital instruction via a participant-facing interface available over a network connection. For example, in golf, the player-to-instructor dimension of two-way interactive digital lessons within a personalized roadmap of instruction may be provided via a Player mobile application that allows golf players to capture multi-perspective videos of their golf swing, input data describing the shot via a normalized menu of shot attributes taken from a shot attribute taxonomy, and transmit them via a network to a centralized repository. The instructor-to-player dimension of two-way interactive digital lessons within a personalized roadmap of instruction may be provided via golf instructors accessing the centralized repository of participant golf videos via a golf-instructor-facing interface and opening a player's incoming golf swing video. Within the instructor-facing interface, aided by the roadmap-generation algorithm, golf instructors may review, score and provide personalized digital-lesson-based instruction on specific swing subelements that the participant has failed and which are associated with individual personalized lessons on the player's roadmap of instruction. Personalized digital lessons may be transmitted to golf players via a communication network and consist of drill videos matched to individual players' failed swing subelements and faults, personalized annotations of still images extracted from player golf swing videos by instructors, the player's individual score on the swing subelement, and a mechanism to capture and transmit the player's additional golf swing videos on the specific swing subelement for further scoring, pass or fail statusing and instruction.

Some embodiments may sequentially unlock and make available individual lessons on a physical activity participant's personalized multi-lesson roadmap of digital instruction via a participant-facing interface available over a network connection when the physical activity participant has received a status of either passed or skipped on the previous lesson in their roadmap. For example, in golf, “Lesson 2” on the failed “Posture” subelement within the “Setup” element of the golf swing remains locked and unavailable to access until the player receives a status of either passed or skipped on “Lesson 1” in their roadmap about the “Lead Hand Grip” subelement within the “Setup” element of their golf swing. Once “Lesson 1” is associated with a passed or skipped status, then “Lesson 2” unlocks and becomes available for the player to access.

Some embodiments may provide learning in a physical activity via a participant-facing interface available over a network connection by using a dynamic list of movements where the participant has regressed from a passing status to a failing status. For example, in golf, a player-facing mobile app may display a dynamic regressed movement checklist of swing subelements where the player had been given a passing status in a previously submitted golf swing video but subsequently was given a failing status in a golf swing video submitted at some time afterward indicating a regression in their form on this swing subelement. Each swing subelement list item on the dynamic regression checklist may contain a personalized audio annotation by a golf instructor to correct the regression error and a video showing the player performing the swing subelement correctly when they initially achieved a passing status on the subelement.

Some embodiments may provide a data attribute model that enables the system and method to perform its functions.

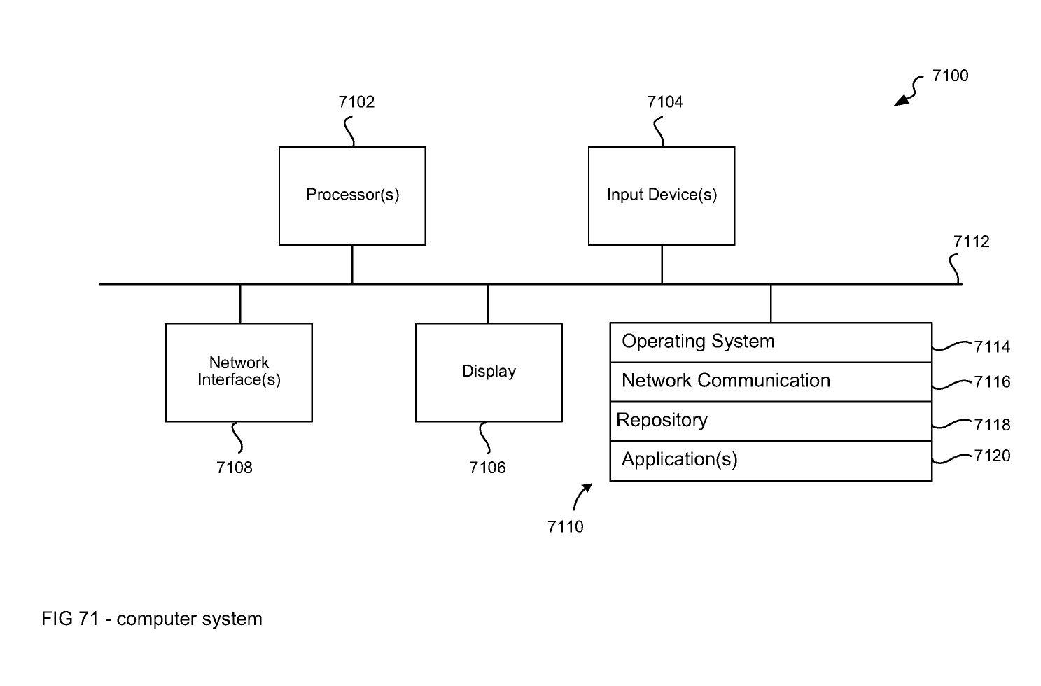

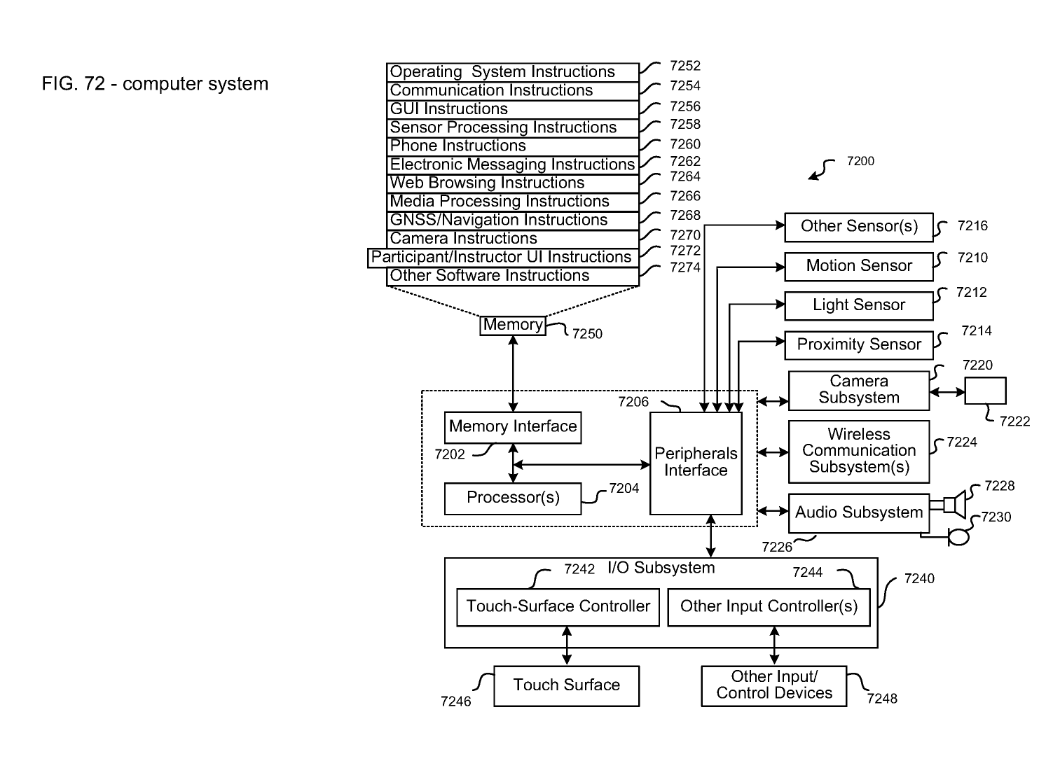

The following examples describe interactions between users and the disclosed systems and methods. For example, a physical activity participant may interact with the system using a personal computing device such as a smartphone or PC. An instructor may interact with the system using a personal computing device such as a smartphone or PC. One or more servers may act as central repositories of data entered by the respective users and/or may perform additional processing on the data as described below. Specific examples of computing devices that may be part of the disclosed systems are also described in detail below (e.g., see FIGS. 71 and 72).

Some embodiments may provide a system whereby a physical activity participant may provide a video of themselves performing a physical activity. An instructor may evaluate the video to identify aspects of the activity the participant is performing correctly and/or aspects of the activity the participant could improve. The figures and the following descriptions thereof describe this two-way process.

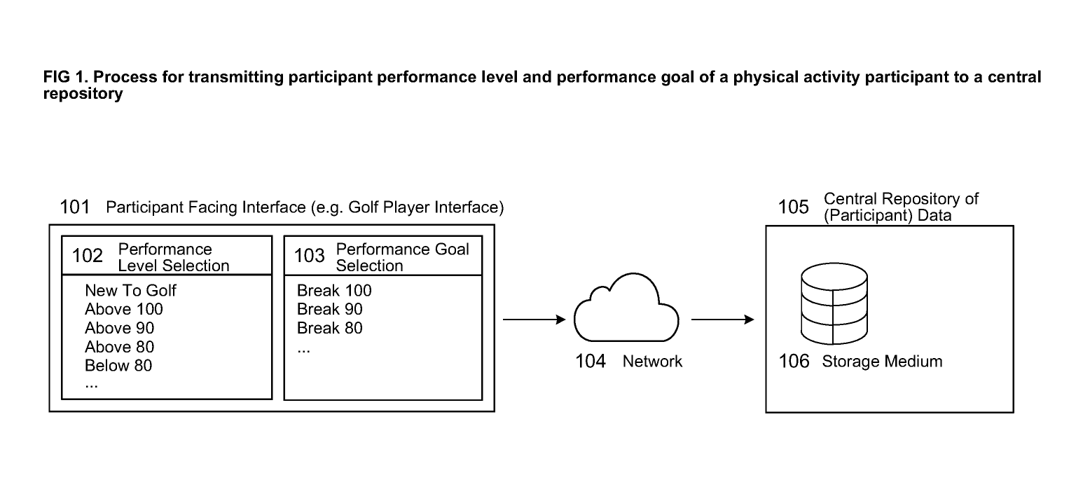

FIG. 1 depicts a process for transmitting a physical activity participant's current performance level and performance goal to a central repository. This process may be performed by one or more computing devices 7100, computing devices 7200, or a combination thereof, described below. For example, via a participant facing interface 101, a participant may select their current performance level from a normalized list of options 102 and/or may select their performance goal from a normalized list of options 103. Selected attributes may be transmitted via a network connection 104 to a centralized repository of participant data 105 residing on a storage medium 106. For example, in golf, a player may select a current performance level of “Above 90” indicating an average score for an 18-hole round of golf that is above 90. The golfer may select a performance goal of “Break 90” indicating that their goal is to achieve a score below 90.

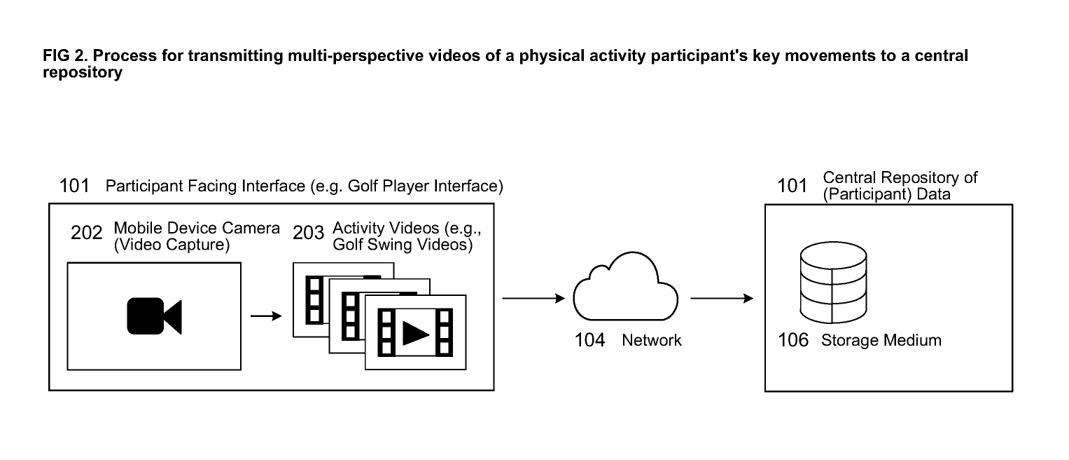

FIG. 2 depicts a process for transmitting multi-perspective videos of a physical activity participant's movements to a central repository. This process may be performed by one or more computing devices 7100, computing devices 7200, or a combination thereof, described below. For example, via a participant facing interface 101, a participant may activate their mobile device camera 202. With the help of another participant, the participant may capture multiperspective activity videos 203 of himself/herself via their mobile device camera 202. For example, the videos may record the participant performing the physical activity. The other participant may capture the full range of movements performed during the activity. These activity videos may be transmitted via a network connection 104 to a centralized repository of participant data 105 residing on a storage medium 106. For example, in golf, a golfer (Golfer 1) may hand their mobile device to another golfer (Golfer 2) who is with them on the golf course or range. Golfer 2 may capture activity videos of Golfer 1's golf swing, and after reviewing and approving each activity video, Golfer 1 may transmit the video over the network 104 to a central repository 105.

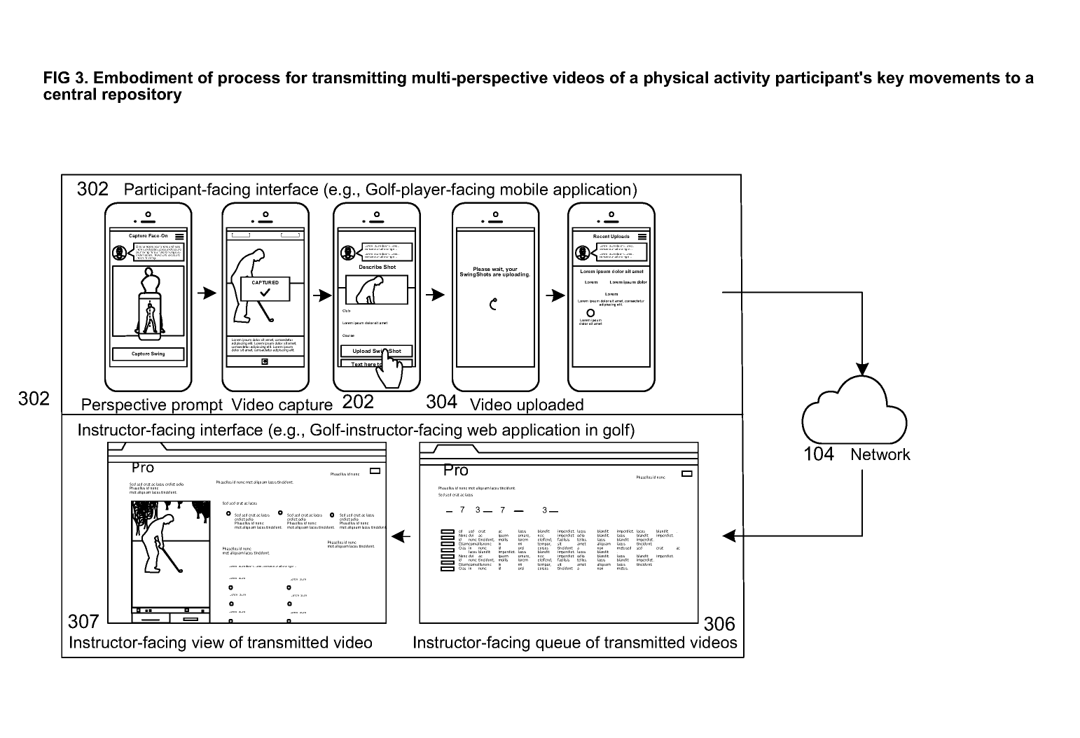

FIG. 3 depicts an embodiment of a process for transmitting multi-perspective videos of a physical activity participant's movements to a central repository. This process may be performed by one or more computing devices 7100, computing devices 7200, or a combination thereof, described below. A participant facing interface within an application running on a widely available device such as a smartphone 301 may the participant to prepare to capture video of the physical activity from the correct perspective 302. The interface may utilize integration with the mobile device's camera for video capture and may provide a review and re-record capability for the participant to review the captured video 101. The interface may transmit the video 304 over a network connection 104 to a centralized repository where physical activity instructors may discover the participant video in an instructor-facing queue of transmitted videos 306 and open and evaluate the individual video via an instructor-facing review workflow interface 307.

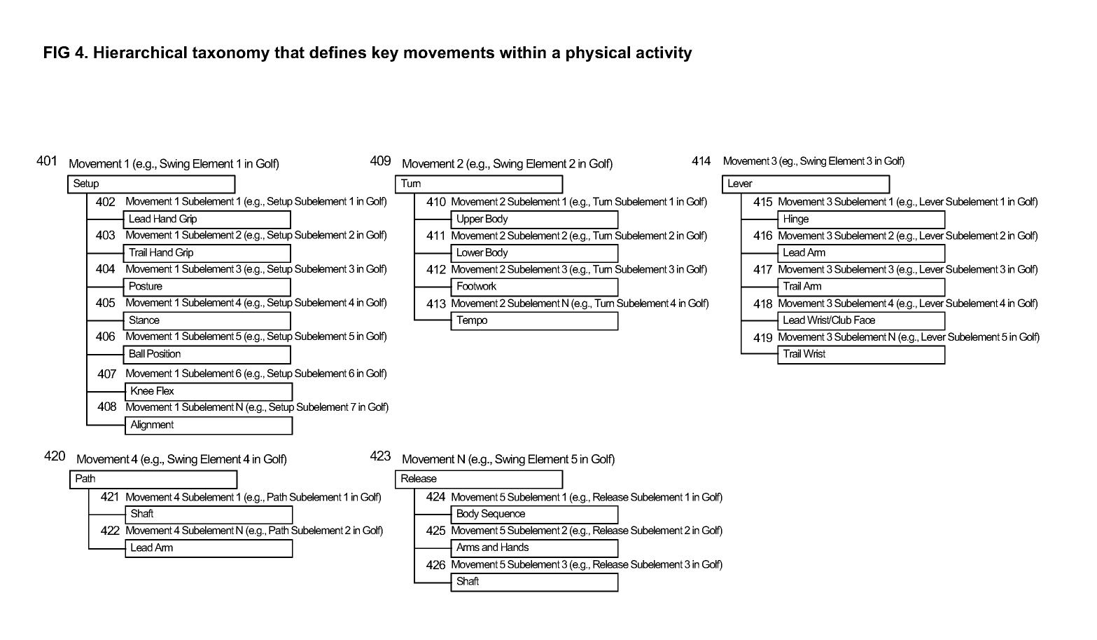

FIG. 4 depicts a hierarchical taxonomy that defines movements and submovements within a physical activity. The example of FIG. 4 is for golf movements and submovements, but other physical activities may have other hierarchies. In the golf example, a movement element 401 called Setup may contain hierarchically nested movement subelements such as Lead Hand Grip 402, Trail Hand Grip 403, Posture 404, Stance 405, Ball Position 406, Knee Flex 407, and Alignment 408. A movement element called Turn 409 may contain hierarchically nested movement subelements such as Upper Body 410, Lower Body 411, Footwork 412, and Tempo 413. A movement element called Lever 414 may contain hierarchically nested movement subelements such as Hinge 415, Lead Arm 416, Trail Arm 417, Lead Wrist/Club Face 418, and Trail Wrist 419. A movement element called Path 420 may contain hierarchically nested movement subelements such as Shaft 421 and Lead Arm 422. A movement element called Release 423 may contain hierarchically nested movement subelements such as Body Sequence 424, Arms and Hands 425, and Shaft 426.

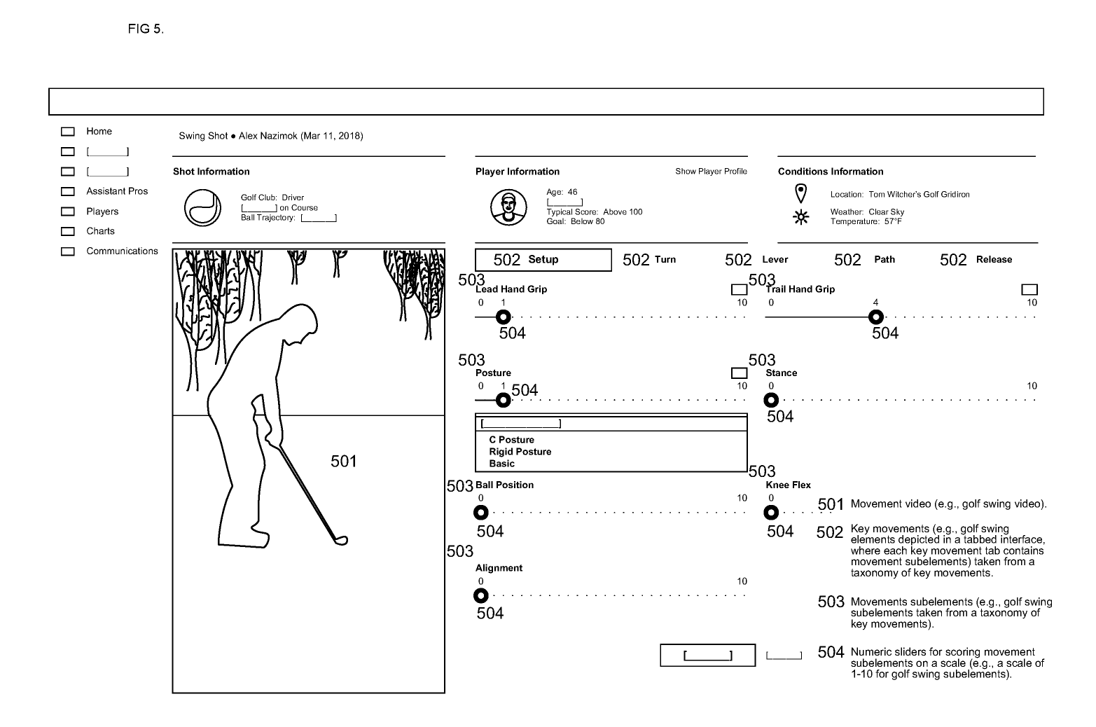

FIG. 5 depicts an embodiment of a standardized evaluative scoring framework for movements and submovements within a physical activity in an instructor-facing interface 500. This process may be performed by one or more computing devices 7100, computing devices 7200, or a combination thereof, described below. An instructor may review the physical activity participant's activity video 501 and may select a movement element 502 from the interface 500. For example, FIG. 5 includes five movement elements 502. For the selected movement element 502, the interface 500 may show the instructor the hierarchically nested movement subelements 503 within that movement, and the instructor may give a numeric score to each subelement via an interface control such as a slider bar 504. The instructor may repeat this process for each of the movement subelements 502 until the evaluation and scoring of the physical activity participant video 501 is complete;

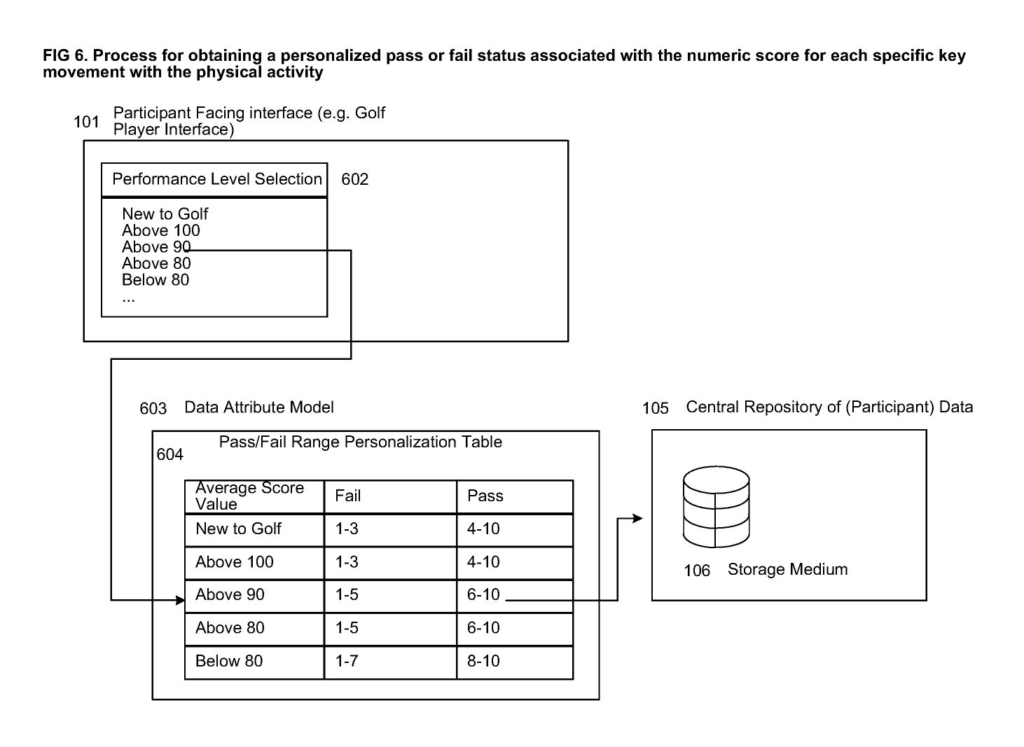

FIG. 6 depicts a process for obtaining a personalized, performance-level-based pass or fail status associated with the numeric score for specific submovements within the physical activity. This process may be performed by one or more computing devices 7100, computing devices 7200, or a combination thereof, described below. For example, in a physical activity participant facing interface 101, a participant may select their current performance level from a normalized list 602. The participant's performance level attribute may be passed into a data attribute model 603 and may be used to interrogate a pass/fail range personalization table 604 where a personalized pass/fail range may be obtained for the attribute based on the model 603. For each normalized performance level, the personalized pass/fail range may define a range of numeric scores which instructors may give to movement subelements and may map them to a pass or fail status. For example, a participant performance level of “Above 90” may be associated with a numeric score range of 1-5 that maps to a failing status and a numeric score range of 6-10 that maps to a passing status (although other embodiments may use other mappings). This personalized pass/fail range attribute may be placed into a central repository of participant data 105 within a storage medium 106 in a manner such as that described above.

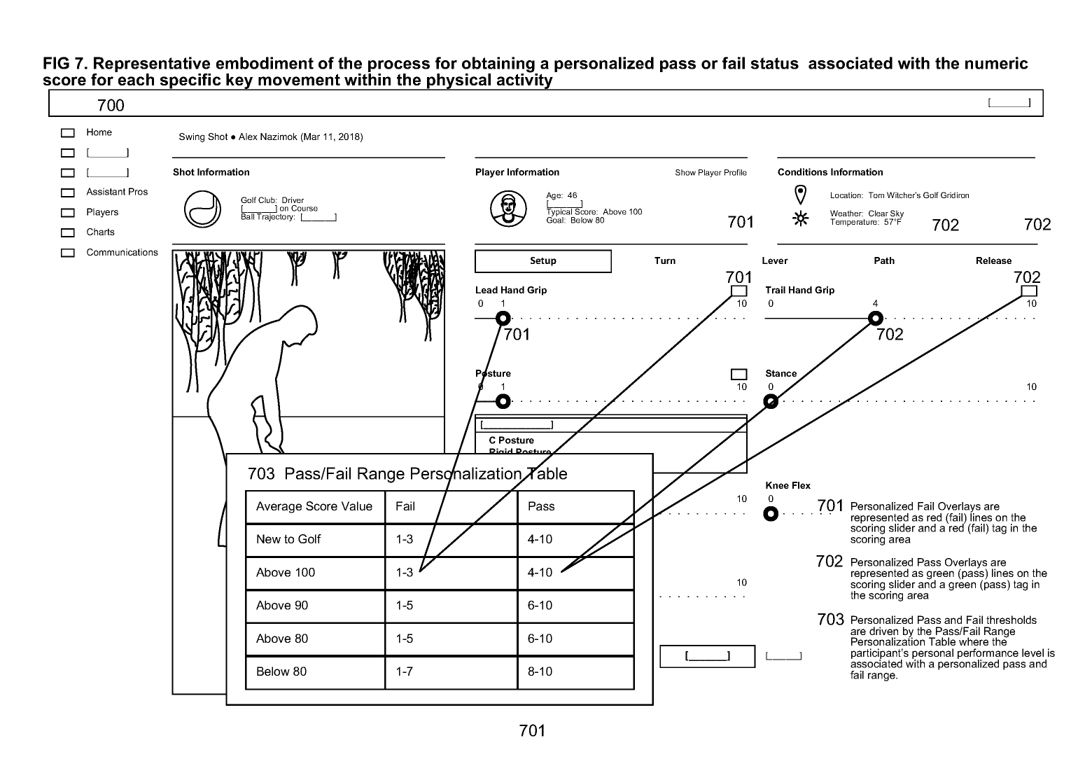

FIG. 7 depicts an embodiment of the process for obtaining a personalized, performance-level-based pass or fail status associated with the numeric score for each specific submovement within the physical activity. This process may be performed by one or more computing devices 7100, computing devices 7200, or a combination thereof, described below. Within an instructor-facing interface for participant movement video evaluation and scoring 700, an instructor may be visually shown the personalized fail status 701 that corresponds to the numeric score range associated with a failing status in the pass/fail range personalization table 703. An instructor may be visually shown the personalized pass status 702 that corresponds to the numeric score range associated with a failing status in the pass/fail range personalization table.

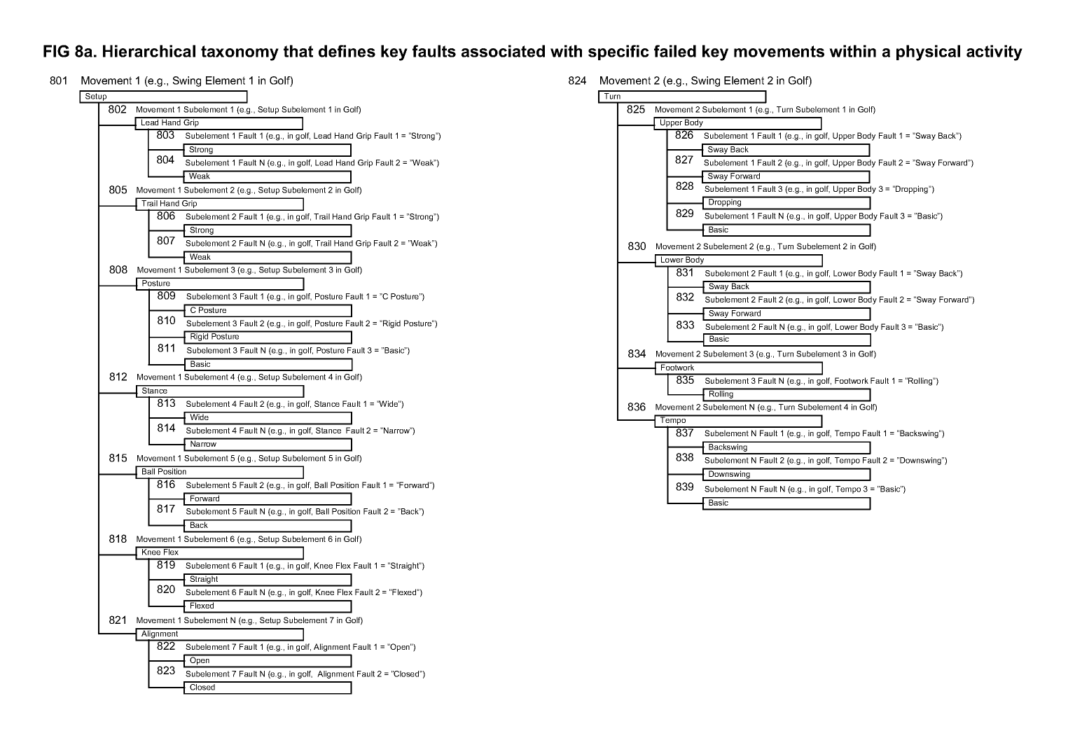

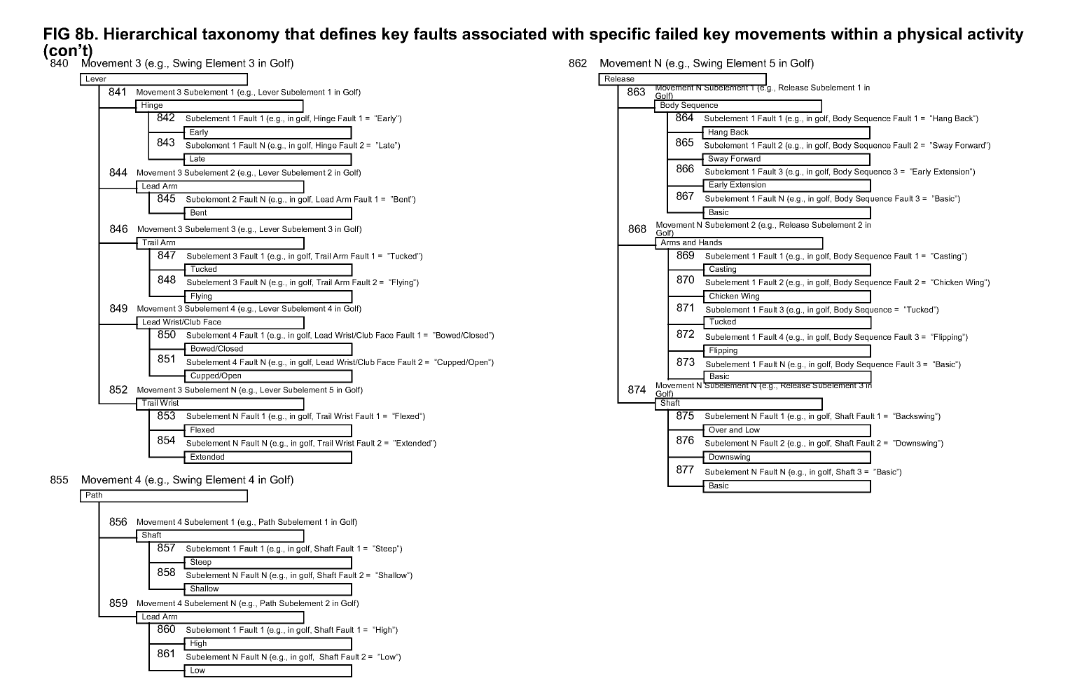

FIG. 8A and FIG. 8B depict a hierarchical taxonomy that defines faults associated with movements and submovements within a physical activity, for example in golf. In the illustrated golf hierarchy, a movement element 801 called Setup may contain a hierarchically nested movement subelement called Lead Hand Grip 802, which may contain hierarchically nested subelement faults called Strong 803 and Weak 804. Setup element 801 may contain a hierarchically nested movement subelement called Trail Hand Grip 805, which may contain hierarchically nested subelement faults called Strong 806 and Weak 807. Setup element 801 may contain a hierarchically nested movement subelement called Posture 808, which may contain hierarchically nested subelement faults called C-Posture 809, Rigid Posture 810, and Basic 811. Setup element 801 may contain a hierarchically nested movement subelement called Stance 812, which may contain hierarchically nested subelement faults called Wide 813 and Narrow 814. Setup element 801 may contain a hierarchically nested movement subelement called Ball Position 815, which may contain hierarchically nested subelement faults called Forward 816 and Back 817. Setup element 801 may contain a hierarchically nested movement subelement called Knee Flex 818, which may contain hierarchically nested subelement faults called Straight 819 and Flexed 820. Setup element 801 may contain a hierarchically nested movement subelement called Alignment 821, which may contain hierarchically nested subelement faults called Open 822 and Closed 824.

A movement element 824 called Turn may contain a hierarchically nested movement subelement called Upper Body 825, which may contain hierarchically nested subelement faults called Sway Back 826, Sway Forward 827, Dropping 828, and Basic 829. Turn element 824 may contain a hierarchically nested movement subelement called Lower Body 830, which may contain hierarchically nested subelement faults called Sway Back 831, Sway Forward 832, and Basic 833. Turn element 824 may contain a hierarchically nested movement subelement called Footwork 834, which may contain a hierarchically nested subelement fault called Rolling 835. Turn element 824 may contain a hierarchically nested movement subelement called Tempo 836, which may contain hierarchically nested subelement faults called Backswing 837, Downswing 838, and Basic 839.

A movement element 840 called Lever may contain a hierarchically nested movement subelement called Hinge 841, which may contain hierarchically nested subelement faults called Early 842 and Late 843. Lever element 840 may contain a hierarchically nested movement subelement called Lead Arm 844, which may contain a hierarchically nested subelement fault called Bent 845. Lever element 840 may contain a hierarchically nested movement subelement called Trail Arm 846, which may contain hierarchically nested subelement faults called Tucked 847 and Flying 848. Lever element 840 may contain a hierarchically nested movement subelement called Lead Wrist/Club Face 849, which may contain hierarchically nested subelement faults called Bowed/Closed 850 and Cupped/Open 851. Lever element 840 may contain a hierarchically nested movement subelement called Trail Wrist 852, which may contain hierarchically nested subelement faults called Flexed 853 and Extended 854.

A movement element 855 called Path may contain a hierarchically nested movement subelement called Shaft 856, which may contain hierarchically nested subelement faults called Steep 857 and Shallow 858. Path element 855 may contain a hierarchically nested movement subelement called Lead Arm 859, which may contain hierarchically nested subelement faults called High 860 and Low 861.

A movement element 862 called Release may contain a hierarchically nested movement subelement called Body Sequence 863, which may contain hierarchically nested subelement faults called Hang Back 864, Sway Forward 865, Early Extension 866, and Basic 867. Release element 862 may contain a hierarchically nested movement subelement called Arms and Hands 868, which may contain hierarchically nested subelement faults called Casting 869, Chicken Wing 870, Tucked 871, Flipping 872, and Basic 873. Release element 862 may contain a hierarchically nested movement subelement called Shaft 874, which may contain hierarchically nested subelement faults called Over and Low 875, Over and High 876, and Basic 877.

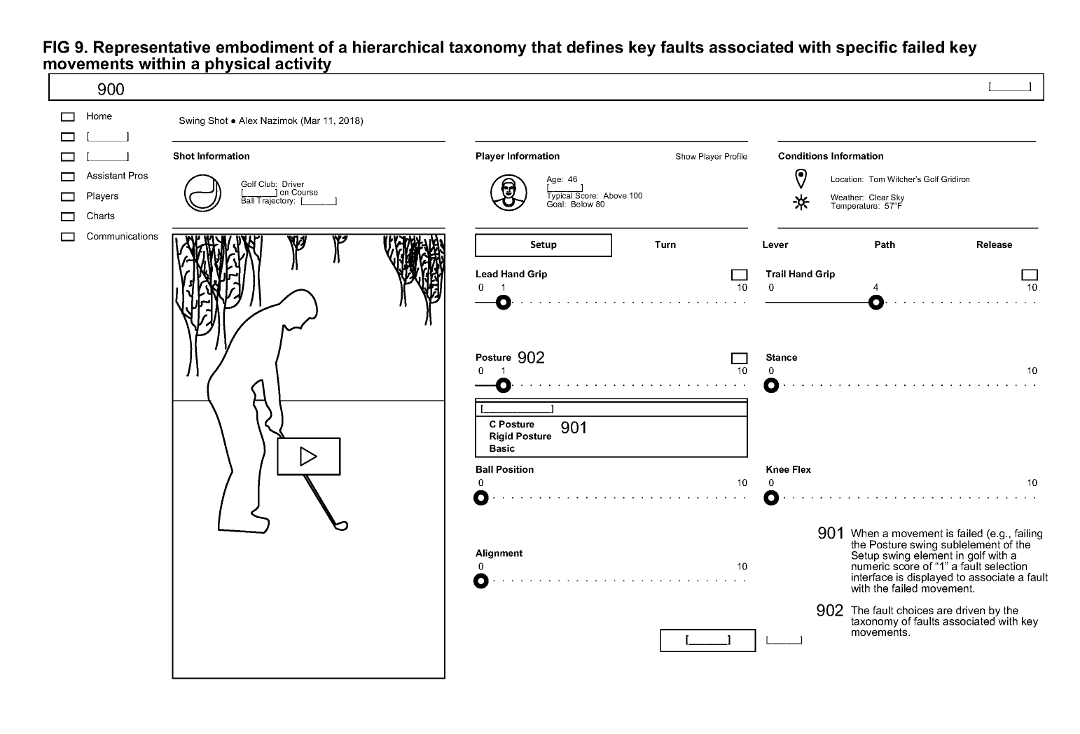

FIG. 9 depicts an embodiment of a hierarchical taxonomy that defines faults associated with movements and submovements within a physical activity. Within an instructor-facing interface for participant movement video evaluation and scoring 900, an instructor may be visually prompted to select from a normalized list of associated subelement faults 901 when the instructor has assigned a numeric score 902 to the movement subelement that is visually associated with a fail status.

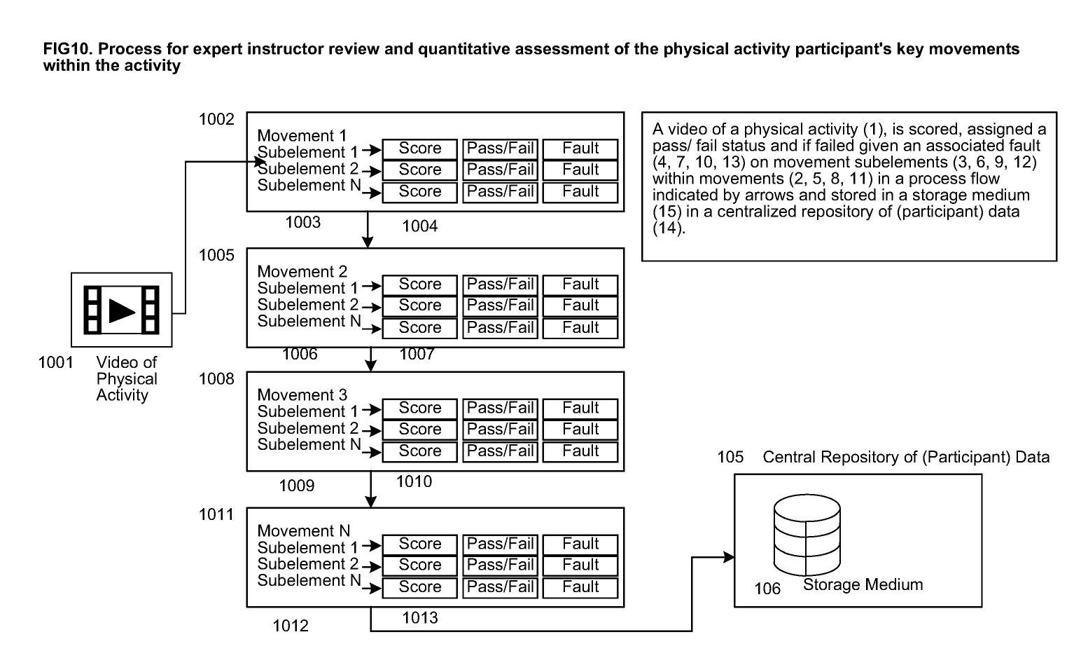

FIG. 10 Depicts a process for expert review and quantitative assessment of the physical activity participant's movements within a physical activity. This process may be performed by one or more computing devices 7100, computing devices 7200, or a combination thereof, described below. A participant movement video 1001 may be transmitted to a central repository 105, where it may be reviewed by an instructor, evaluated, scored and, when subelements are failed, assigned a subelement fault. For movement 1 1002, the movement subelements 1003 may be evaluated 1004, giving a numeric score, a pass/fail status, and if the subelement is failing, an associated subelement fault for each subelement 1003. For movement 2 1005, the movement subelements 1006 may be evaluated 1007, giving a numeric score, a pass/fail status, and if the subelement is failing, an associated subelement fault for each subelement 1006. For movement 3 1008, the movement subelements 1009 may be evaluated 1010, giving a numeric score, a pass/fail status, and if the subelement is failing, an associated subelement fault for each subelement 1009. For movement N 1011, the movement subelements 1012 may be evaluated 1013, giving a numeric score, a pass/fail status, and if the subelement is failing, an associated subelement fault for each subelement 1012. Any number of movements and/or subelements may be evaluated in this manner. The scoring, pass/fail statuses and associated subelement faults may be sent to a central repository of participant data 105, where they may reside on a storage medium 106.

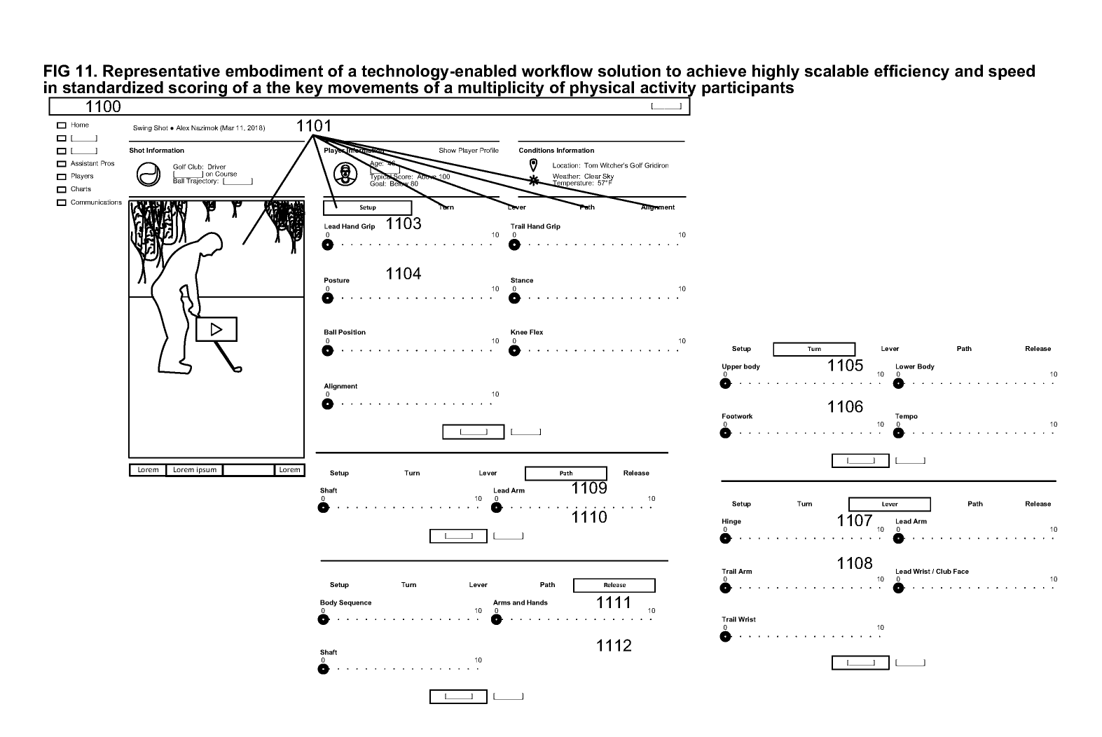

FIG. 11 depicts an embodiment of a technology-enabled workflow solution to achieve highly-scalable efficiency and speed in standardized scoring of the movements and submovements of a multiplicity of physical activity participants. This solution may be utilized by one or more computing devices 7100, computing devices 7200, or a combination thereof, described below. Within an instructor-facing interface for participant movement video evaluation and scoring 1100, an instructor may be presented with a multi-tab technology-enabled workflow 1101 for scoring multiple movement elements 1103, 1105, 1107, 1109, and 1111 within a participant movement video 1102 where one or more tabs may contain multiple subelements 1104, 1106, 1108, 1110, and 1112.

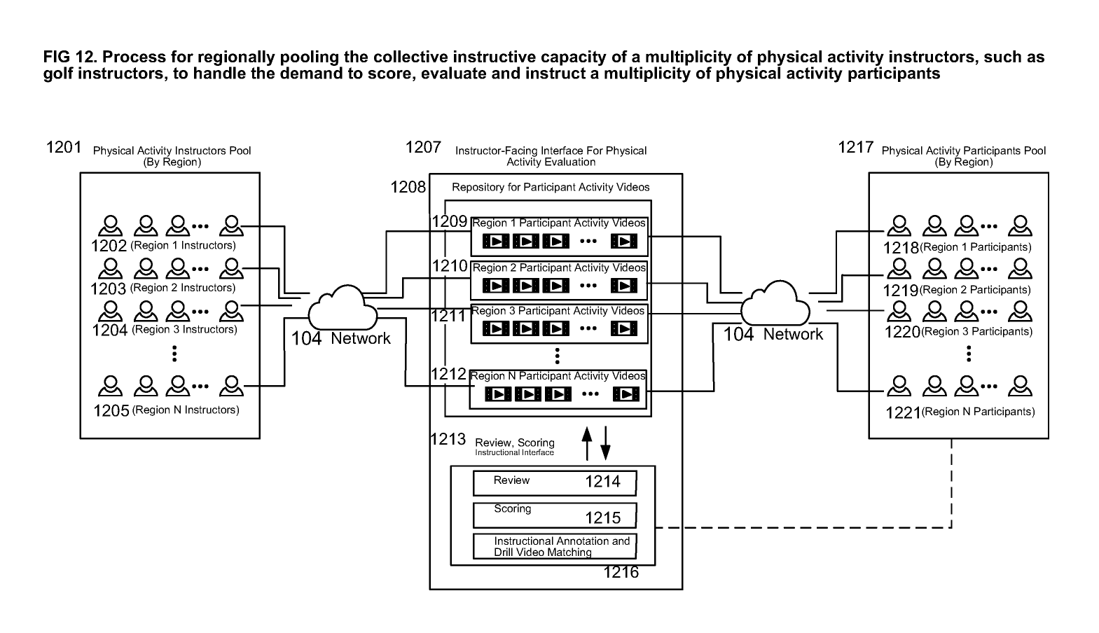

FIG. 12 depicts a process for regionally pooling the collective instructive capacity of a multiplicity of physical activity instructors to handle the demand to evaluate, score and instruct a multiplicity of physical activity participants. This process may be performed by one or more computing devices 7100, computing devices 7200, or a combination thereof, described below. Physical activity instructors may be pooled by geographic region 1201. For example, instructors may be pooled into a group of instructors for region 1 1202, a group for region 2 1203, a group for region 3 1204, and a group for region N 1205. Any number of groups may be created. Instructors in the regional pools may access an instructor facing interface for physical activity video evaluation 1207 via a network connection 104. Within the instructor facing interface, instructors may access a central repository for participant activity videos 1208 (e.g., which may be part of central repository 105), which may contain activity videos transmitted to the central repository by participants in different geographic regions, for example participants from region 1 1209, region 2 1210, region 3 1211, and region N 1212. Any number of participants from any number of regions may contribute videos. Instructors may use the review, scoring and instruction interface 1213 to review 1214, score 1215, and provide instructional annotations and drill videos 1216 for each transmitted participant video. Instructors may be assigned and/or may access videos from the region into which they are grouped.

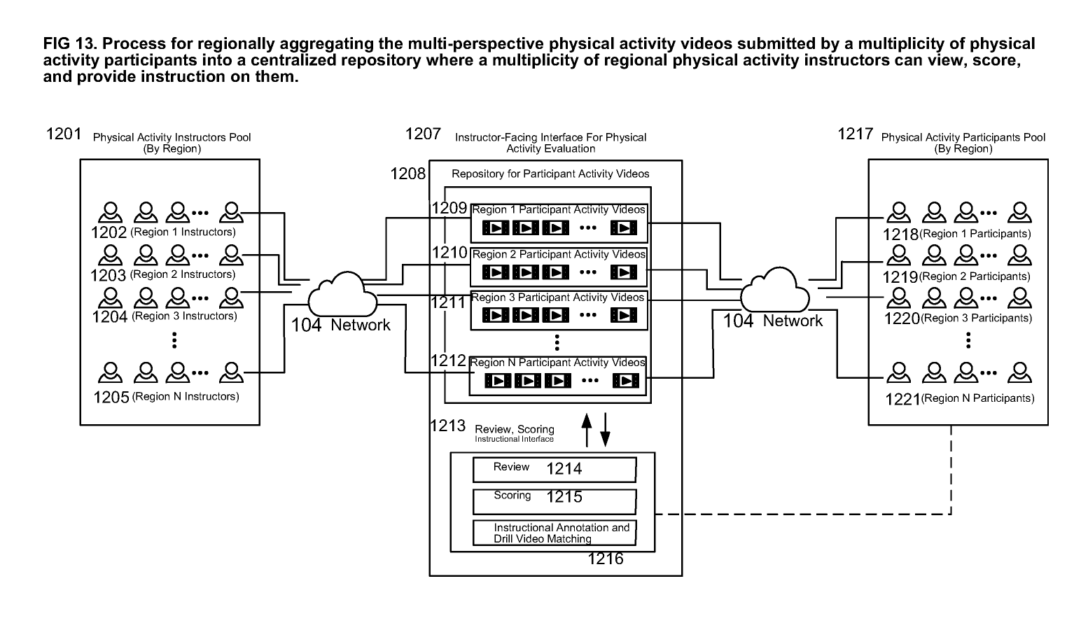

FIG. 13 depicts a process for regionally aggregating the multi-perspective physical activity videos transmitted by a multiplicity of physical activity participants into a centralized repository where a multiplicity of regional physical activity instructors can view, score and provide instruction on the videos. This process may be performed by one or more computing devices 7100, computing devices 7200, or a combination thereof, described below. Physical activity participants may be pooled by geographic region 1217. For example participants may be pooled into a group of participants for region 1 1218, a group for region 2 1219, a group for region 3 1220, and a group for region N 2112. Any number of groups may be created. Participants in the regional pools may capture and transmit physical activity videos via a network connection 104 to the central repository for participant activity videos 1208. As noted above, instructors may use the review, scoring and instruction interface 1213 to review 1214, score 1215, and provide instructional annotations and drill videos 1216 for each transmitted participant video. Instructors may be assigned and/or may access videos from the region into which they are grouped.

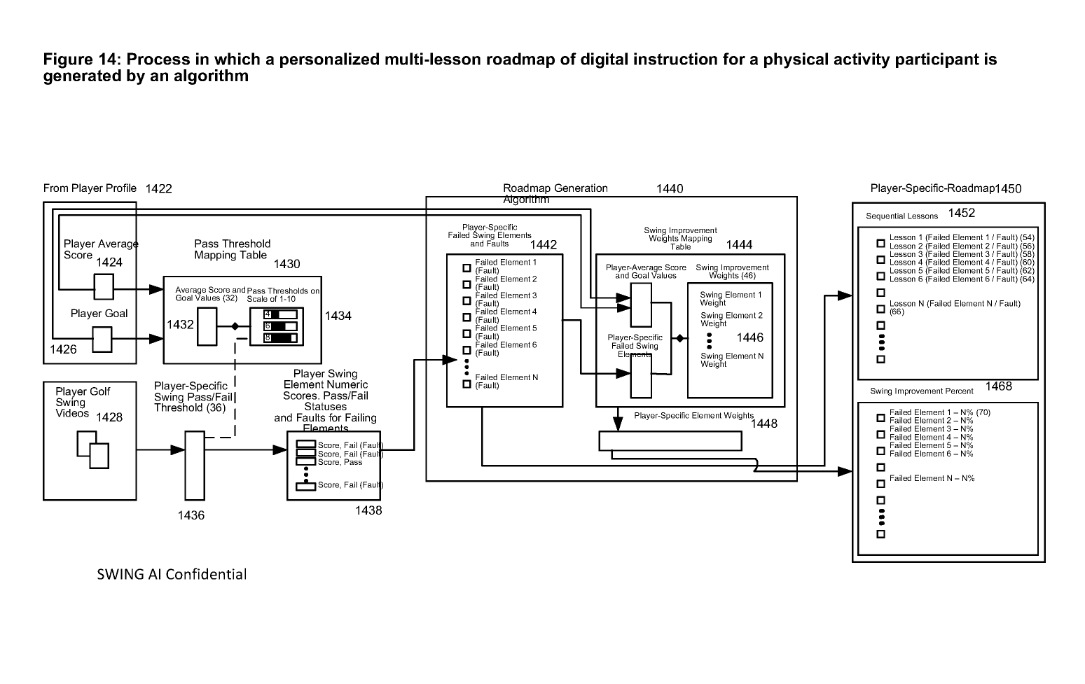

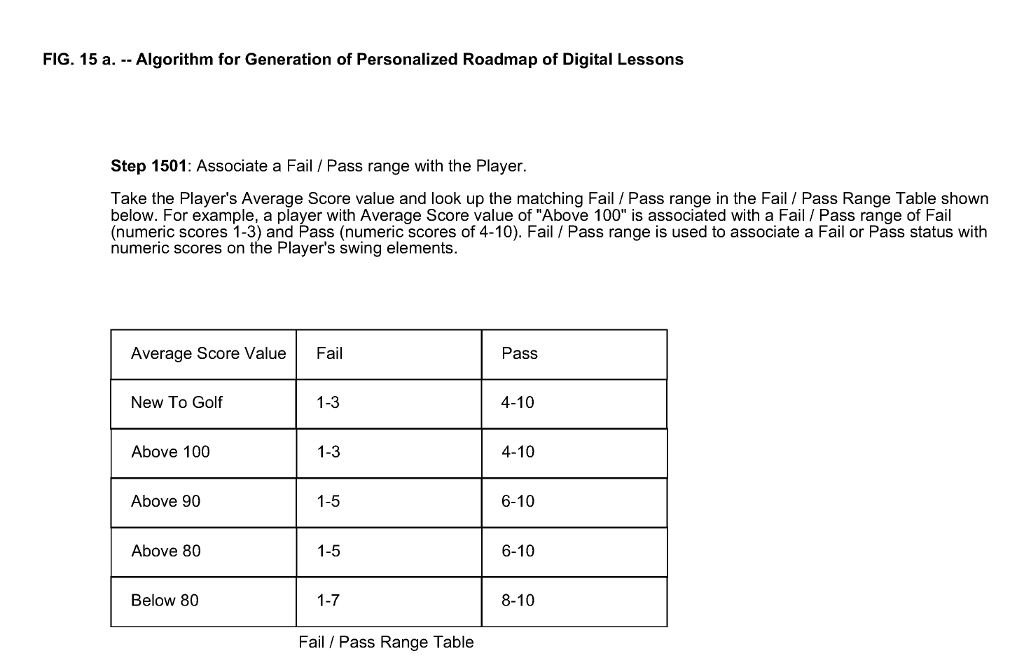

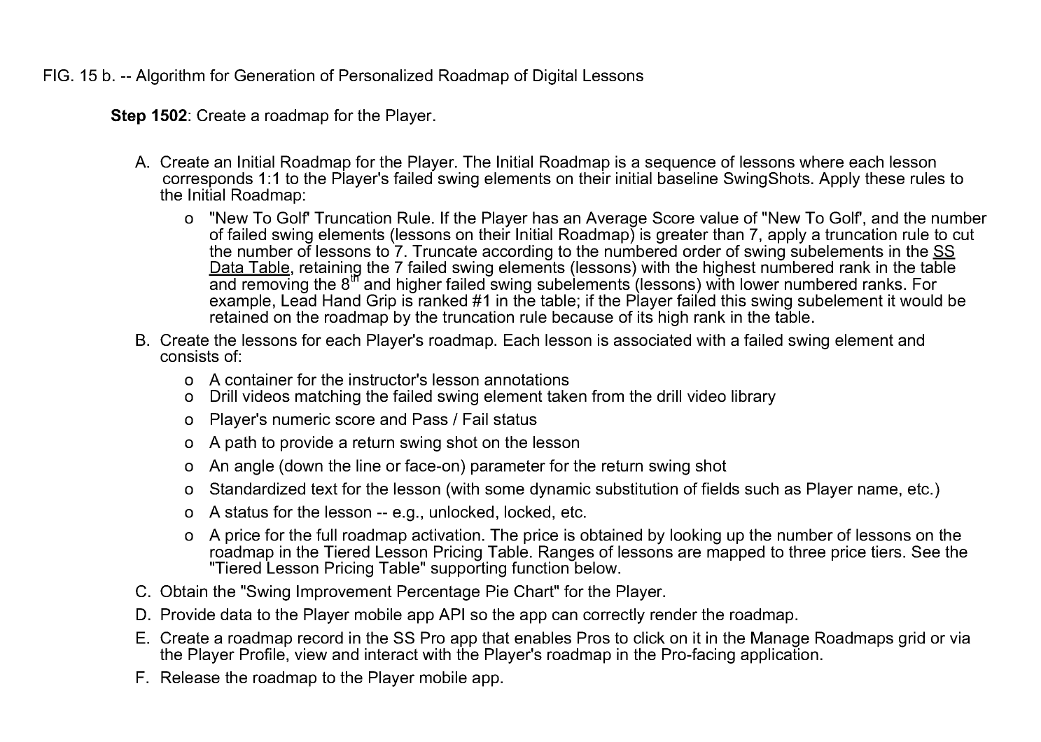

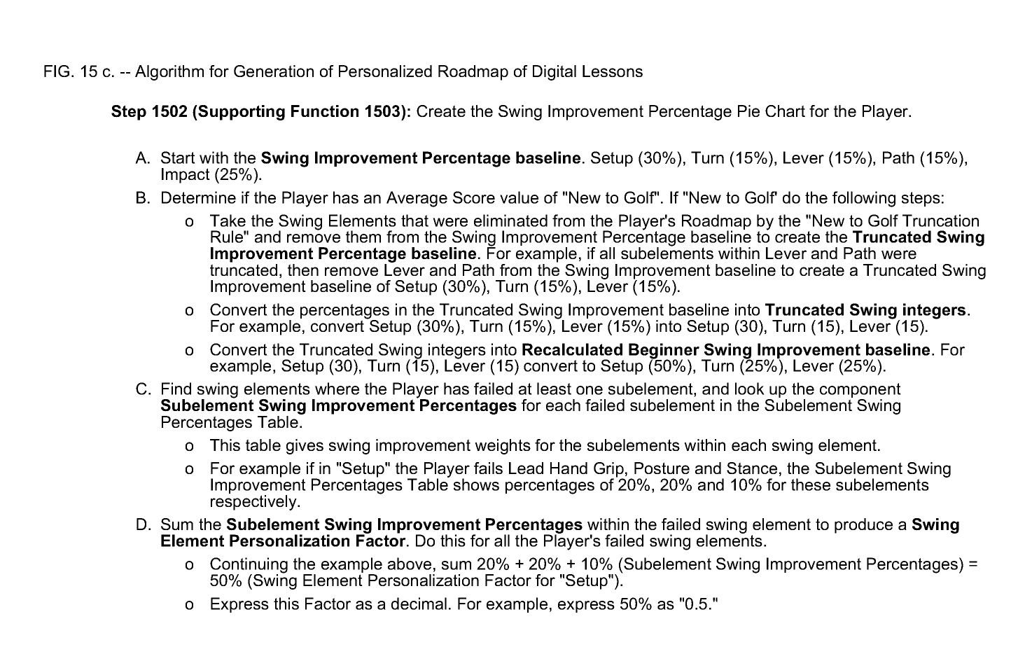

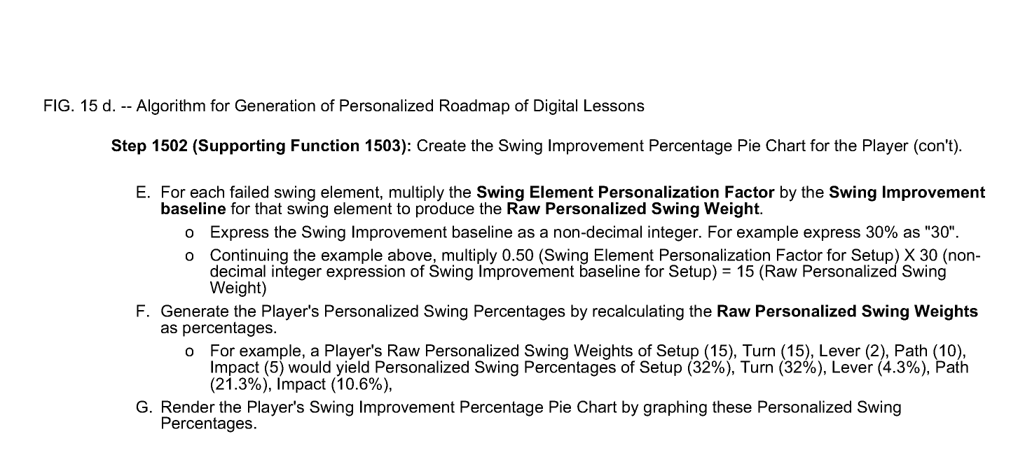

FIG. 14 depicts a process in which a personalized multi-lesson roadmap of digital instruction for a physical activity participant is generated by an algorithm. This process may be performed by one or more computing devices 7100, computing devices 7200, or a combination thereof, described below. As described above, a physical activity participant, such as a golf player in golf, may use a participant-facing interface to select an average performance score 1424 and a performance goal 1426 within the participant profile 1422 and transmit these attributes via a network connection to a central repository on a storage medium. The average performance score attribute may be used to query a pass/fail threshold mapping table 1430 and associate a personalized pass/fail threshold with the player which may map a pass or fail status to an instructor's numeric score on the participant's movement subelements. The participant may use a participant-facing interface to capture videos of their physical activity 1428, for example a golf swing, and transmits these videos via a network connection to a central repository on a storage medium where they may be accessed by instructors via an instructor facing interface. Instructors may input numeric scores, pass/fail statuses driven by the participant's personalized pass/fail threshold, and associated movement subelement faults 1438 on the participant movement video 1428. A roadmap generation algorithm 1440 may compile a list of the participant's failed movement subelements 1442 and may generate a player-specific personalized roadmap of digital lessons 1450, where each lesson may include a container for personalized instruction and coaching that corresponds to one of the participant's individual failed movement subelements. For example, Lesson 1 may be generated for failed movement subelement 1 with its associated fault, Lesson 2 may be generated for failed movement subelement 2 with its associated fault, Lesson 3 may be generated for failed movement subelement 3 with its associated fault, and so on through Lesson N. Any number of lessons may be generated. Also compiled for inclusion in the personalized roadmap may be a movement improvement percent analytic 1468 which may show the percent contribution to improving the participant's physical activity movement that is projected to come from improvement in each of the individual movement elements that comprise the movement. To calculate the movement improvement percent analytic 1468, a list of all major movement elements that contain at least one failed movement subelement may be compiled 1444. Using a table of movement improvement weights 1446 and following a list of calculations specified in a supporting component of the roadmap generation algorithm for movement improvement percent (defined in FIGS. 15A-15D below), a set of player-specific movement element weights may be produced 1448.

FIGS. 15A-15D depict an embodiment of an algorithm for the generation of a personalized multi-lesson roadmap of digital instruction for a physical activity participant. This algorithm may be performed by one or more computers associated with the central repository of FIG. 14, for example. In some embodiments, this algorithm may be performed by one or more computing devices 7100, computing devices 7200, or a combination thereof, described below.

At step 1501, a Fail/Pass range may be associated with the Player. For example, the computer may take the Player's Average Score value and look up the matching Fail/Pass range in the Fail/Pass Range Table shown in FIG. 15A. For example, a player with Average Score value of “Above 100” may be associated with a Fail/Pass range of Fail (numeric scores 1-3) and Pass (numeric scores of 4-10). Fail/Pass range may be used to associate a Fail or Pass status with numeric scores on the Player's swing elements.

At step 1502, a roadmap may be created for the Player. At 1502A, the computer may create an Initial Roadmap for the Player. The Initial Roadmap may be a sequence of lessons where each lesson corresponds 1:1 to the Player's failed swing elements on their initial baseline SwingShots. To create the initial roadmap, the computer may apply one or more rules to the Initial Roadmap. For example, rules may include a “New To Golf” Truncation Rule as follows: If the Player has an Average Score value of “New To Golf”, and the number of failed swing elements (lessons on their Initial Roadmap) is greater than 7, apply a truncation rule to cut the number of lessons to 7. Truncate according to the numbered order of swing subelements as listed in the Data Attribute Table, retaining the 7 failed swing elements (lessons) with the highest numbered rank in the table and removing the 8th and higher failed swing subelements (lessons) with lower numbered ranks. For example, Lead Hand Grip is ranked #1 in the table. If the Player failed this swing subelement, it would be retained on the roadmap by the truncation rule because of its high rank in the table.

At 1502B, the computer may create the lessons for each Player's roadmap. Each lesson may be associated with a failed swing element. Each lesson may include one or more of the following: A container for the instructor's lesson annotations; Drill videos matching the failed swing element taken from the drill video library; Player's numeric score and Pass/Fail status; A path to provide a return swing shot on the lesson; An angle (down the line or face-on) parameter for the return swing shot; Standardized text for the lesson (with some dynamic substitution of fields such as Player name, etc.); A status for the lesson—e.g., unlocked, locked, etc.

At 1502C, the computer may obtain the “Swing Improvement Percentage Pie Chart” for the Player via the supporting function (see below).

At 1502D, the computer may provide data to the Player mobile app API so the app can correctly render the roadmap.

At 1502E, the computer may create a roadmap record in the Instructor facing interface that enables Instructors to view it.

At 1502F, the computer may release the roadmap to the Player interface.

Step 1502 may include supporting function 1503 which may create the Swing Improvement Percentage Pie Chart for the Player. At 1503A, the computer may start with the Swing Improvement Percentage baseline (e.g., Setup (30%), Turn (15%), Lever (15%), Path (15%), Impact (25%)).

At 1503B, the computer may determine if the Player has an Average Score value of “New to Golf”. If “New to Golf,” the computer may perform one or more of the following steps: Take the Swing Elements that were eliminated from the Player's Roadmap by the “New to Golf Truncation Rule” and remove them from the Swing Improvement Percentage baseline to create the Truncated Swing Improvement Percentage baseline (for example, if all subelements within Lever and Path were truncated, then remove Lever and Path from the Swing Improvement baseline to create a Truncated Swing Improvement baseline of Setup (30%), Turn (15%), Lever (15%)); convert the percentages in the Truncated Swing Improvement baseline into Truncated Swing integers (for example, convert Setup (30%), Turn (15%), Lever (15%) into Setup (30), Turn (15), Lever (15)); and convert the Truncated Swing integers into Recalculated Beginner Swing Improvement baseline (for example, Setup (30), Turn (15), Lever (15) convert to Setup (50%), Turn (25%), Lever (25%)).

At 1503C, the computer may find swing elements where the Player has failed at least one subelement and may look up the component Subelement Swing Improvement Percentages for each failed subelement in the Subelement Swing Percentages Table. This table may give swing improvement weights for the subelements within each swing element. For example if in “Setup” the Player fails Lead Hand Grip, Posture and Stance, the Subelement Swing Improvement Percentages Table may show percentages of 20%, 20% and 10% for these subelements, respectively.

At 1503D, the computer may sum the Subelement Swing Improvement Percentages within the failed swing element to produce a Swing Element Personalization Factor. For example, the computer may do this for all the Player's failed swing elements. Continuing the example above, the computer may sum 20%+20%+10% (Subelement Swing Improvement Percentages)=50% (Swing Element Personalization Factor for “Setup”). The computer may express this Factor as a decimal. For example, express 50% as “0.5.”

At 1503E, for each failed swing element, the computer may multiply the Swing Element Personalization Factor by the Swing Improvement baseline for that swing element to produce the Raw Personalized Swing Weight. The computer may express the Swing Improvement baseline as a non-decimal integer. For example, the computer may express 30% as “30.” Continuing the example above, multiply 0.50 (Swing Element Personalization Factor for Setup)×30 (non-decimal integer expression of Swing Improvement baseline for Setup)=15 (Raw Personalized Swing Weight).

At 1503F, the computer may generate the Player's Personalized Swing Percentages by recalculating the Raw Personalized Swing Weights as percentages. For example, a Player's Raw Personalized Swing Weights of Setup (15), Turn (15), Lever (2), Path (10), Impact (5) may yield Personalized Swing Percentages of Setup (32%), Turn (32%), Lever (4.3%), Path (21.3%), Impact (10.6%).

At 1503G, the computer may render the Player's Swing Improvement Percentage Pie Chart by graphing these Personalized Swing Percentages.

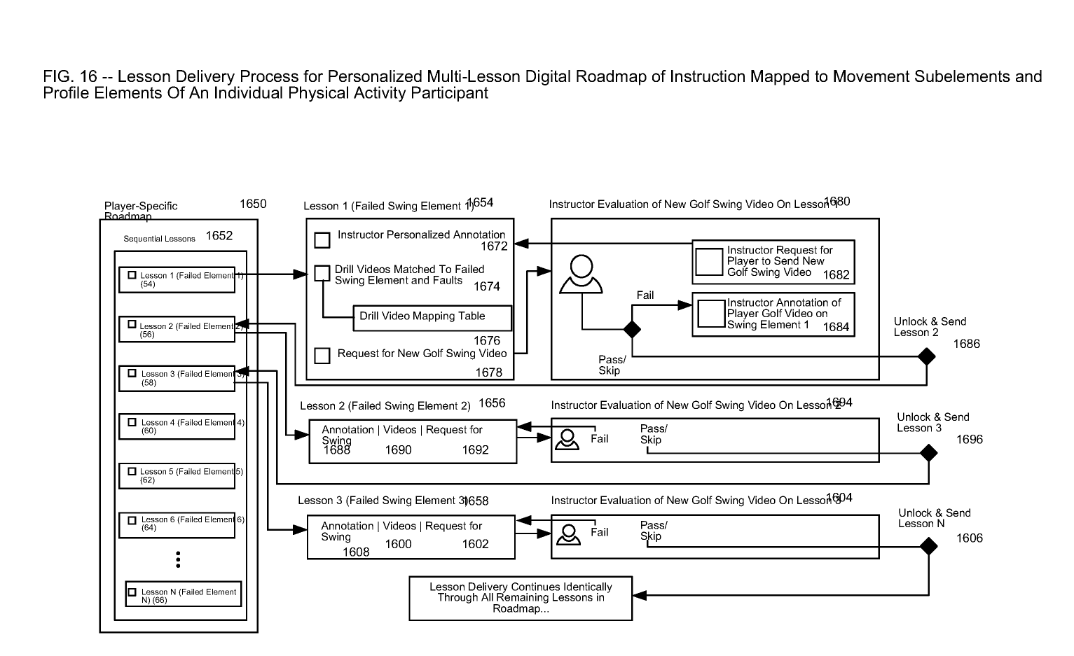

FIG. 16 depicts an example embodiment of the personalized lesson delivery process for a personalized multi-lesson roadmap of digital instruction that is mapped to each individual physical activity participant's movement subelements and profile elements. This process may be performed by one or more computing devices 7100, computing devices 7200, or a combination thereof, described below. A participant may receive a personalized multi-lesson roadmap of digital instruction 1650 containing individual lessons 1652 associated with movement subelements that the participant has failed; for example, Lesson 1 on failed subelement 1, Lesson 2 on failed subelement 2, and so on through Lesson N on failed subelement N. Any number of lessons may be provided. When the roadmap is initially delivered to the participant, one lesson (e.g., Lesson 1) may be in an unlocked state, meaning that its contents and functions are delivered to the participant and accessible, and subsequent Lessons 2-N may be in a locked state, meaning that their contents and functions are inaccessible and have not yet been delivered to the participant. Within Lesson 1 1654, the participant may engage with the instructor's personalized annotations 1672, the drill videos and ball flight law videos 1674 matched to Lesson 1's failed movement subelement by the video mapping table 1676, and the functionality to transmit an additional movement video to the instructor for re-evaluation 1678. Within the instructor interface, the instructor may evaluate the first additional participant video 1680. If the instructor passes the participant's first additional movement video on the movement subelement in the Lesson, then the participant may be given a passing status for the movement video associated with this subelement and Lesson 1. If the instructor fails the participant's video on the movement subelement in the Lesson, the instructor may provide additional personalized annotation and coaching, which may be sent back to the participant to review and practice and submit a second additional movement video for instructor re-evaluation. This two-way interactive cycle between participant and instructor may repeat until either the participant is given a passing status or reaches a maximum failure count value and is given a status of skipped on Lesson 1. When a status of pass or skip is obtained for Lesson 1, Lesson 2 may be unlocked and delivered to the participant. The initial delivery of Lesson 2 on failed movement subelement 21656 may repeat the same Lesson delivery process as noted in Lesson 1 above. This sequential Lesson unlocking process may repeat until the final Lesson of the participant's personalized multi-lesson roadmap of digital instruction is delivered.

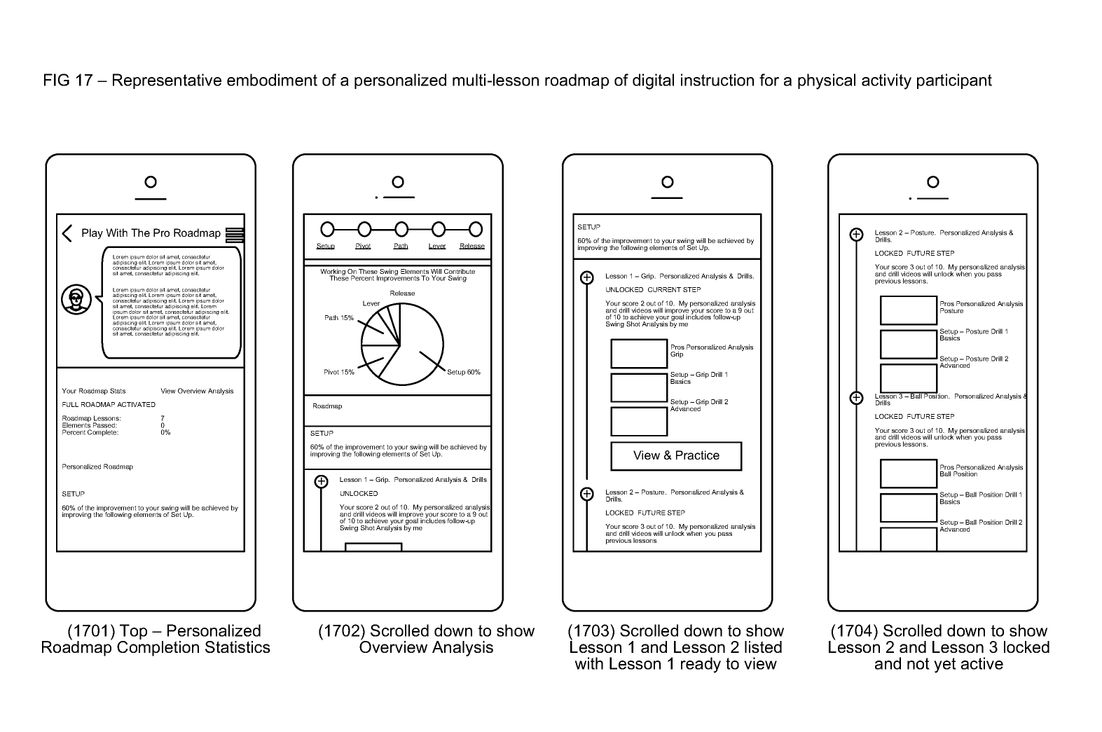

FIG. 17 depicts an example embodiment of a personalized, multi-lesson roadmap of digital instruction for a physical activity participant. This instruction may be provided by one or more computing devices 7100, computing devices 7200, or a combination thereof, described below. The illustrated examples show a user interface presented on a participant's mobile device. The top of the screen 1701 may display roadmap completion stats and a personalized message from the lead instructor. When the “view overview analysis” link is tapped, a roadmap high level visualization 1702 may indicate with color coding and underlining which major movement elements contain Lessons for the participant based on instructor's evaluation and scoring. A swing percent improvement analysis may show the percentage of overall improvement to the participant's swing that will be achieved through improvements in the major movement elements of the activity. For example in golf the swing percent improvement pie chart visualization shows that 40% of overall swing improvement will results from improvements to the Setup element of the swing, 15% from the Path element, etc. Scrolling further down the screen, individual lessons 1703 within the participant's roadmap of personalized instruction may be displayed. Lesson 1 is shown as unlocked and delivered. Lessons 2 and 3 1704 are shown as locked and not yet delivered.

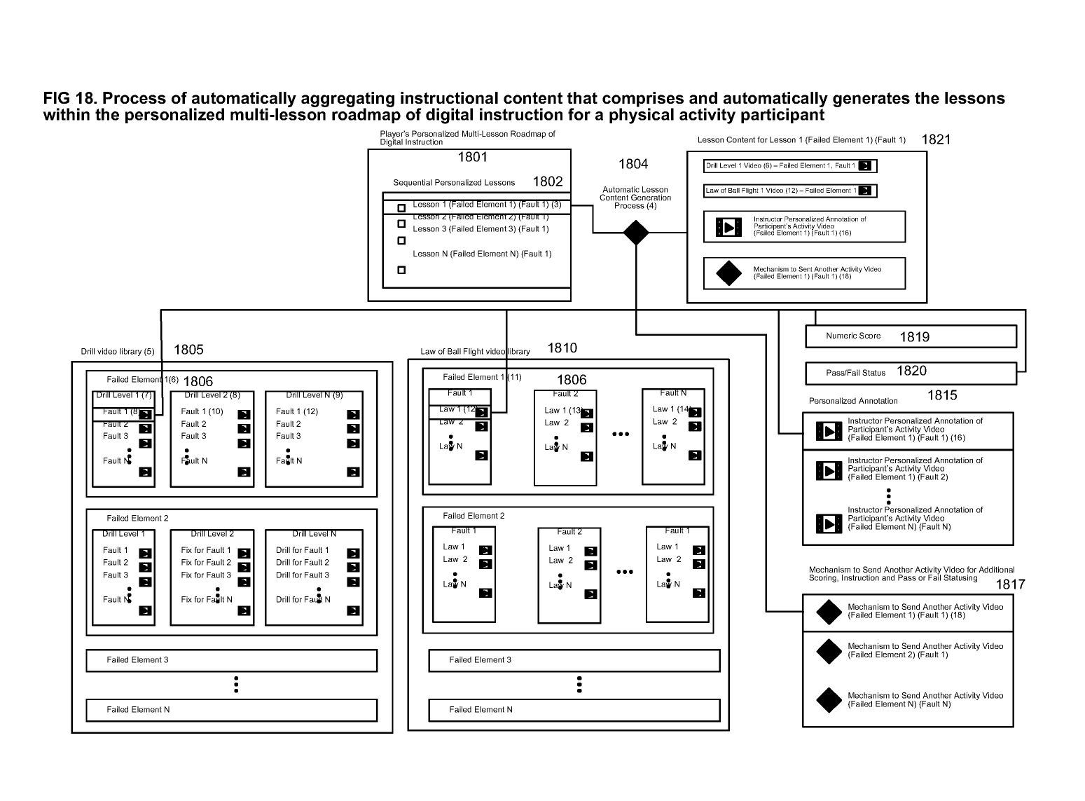

FIG. 18 depicts a process for automatically aggregating instructional content that comprises and automatically generates the lessons within the personalized multi-lesson roadmap of digital instruction for a physical activity participant. This process may be performed by one or more computing devices 7100, computing devices 7200, or a combination thereof, described below. For each of the sequential personalized lessons 1802 in the participant's personalized multi-lesson roadmap of digital instruction 1801, an automated lesson generation process 1804 may perform the following functions. The automated lesson generation process may interrogate the drill video library database 1805 to find drill videos that matches the failed movement subelement 1806 and subelement fault 1808 of the lesson. The automated lesson generation process may filter this drill video result set for a drill video that matches the number of additional participant movement videos that the participant has transmitted to the instructor for the lesson. For example, if the count of additional movement videos transmitted back to the instructor is 0, then a primary drill video is returned. If the count of additional movement videos transmitted back to the instructor is 1, then a secondary drill video is returned. This may enable additional instruction to be delivered by the lesson when a participant has failed their first additional movement video. The automated lesson generation process may interrogate the law of ball flight video library database 1810 to find law of ball flight videos that match the failed movement subelement 1806 and subelement fault 1808 of the lesson. The automated lesson generation process may retrieve the personalized voice and drawing annotations 1815 that the instructor has created for the participant's personalized lesson. The automated lesson generation process may utilize a rules engine to determine whether a mechanism to transmit another movement video from participant to instructor for the lesson 1817 should be exposed. The rules engine may enable a configurable maximum number of additional movement videos to be transmitted from participant to instructor, after which the participant may be given a status of skipped on the lesson, and the mechanism to transmit additional movement videos for the lesson may be disabled. Finally, the automated lesson generation process may compile all of these inputs into the lesson content for the lesson 1821.

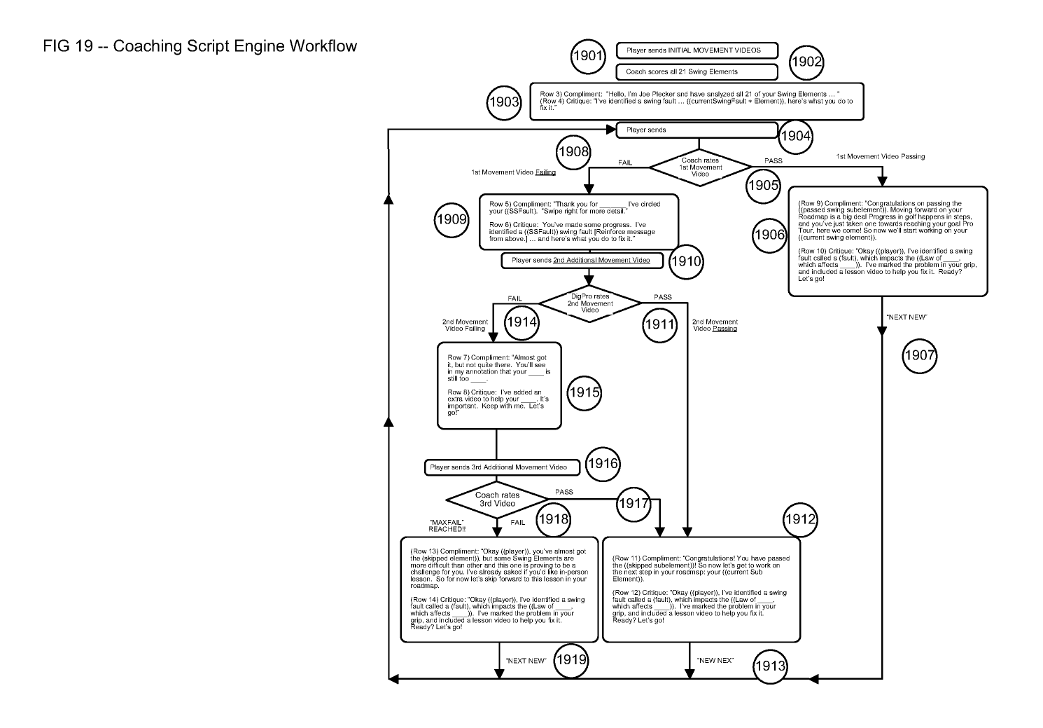

FIG. 19 depicts an example embodiment of the workflow for an automated coaching script engine. This process may be performed by one or more computing devices 7100, computing devices 7200, or a combination thereof, described below. A physical activity participant may transmit their initial movement videos 1901 for instructor evaluation and scoring. The instructor may score all movement subelements of the participant's movement in the videos 1902, which may enable the roadmap generation algorithm to create a personalized roadmap of digital lessons for the participant where each lesson corresponds to a failed subelement. When ready to record the voice annotation audio file for the initial release of the participant's Lesson 1, the instructor may be prompted by the automated coaching script engine with two personalized coaching scripts 1903 that match the movement subelement, the pass/fail status, and the numeric count of additional movement videos transmitted from participant to instructor in Lesson 1. The first coaching script may compliment the participant on facets of the movement done correctly. The second coaching script may critique the failed subelement and give instruction to correct it. These annotations may be recorded by the instructor and included in the initial delivery of Lesson 1.

After consuming the Lesson 1 content, the participant may transmit their first additional movement video to the instructor for reevaluation in Lesson 1 1904. If the instructor passes the participant on this video because the movement subelement was performed with a passing score 1905, the instructor may be prompted by the automated coaching script engine with two personalized coaching scripts 1906 that match the movement subelement, the pass/fail status, and the numeric count of additional movement videos transmitted from participant to instructor in Lesson 1. In this case, the first coaching script may congratulate the participant for passing Lesson 1, and the second coaching script may critique the participant on the subelement fault that is the subject of Lesson 2. The automated lesson delivery process may then unlock Lesson 2 1907, which may become the next/new Lesson delivered to the participant's roadmap.

If the instructor fails the participant on the first additional movement video transmitted from participant to instructor on Lesson 1 because the movement subelement continued to be performed with a failing score 1908, the instructor may be prompted by the automated coaching script engine with two personalized coaching scripts 1909 that match the movement subelement, the pass/fail status, and the numeric count of additional movement videos transmitted from participant to instructor in Lesson 1. The first coaching script may compliment the participant on facets of the movement done correctly. The second coaching script may offer additional critiques of the subelement that continues to be failed and may give instructions to correct it. These annotations may be recorded by the instructor and included in delivery of updated content to the participant's Lesson 1.

After consuming the updated Lesson 1 content, the participant may transmit their second additional movement video to the instructor for reevaluation in Lesson 1 1910. If the instructor passes the participant on this second video because the movement subelement was performed with a passing score 1911, the instructor may be prompted by the automated coaching script engine with two personalized coaching scripts 1912 that match the movement subelement, the pass/fail status, and the numeric count of additional movement videos transmitted from participant to instructor in Lesson 1. In this case, the first coaching script may congratulate the participant for passing Lesson 1 and the second coaching script may critique the participant on the subelement fault that is the subject of Lesson 2. The automated lesson delivery process may then unlock Lesson 2 1913, which may become the next/new Lesson delivered to the participant's roadmap.

If the instructor fails the participant on the second additional movement video transmitted from participant to instructor on Lesson 1 because the movement subelement continued to be performed with a failing score 1914, the instructor may be prompted by the automated coaching script engine with two personalized coaching scripts 1915 that match the movement subelement, the pass/fail status, and the numeric count of additional movement videos transmitted from participant to instructor in Lesson 1. The first coaching script may compliment the participant on facets of the movement done correctly. The second coaching script may offer additional critiques of the subelement that continues to be failed and may give instructions to correct it. These annotations may be recorded by the instructor and included in delivery of updated content to the participant's Lesson 1.

After consuming the updated Lesson 1 content, the participant may transmit their third additional movement video to the instructor for reevaluation in Lesson 1 1916. If the instructor passes the participant on this third video because the movement subelement was performed with a passing score 1917, the instructor may be prompted by the automated coaching script engine with two personalized coaching scripts 1912 that match the movement subelement, the pass/fail status, and the numeric count of additional movement videos transmitted from participant to instructor in Lesson 1. In this case, the first coaching script may congratulate the participant for passing Lesson 1, and the second coaching script may critique the participant on the subelement fault that is the subject of Lesson 2. The automated lesson delivery process may unlock Lesson 2 1913, which may become the next/new Lesson delivered to the participant's roadmap.

If the instructor fails the participant on the third additional movement video transmitted from participant to instructor on Lesson 1 because the movement subelement continued to be performed with a failing score 1914, the instructor may be prompted by the automated coaching script engine with two personalized coaching scripts 1918 that match the movement subelement, the pass/fail status, and the numeric count of additional movement videos transmitted from participant to instructor in Lesson 1. The first coaching script may acknowledge that the participant still needs more work on the subelement that continues to be failed and may suggest a physical, in-person lesson. The second coaching script may critique the participant on the subelement fault that is the subject of Lesson 2. The automated lesson delivery process may unlock Lesson 2 1919, which may become the next/new Lesson delivered to the participant's roadmap.

This basic pattern of the automated coaching script engine may repeat through every lesson, with every subelement fault, throughout the participant's roadmap, drawing its personalized inputs from an automated coaching script engine mapping table in the data model.

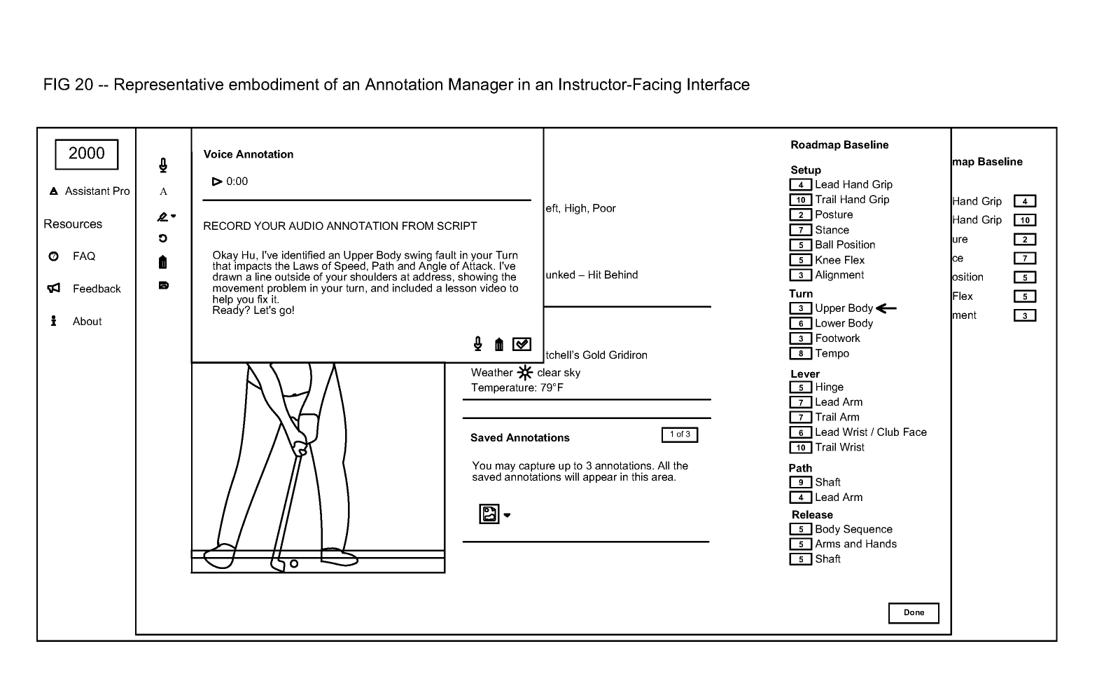

FIG. 20 depicts an embodiment of an annotation manager interface for instructors to use to create instructional annotations associated with the physical activity movement videos transmitted by physical activity participants 2000. This interface may be provided by one or more computing devices 7100, computing devices 7200, or a combination thereof, described below. The coaching script may be pre-populated by the automated coaching script engine into this interface 2000 (e.g., “Okay, Hu, I've identified an Upper Body swing fault in your Turn that impacts the Laws of Speed, Path and Angle of Attack. I've drawn a line outside of your shoulders . . . ” The script prompt may be ergonomically clustered together with the controls in the interface for an instructor to record the personalized coaching script as a voice annotation audio file that will be delivered with the other components of the participant's lesson.

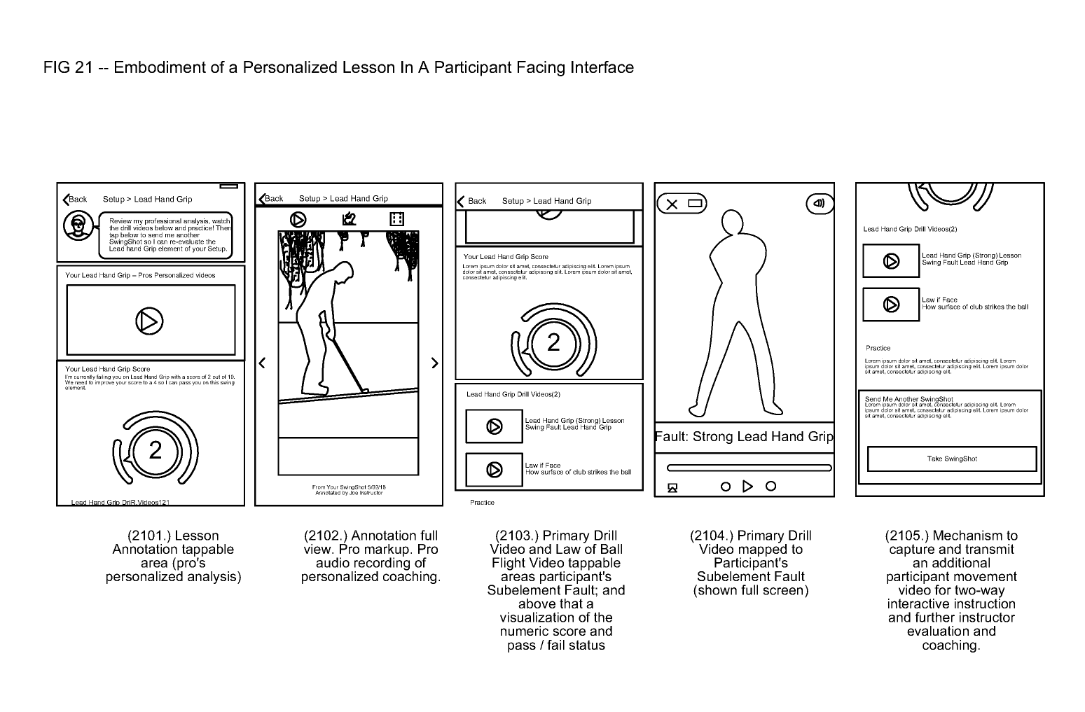

FIG. 21 depicts an example embodiment of a personalized lesson in participant facing interface. This interface may be provided by one or more computing devices 7100, computing devices 7200, or a combination thereof, described below. Personalized annotations (voice annotations and drawing annotations) may be accessible to the participant by tapping on the Lesson Annotation tappable area 2101. An annotation full view is shown 2102 that may contain instructor drawing (markup) annotations on still images taken from the participant's most recent movement video, and voice annotations playable as audio files when the participant taps the circular audio play button in the banner above the image. Multiple annotations may be recorded and drawn by the instructor and may be viewable in the participant interface by swiping left or right within the annotations full view. A numeric score and pass/fail status and/or a list of subelement fault specific drill videos and law of ball flight videos may be seen by scrolling down the lesson screen 2103. A mechanism 2105 to capture and transmit an additional participant movement video 2104 for instructor reevaluation may be shown within the lesson, giving the lessons a function in their two-way, instructor-to-participant and participant-to-instructor method of digital instruction.

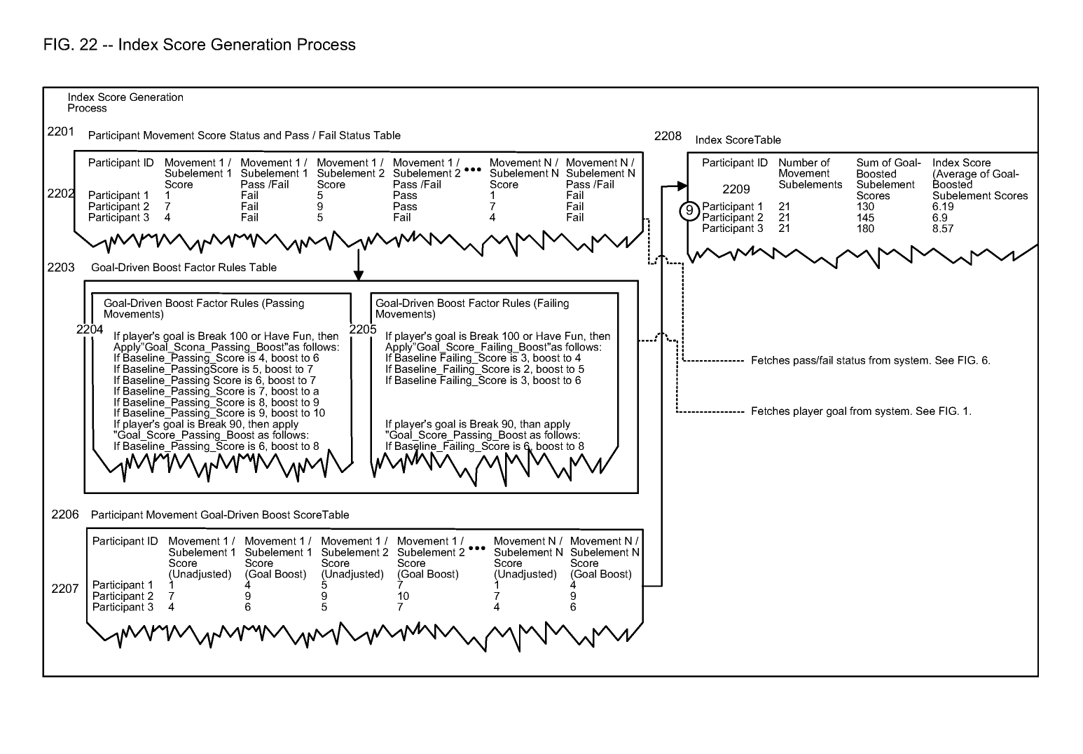

FIG. 22 depicts a goal-driven index score generation process in which a personalized, goal-driven index score analytic is created for a physical activity participant. This process may be performed by one or more computing devices 7100, computing devices 7200, or a combination thereof, described below. A participant record 2202 may be retrieved from a participant movement score status and pass/fail status table 2201 where the participant's record includes a numeric score and pass/fail status for all movement subelements in the movement subelement taxonomy. The participant's initial subelement scores may be given a goal-driven boost according to a goal-driven boost factor rules table 2203 where specific boost factors are applied to the participant's passing subelement scores, and other boost factors are applied to the participant's failing subelement scores, based upon the normalized goal that the participant selected in their profile. For example, boost factor rules are shown for the passing subelement scores for a golf player whose goal is to “Break 100” 2204, and boost factor rules are shown for the failing subelement scores for the golfer with the goal to “Break 100” 2205. The boosted subelement scores may be stored in a participant movement goal-driven boost score table 2206 where the participant's record indicates their boosted subelement scores 2207 for all movement subelements in the movement subelement taxonomy. The index score 2208 (average of goal-boosted subelement scores) may then be calculated 2209.

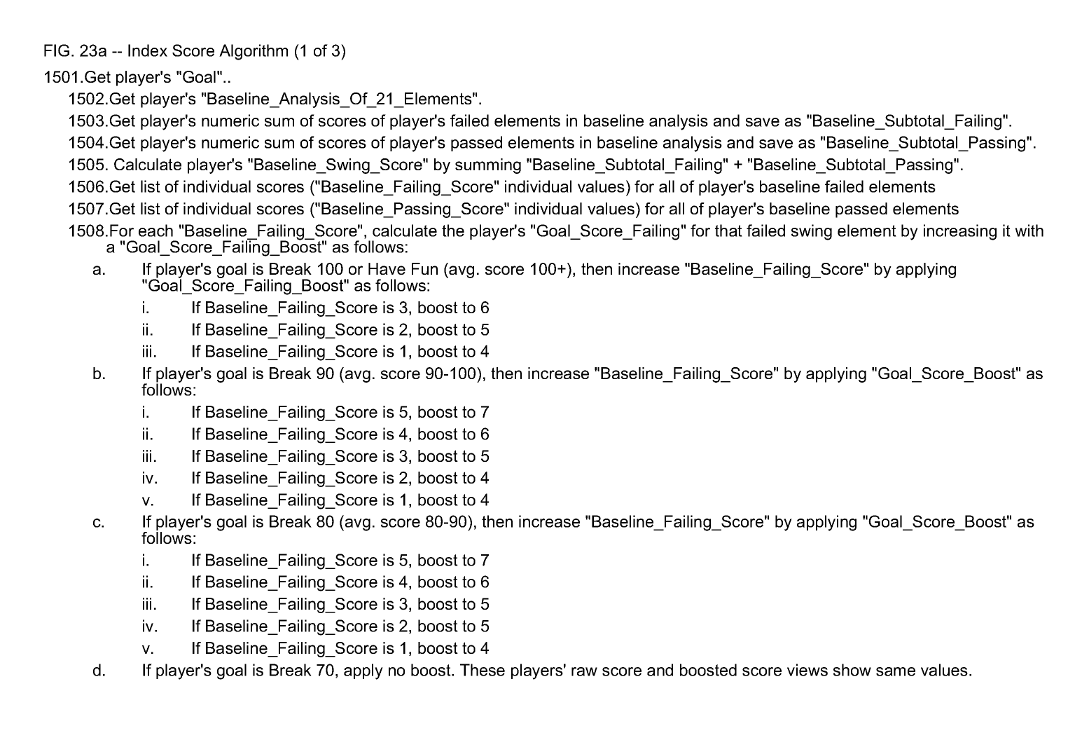

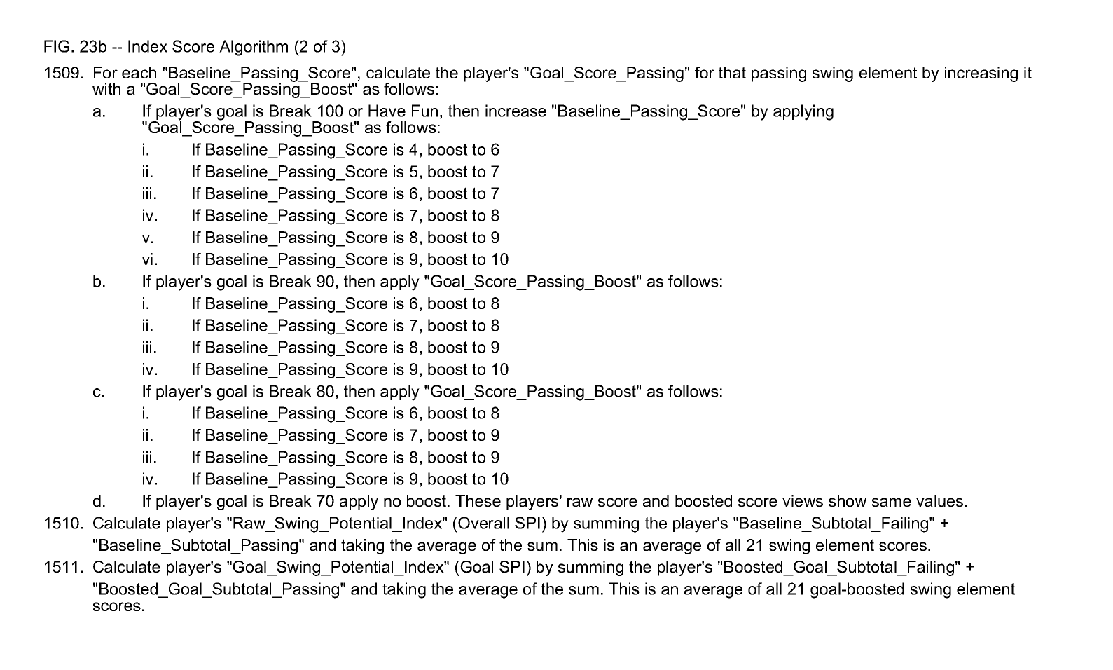

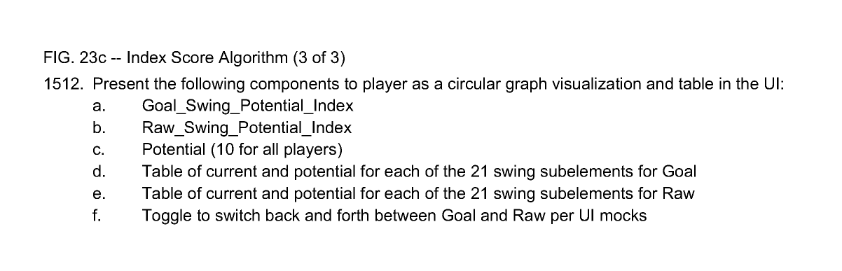

FIGS. 23A-23C depict an embodiment of an algorithm for the generation of a personalized, goal-driven index score analytic for a physical activity participant. This algorithm may be performed by one or more computers associated with the central repository described above and/or used by the physical activity participant and/or by the instructor, for example. In some embodiments, the algorithm may be performed by one or more computing devices 7100, computing devices 7200, or a combination thereof, described below.

At step 1501, the computer may get the player's “goal,” for example as described above. At step 1502, the computer may get the player's “Baseline_Analysis_Of_21_Elements,” for example as described above. At step 1503, the computer may get the player's numeric sum of scores of player's failed elements in baseline analysis and save as “Baseline_Subtotal_Failing”. At step 1504, the computer may get the player's numeric sum of scores of player's passed elements in baseline analysis and save as “Baseline_Subtotal_Passing”. At step 1505, the computer may calculate the player's “Baseline_Swing_Score” by summing “Baseline_Subtotal_Failing”+“Baseline_Subtotal_Passing”. At step 1506, the computer may get a list of individual scores (“Baseline_Failing_Score” individual values) for all of player's baseline failed elements. At step 1507, the computer may get a list of individual scores (“Baseline_Passing_Score” individual values) for all of player's baseline passed elements.

At step 1508, for each “Baseline_Failing_Score”, the computer may calculate the player's “Goal_Score_Failing” for that failed swing element by increasing it with a “Goal_Score_Failing_Boost” according to one or more of the following examples.

If player's goal is Break 100 or Have Fun (avg. score 100+), then increase “Baseline_Failing_Score” by applying “Goal_Score_Failing_Boost” as follows: If Baseline_Failing_Score is 3, boost to 6; If Baseline_Failing_Score is 2, boost to 5; If Baseline_Failing_Score is 1, boost to 4.

If player's goal is Break 90 (avg. score 90-100), then increase “Baseline_Failing_Score” by applying “Goal_Score_Boost” as follows: If Baseline_Failing_Score is 5, boost to 7; If Baseline_Failing_Score is 4, boost to 6; If Baseline_Failing_Score is 3, boost to 5; If Baseline_Failing_Score is 2, boost to 4; If Baseline_Failing_Score is 1, boost to 4.

If player's goal is Break 80 (avg. score 80-90), then increase “Baseline_Failing_Score” by applying “Goal_Score_Boost” as follows: If Baseline_Failing_Score is 5, boost to 7; If Baseline_Failing_Score is 4, boost to 6; If Baseline_Failing_Score is 3, boost to 5; If Baseline_Failing_Score is 2, boost to 5; If Baseline_Failing_Score is 1, boost to 4.

If player's goal is Break 70, apply no boost. These players' raw score and boosted score views may show the same values.

At step 1509, for each “Baseline_Passing_Score”, calculate the player's “Goal_Score_Passing” for that passing swing element by increasing it with a “Goal_Score_Passing_Boost” according to one or more of the following examples.

If player's goal is Break 100 or Have Fun, then increase “Baseline_Passing_Score” by applying “Goal_Score_Passing_Boost” as follows: If Baseline_Passing_Score is 4, boost to 6; If Baseline_Passing_Score is 5, boost to 7; If Baseline_Passing_Score is 6, boost to 7; If Baseline_Passing_Score is 7, boost to 8; If Baseline_Passing_Score is 8, boost to 9; If Baseline_Passing_Score is 9, boost to 10.

If player's goal is Break 90, then apply “Goal_Score_Passing_Boost” as follows: If Baseline_Passing_Score is 6, boost to 8; If Baseline_Passing_Score is 7, boost to 8; If Baseline_Passing_Score is 8, boost to 9; If Baseline_Passing_Score is 9, boost to 10.

If player's goal is Break 80, then apply “Goal_Score_Passing_Boost” as follows: If Baseline_Passing_Score is 6, boost to 8; If Baseline_Passing_Score is 7, boost to 9; If Baseline_Passing_Score is 8, boost to 9; If Baseline_Passing_Score is 9, boost to 10.

If player's goal is Break 70 apply no boost. These players' raw score and boosted score views may show the same values.

At 1510, the computer may calculate the player's “Raw_Swing_Potential_Index” (Overall SPI) by summing the player's “Baseline_Subtotal_Failing”+“Baseline_Subtotal_Passing” and taking the average of the sum. This may be an average of all 21 swing element scores.

At 1511, the computer may calculate the player's “Goal_Swing_Potential_Index” (Goal SPI) by summing the player's “Boosted_Goal_Subtotal_Failing”+“Boosted_Goal_Subtotal_Passing” and taking the average of the sum. This may be an average of all 21 goal-boosted swing element scores.

At 1512, the computer may present one or more of the following components to player as a circular graph visualization and table in the UI: Goal_Swing_Potential_Index; Raw_Swing_Potential_Index; Potential (10 for all players); Table of current and potential for each of the 21 swing subelements for Goal; Table of current and potential for each of the 21 swing subelements for Raw; Toggle to switch back and forth between Goal and Raw per UI mocks.

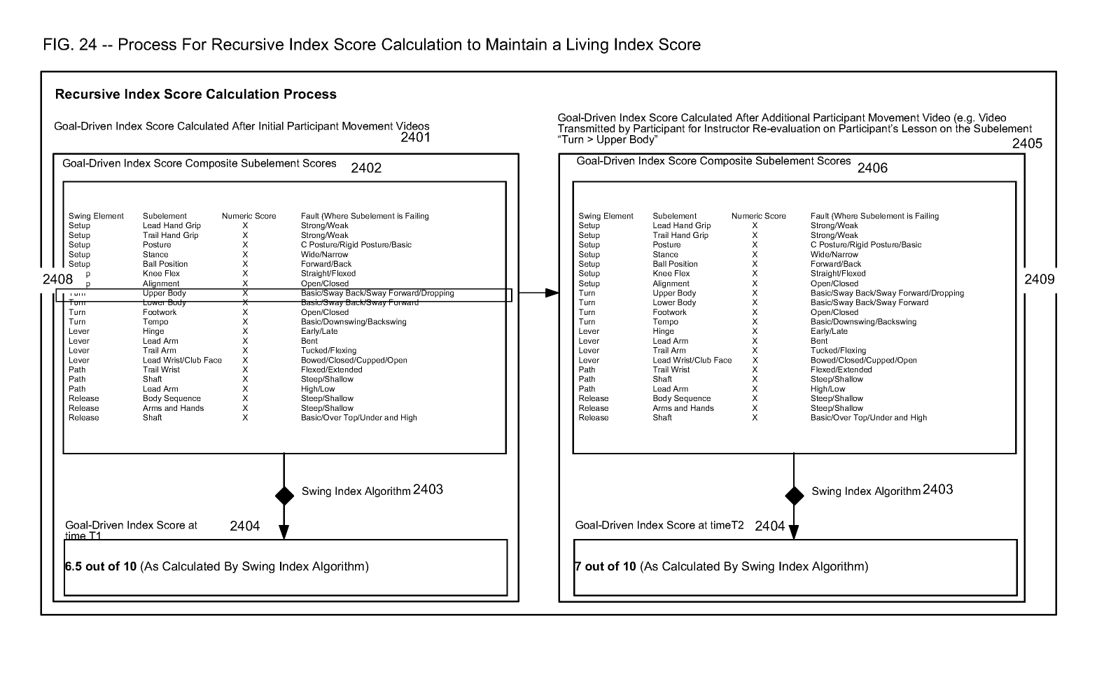

FIG. 24 depicts an example embodiment of a process for recursive goal-driven index score calculation and updating to maintain a current, living index score with new inputs over time. This process may be performed by one or more computing devices 7100, computing devices 7200, or a combination thereof, described below. At time T1, a participant may have a goal-driven index score of 6.5 2404 as calculated by the index score algorithm 2403 based upon their participant-specific set of composite subelement scores 2402 at that time obtained by an instructor scoring their initial participant movement videos 2401. In this initial subelement scoring, the participant's numeric score on the Upper Body subelement of the Turn element was “X” 2408. At time T2, which occurs at some interval after time T1, the participant may transmit an additional movement video to the instructor for re-evaluation of the Upper Body subelement of the Turn element of their swing 2405. Upon reevaluation, the subelement score given to Turn>Upper Body by the instructor at time T2 is “Y” 2409, where Y is an integer larger than the participant's previous score of X on this subelement in this example. Upon rescoring of this subelement, the index score algorithm 2403 may recalculate the participant's index score as 7 2407 in this example, an increase of 0.5 over the participant's previous index score of 6.5. The index score may recalculate in this way each time a participant's subsequent movement videos are evaluated and scored by instructors. This may produce a living, dynamic, continuously updating analytic.

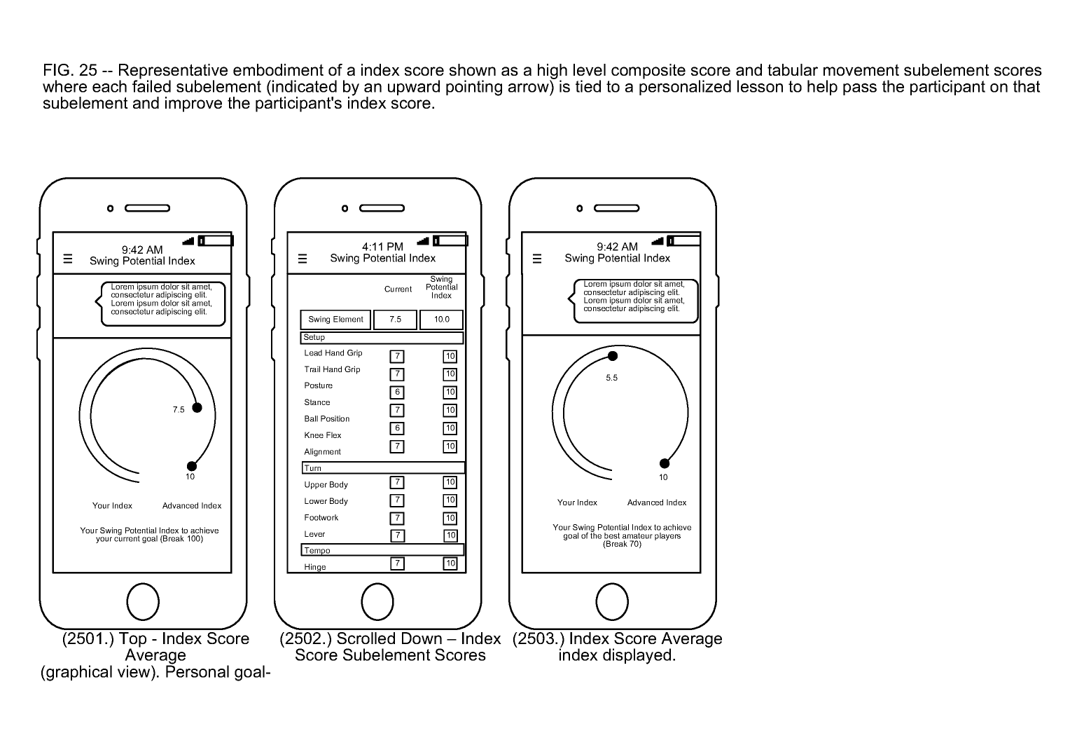

FIG. 25 depicts an example embodiment of an index score interface for physical activity participants. This interface may be provided by one or more computing devices 7100, computing devices 7200, or a combination thereof, described below. For example, this interface may be presented on a user device as shown. The top of the index score screen 2501 may show the goal-driven index score average of 7 (e.g., from the example of FIG. 24) represented as a circular graph calibrated to the participant's individual performance goal where a maximum score of 10 represents an improvement required to achieve that performance goal. Scrolling down the screen 2502, the participant may view a table of their individual movement subelement scores where each failed subelement (indicated by an upward pointing arrow) may be linked to a personalized lesson to help pass the participant on that subelement and improve the participant's index score. The advanced index is shown at far right 2503, which may show the participant's unaltered index score with goal-driven boost factors removed where a maximum score of 10 represents an improvement sufficient to achieve the goal of the best amateur participants, for example, in golf to “Break 70.”

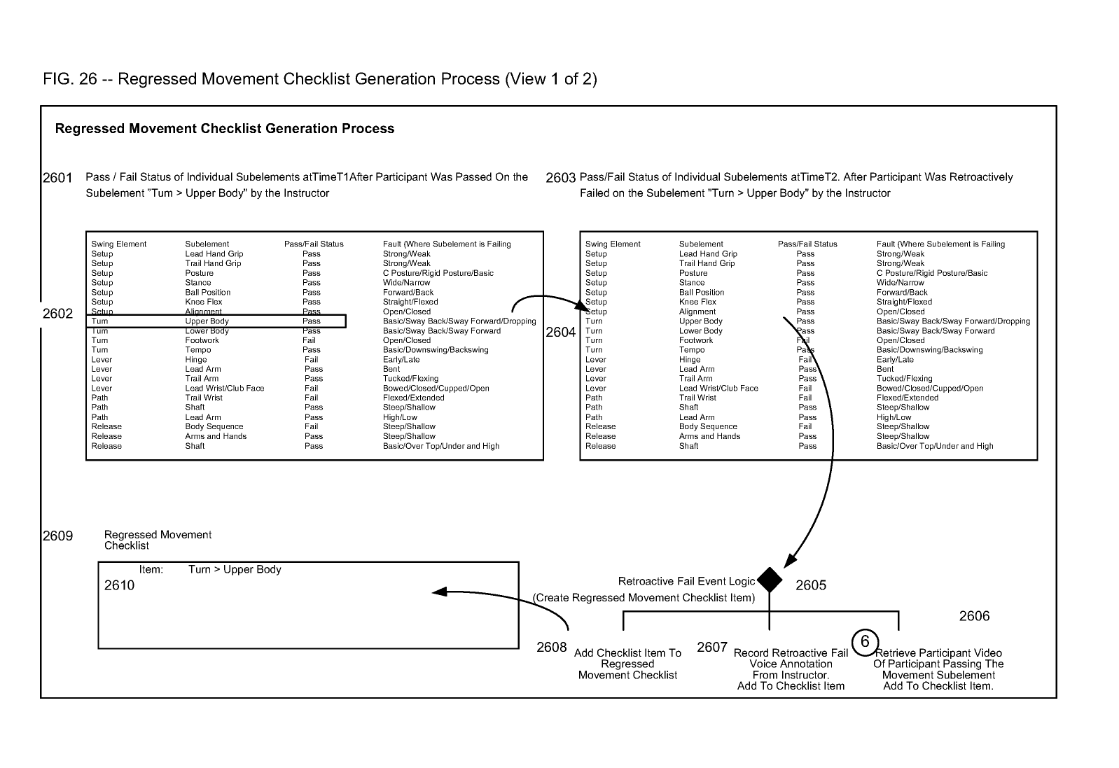

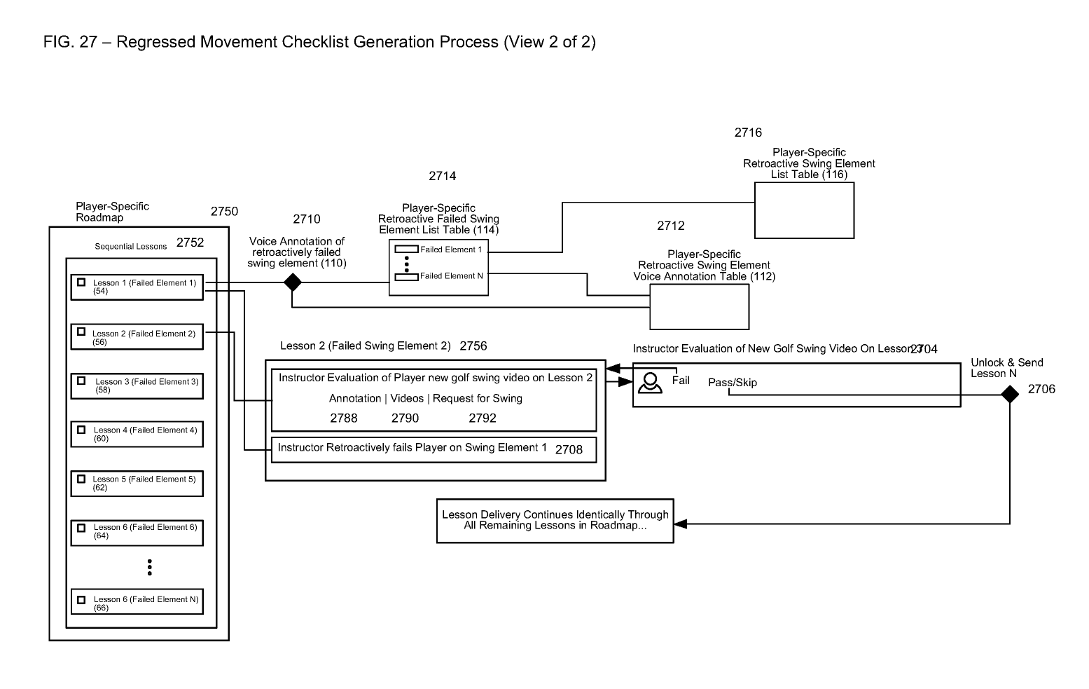

FIGS. 26 and 27 depict an automated generation process that produces a personalized regressed movement checklist for a physical activity participant. This process may be performed by one or more computing devices 7100, computing devices 7200, or a combination thereof, described below. At time T1 2601, a participant may have a collection of pass/fail statuses for all the movement subelements in the movement taxonomy. At time T1, the participant's subelement pass/fail status for the subelement Turn>Upper Body is “Pass” 2602 in the illustrated example. At time T2 2603, which is some interval of time after T1, the participant's collection of pass/fail statuses may be updated when an instructor evaluates an additional video transmitted by the participant for evaluation on another subelement such as Lever>Hinge. While scoring the additional participant video submitted by the participant for their lesson associated with the Lever>Hinge subelement, the instructor may notice a regression in the participant's Turn>Upper Body subelement and may give the participant an updated, lower, numeric score associated with a fail status 2604. This change from a pass to a fail status (a retroactive fail) on the Turn>Upper Body subelement may trigger retroactive fail logic 2605.

The retroactive fail logic 2605 may initiate the following actions. The retroactive fail logic may retrieve the participant's previous transmitted movement video in which the instructor passed them on Turn>Upper Body 2606. The retroactive fail logic may prompt the instructor to record a retroactive fail voice annotation audio file 2607. The retroactive fail logic may compile these elements 2608 into a regressed movement checklist item 2610 and add it to a regressed movement checklist 2609. The regressed movement checklist may allow participants to see when their instructor finds that they have regressed on a movement subelement and need to practice to return to their passing level of aptitude.

At some point, a participant may unlock Lesson 2 2756 of their personalized multi-lesson roadmap of digital instruction. While evaluating the participant's movement subelement for Lesson 2, the instructor may retroactively fail a previously passing subelement 2708 which was the subject of a previous lesson, Lesson 1 2754, as described above. This retroactive fail action may trigger retroactive fail logic that updates the score in the participant specific retroactively failed movement list table 2714, prompts the instructor to record a personalized retroactive fail voice annotation audio file 2710, store it in the participant specific regressed movement voice annotation table 2712, and add it to the regressed movement checklist table 2716. Separately, the system may retrieve a video of the participant passing the retroactively failed subelement and add it to the regressed movement checklist item, as noted above.

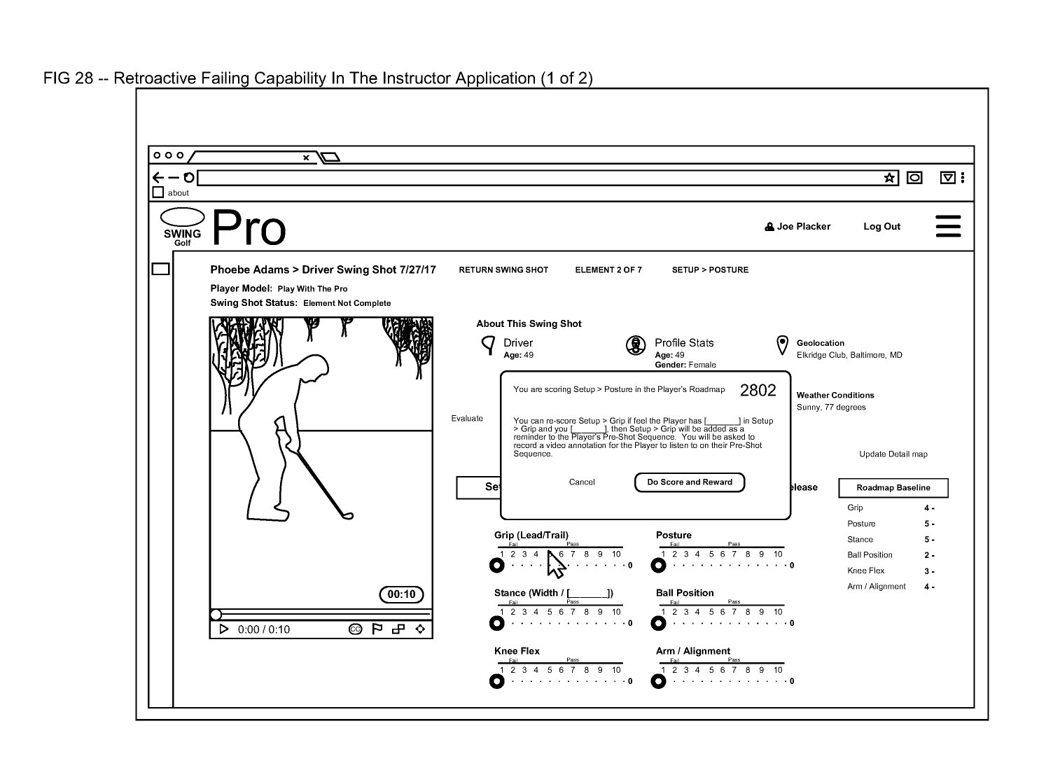

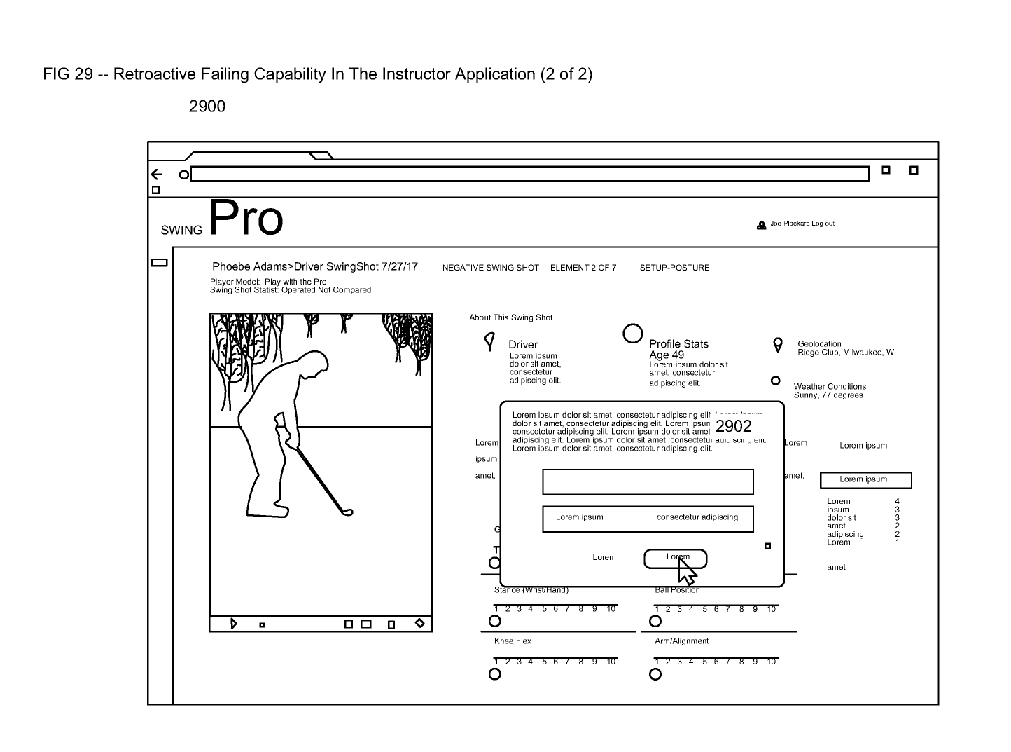

FIGS. 28 and 29 depict example embodiments of a retroactive failing capability in an instructor facing interface which causes an item to appear on the participant-facing personalized regressed movement checklist. This interface may be provided by one or more computing devices 7100, computing devices 7200, or a combination thereof, described below. In the first screen 2800, the Posture subelement of the participant's Setup movement element is highlighted and the other subelements of Setup are shown as gray. This may be because the instructor is re-evaluating an additional participant movement video that has been transmitted to show the participant's improvement in Posture. While doing this, the instructor may notice a regression in the Lead Hand Grip subelement which the participant had previous passed. The instructor may re-score Lead Hand Grip to a numeric score of 1, changing its status from pass to fail, in other words retroactively failing it. This action may cause a popup to appear asking the instructor to confirm the retroactive fail action 2802.

The second screen 2900 may show the next action in the retroactive fail workflow. After confirming the retroactive fail action on the previous screen 2800, a second popup may prompt the instructor to record a retroactive fail voice annotation audio file 2902. This annotation file may be compiled by the retroactive fail event logic, along with a video of the participant passing Lead Hand Grip, into a regressed movement checklist item and added to the participant's regressed movement checklist.

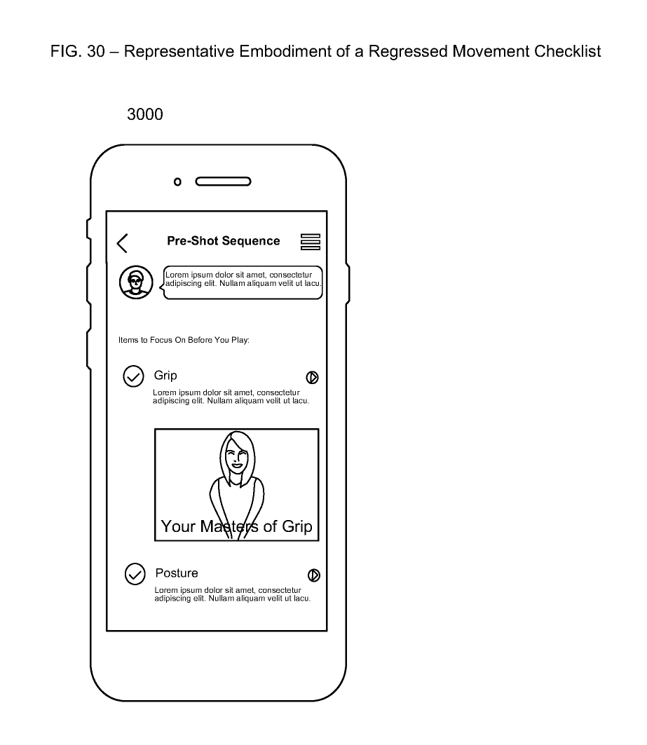

FIG. 30 depicts an example embodiment of a personalized regressed movement checklist interface for a physical activity participant. This interface may be provided by one or more computing devices 7100, computing devices 7200, or a combination thereof, described below. The personalized regressed item checklist screen 3000 may remind participants of submovements that need their attention the next time they take part in the physical activity because their instructor has noticed regression in these areas. Each regressed movement checklist item shown in this screen may contain a circular play audio button allowing the participant to hear the personalized regressed movement voice annotation recorded by the instructor and a video of the participant passing the movement subelement retrieved from the data attribute table within a storage medium. This feature may enable the participant to become their own example of a passed, correct movement subelement once they have initially passed it.

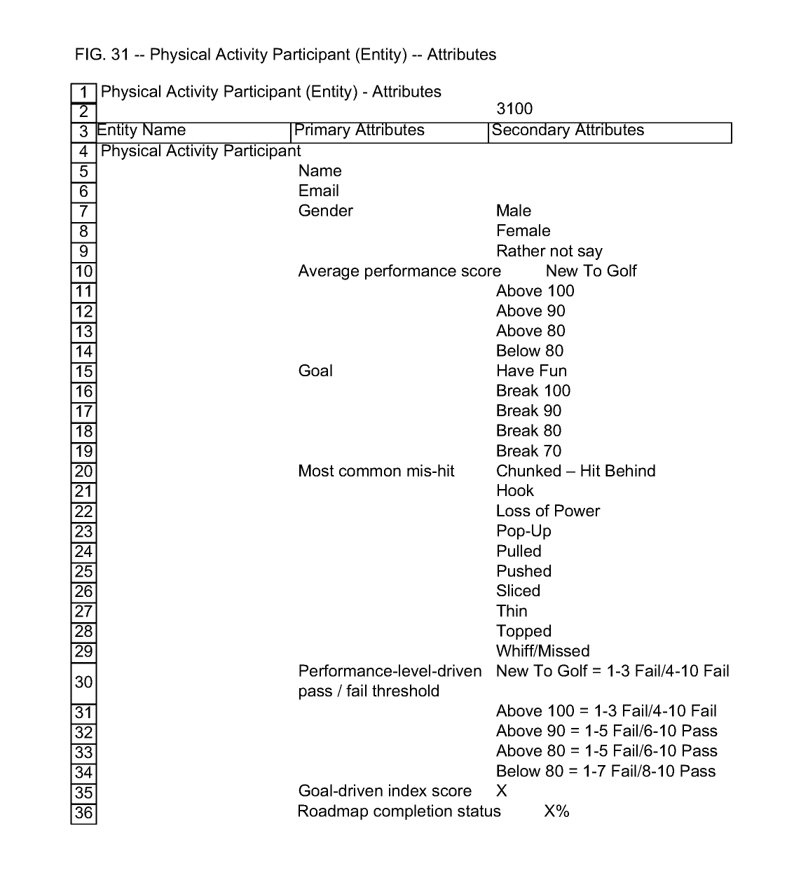

FIG. 31 depicts an example embodiment of a table defining the attributes of a physical activity participant that may be required for the functioning of the method and system for providing physical activity instruction 3100. Attributes may include, for example, name, email, gender, average performance score, goal, most common mis-hit, performance-level-driven pass/fail threshold, goal driven index score, roadmap completion status. Possible secondary, tertiary, and other attributes of these primary attributes are given in the table.

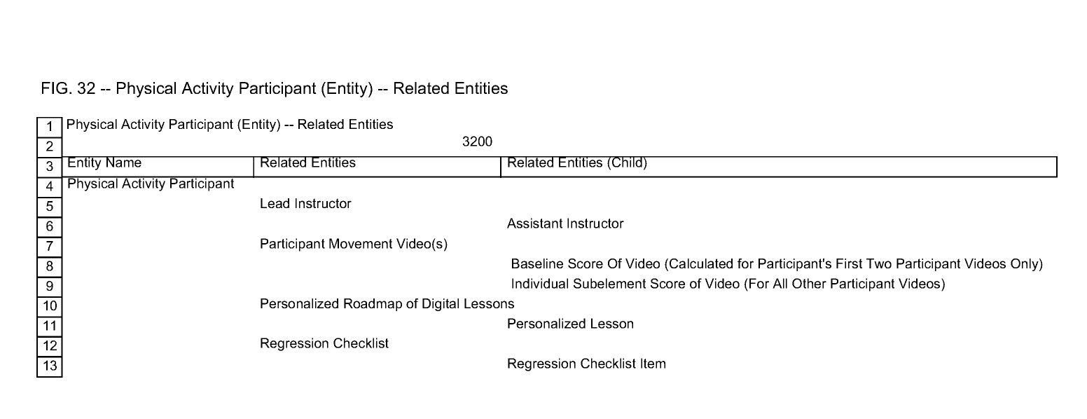

FIG. 32 depicts an example embodiment of a table defining the other entities related to a physical activity participant that may be required for the functioning of the method and system for providing physical activity instruction 3200. Related entities may include, for example, lead instructor, participant movement video(s), personalized roadmap of digital instruction, and regressed movement checklist. Possible child entities of these entities are given in the table.

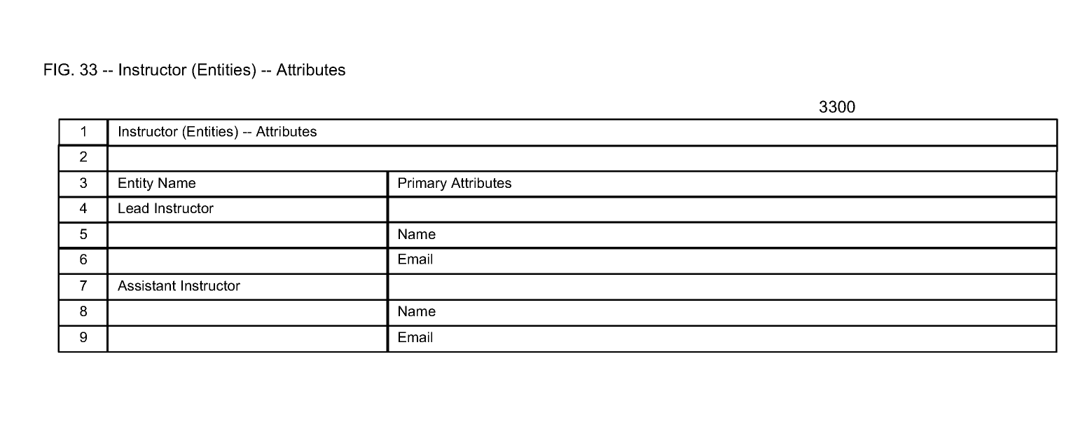

FIG. 33 depicts an example embodiment of a table defining the attributes of a lead instructor and assistant instructor that may be required for the functioning of the method and system for providing physical activity instruction 3300. Attributes for lead instructor may include, for example, name and email. Attributes for assistant instructor may include, for example, name and email. Possible secondary, tertiary, and other attributes of these primary attributes are given in the table.

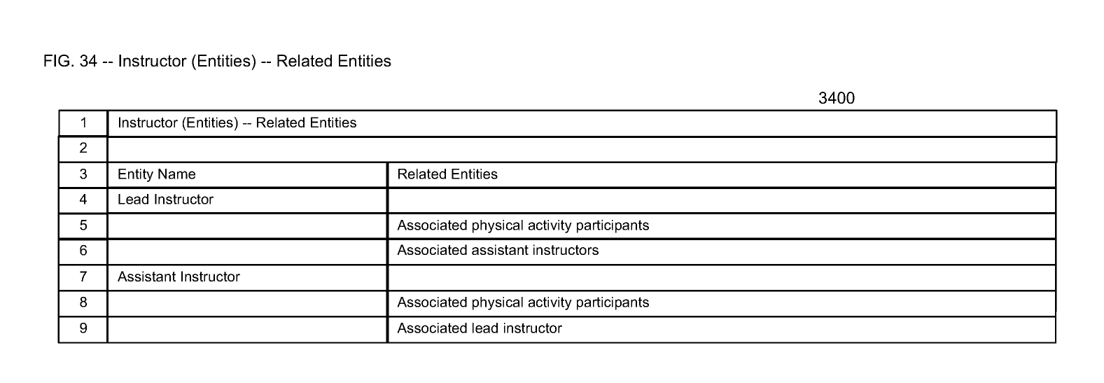

FIG. 34 depicts an example embodiment of a table defining the other entities related to a lead instructor and assistant instructor that may be required for the functioning of the method and system for providing physical activity instruction 3400. Related entities of a lead instructor may include, for example, associated physical activity participants and associated assistant instructors. Related entities of an assistant instructor may include, for example, associated physical activity participants and associated lead instructor.

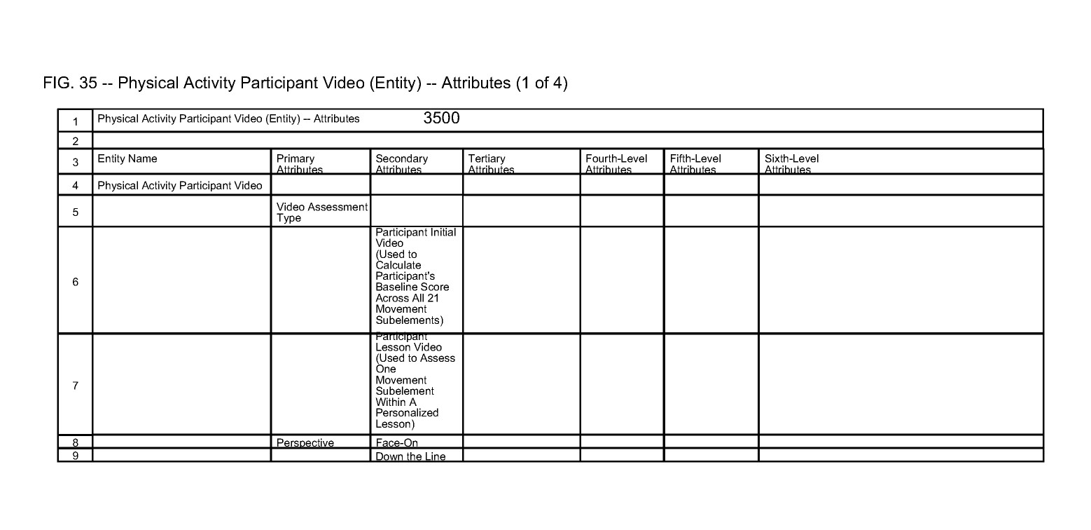

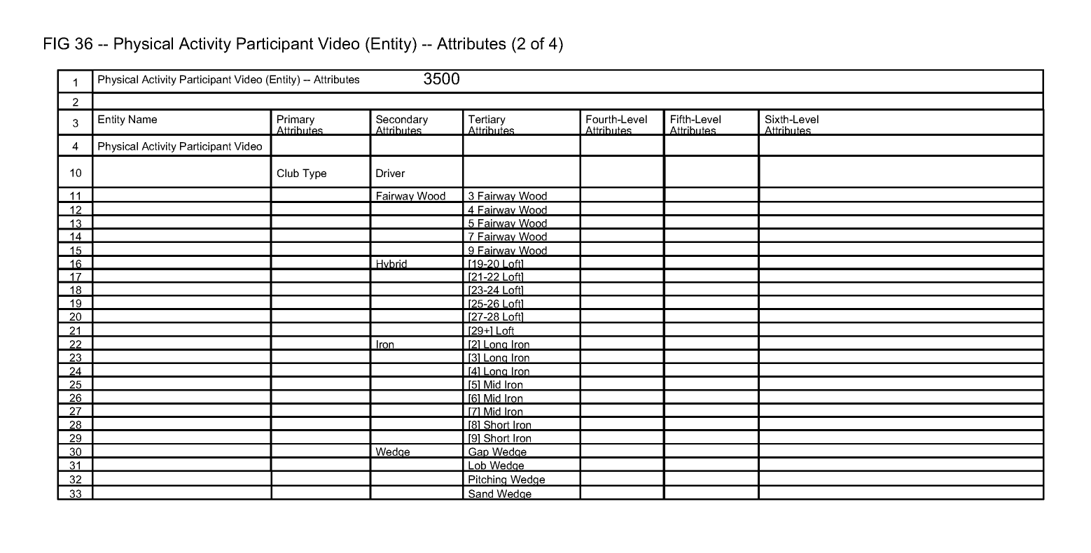

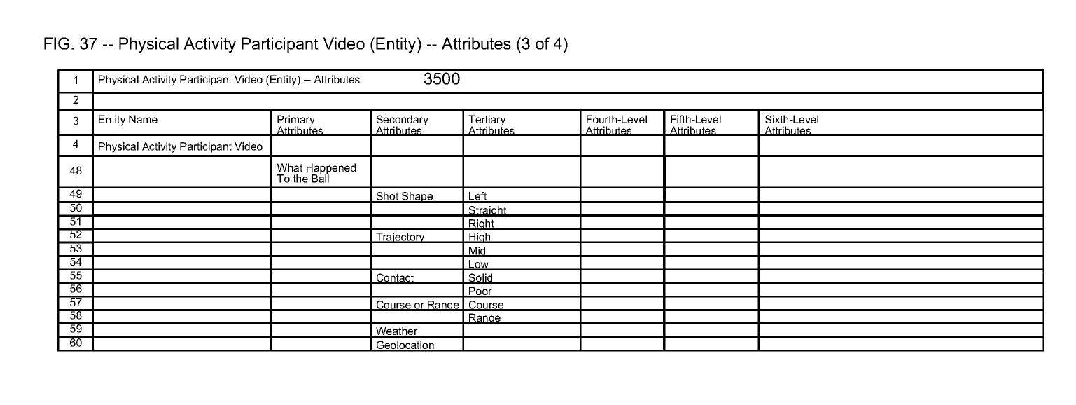

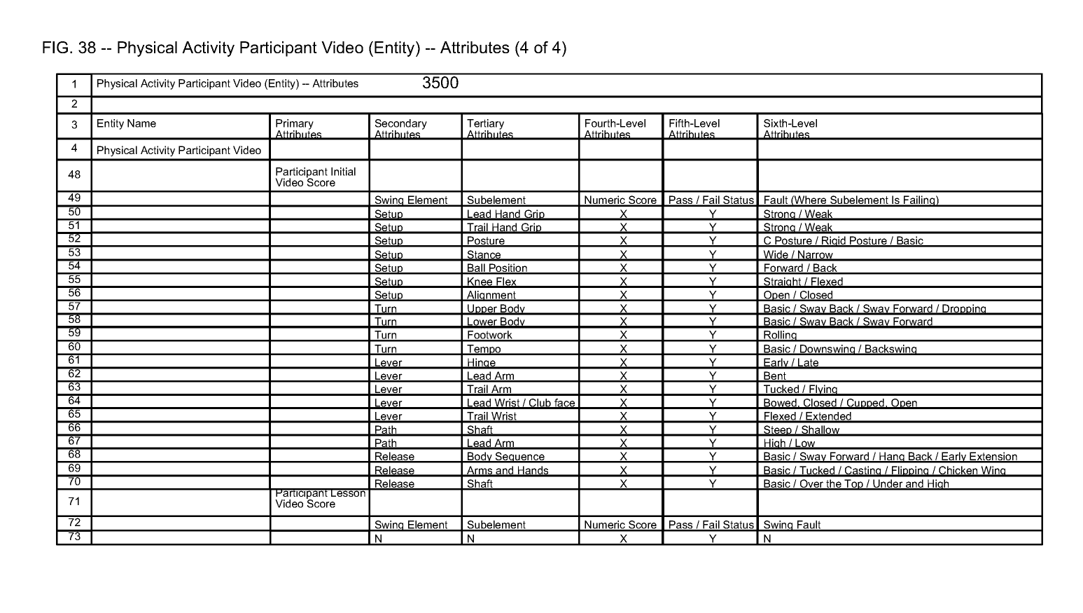

FIGS. 35-38 depict an example embodiment of a table defining the attributes of a physical activity participant video that may be required for the functioning of the method and system for providing physical activity instruction 3500. Attributes shown may include, for example, Video Assessment Type and Perspective, Club Type, What Happened To The Ball, Weather, Geolocation, participant initial video score, and participant lesson video score. Possible secondary, tertiary, and other attributes of these primary attributes are given in the table.

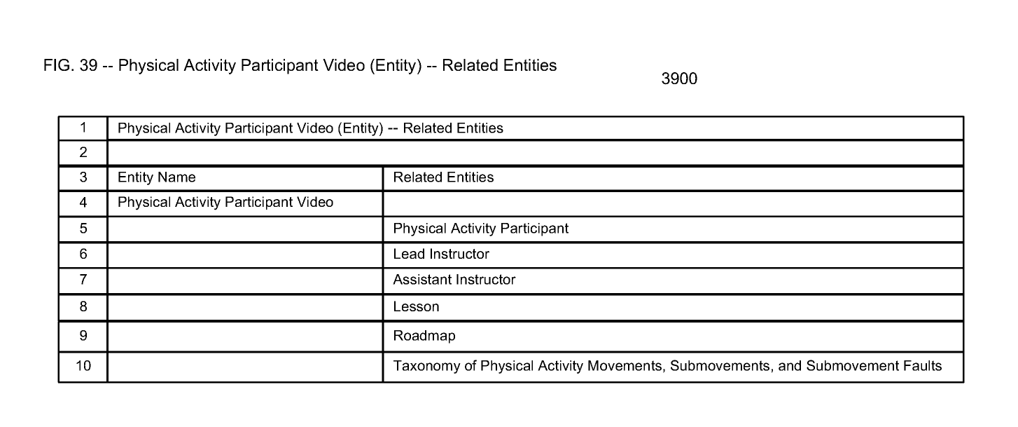

FIG. 39 depicts an example embodiment of a table defining the other entities related to a physical activity participant video that may be required for the functioning of the method and system for providing physical activity instruction 3900. Related entities may include, for example, physical activity participant, lead instructor, assistant instructor, lesson, roadmap, taxonomy of physical activity movements, submovements, and submovement faults.

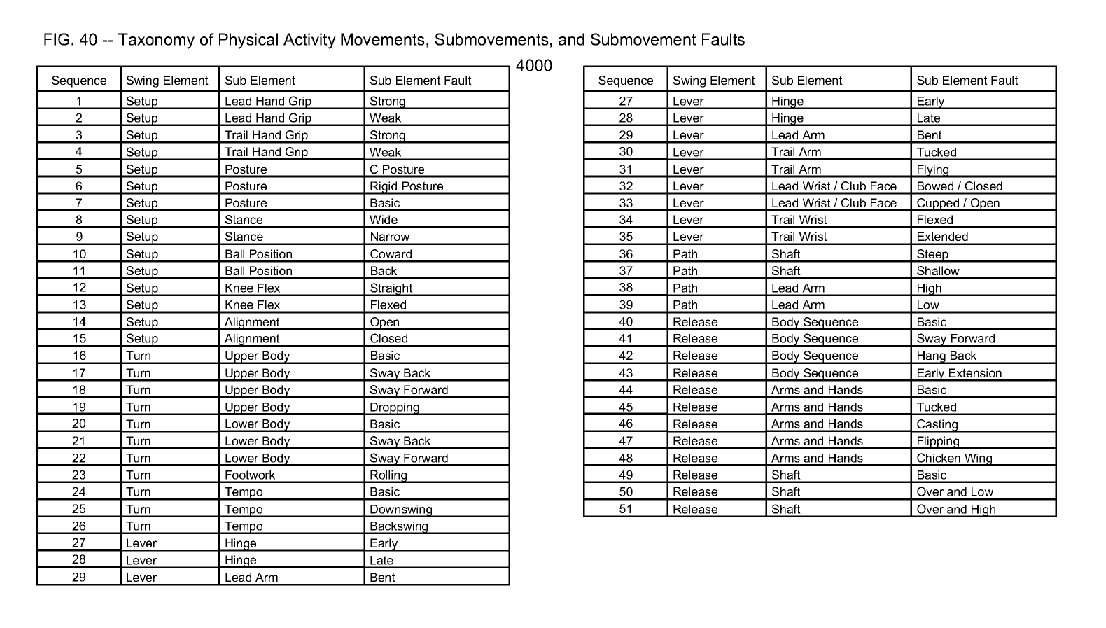

FIG. 40 depicts a taxonomy of physical activity movements, submovements, and submovement faults that may be utilized for instructor evaluation, scoring and assignment of submovement faults on physical activity participant movement videos 4000. The first level of the hierarchical taxonomy may include the movement elements Setup, Turn, Lever, Path and Release. The second level of the hierarchical taxonomy may include the movement subelements. The third level of the hierarchical taxonomy may include the movement subelement faults.

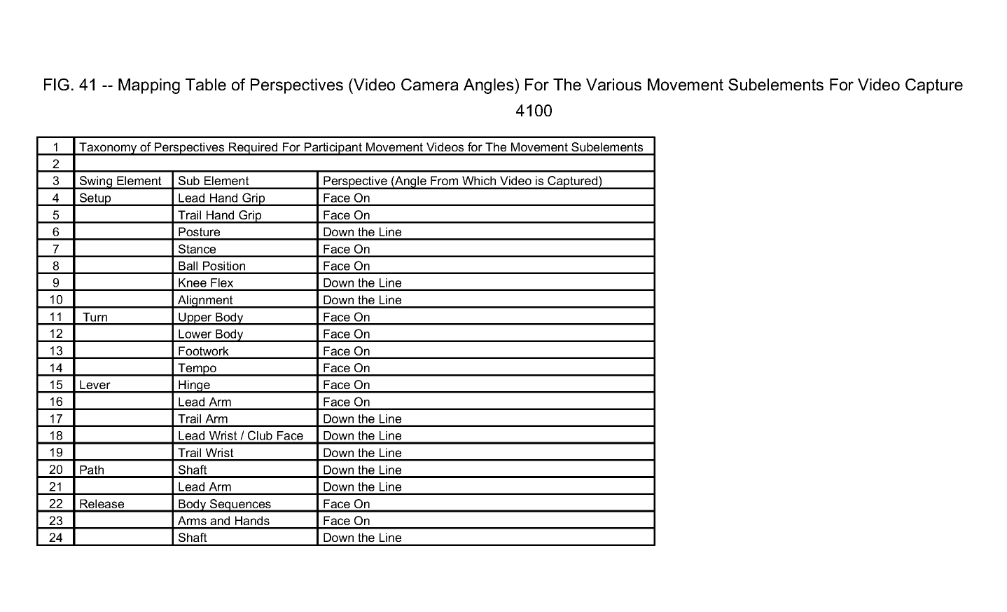

FIG. 41 depicts a mapping table of perspectives (video camera angles) for the various movement elements and subelements for video capture 4100. The movement elements and subelements may include Setup (Lead Hand Grip, Trail Hand Grip, Posture, Stance, Ball Position, Knee Flex and Alignment), Turn (Upper Body, Lower Body, Footwork and Tempo), Lever (Hinge, Lead Arm, Trail Arm, Lead Wrist/Club Face and Trail Wrist), Path (Shaft and Lead Arm), Release (Body Sequence, Arms and Hands, Shaft). The perspectives may include Face On (a camera angle shot from a position directly opposite the participant) and Down the Line (a camera angle shot from a position directly behind the participant). The mapping of a perspective to each individual movement subelement is given in the table. The mapping may provide a participant movement video that captures the movement subelement from the optimal angle for instructor review and scoring.

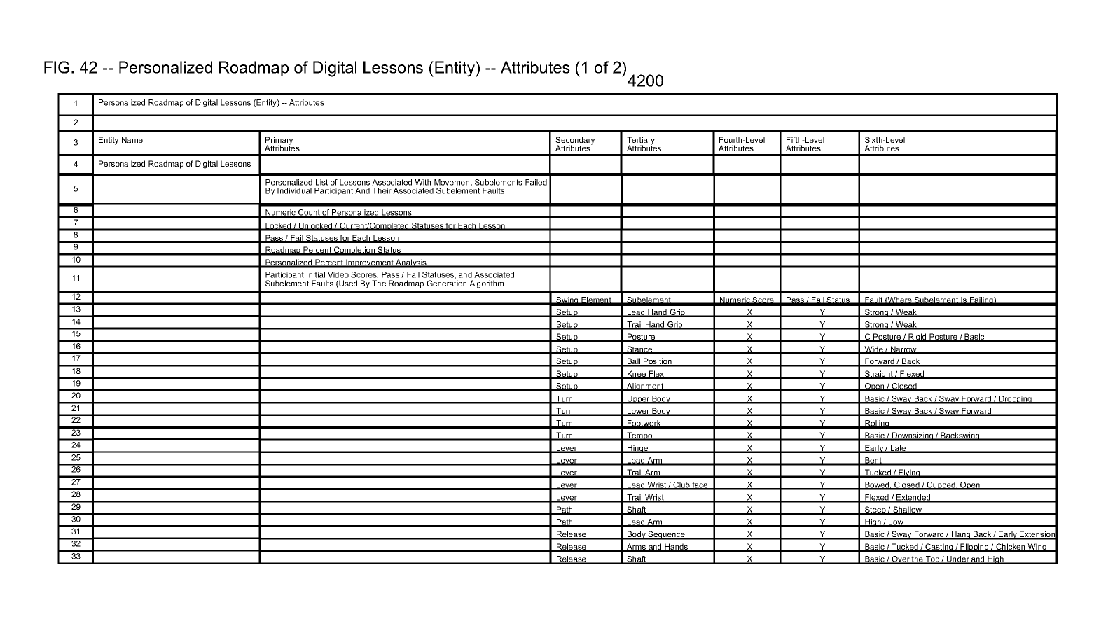

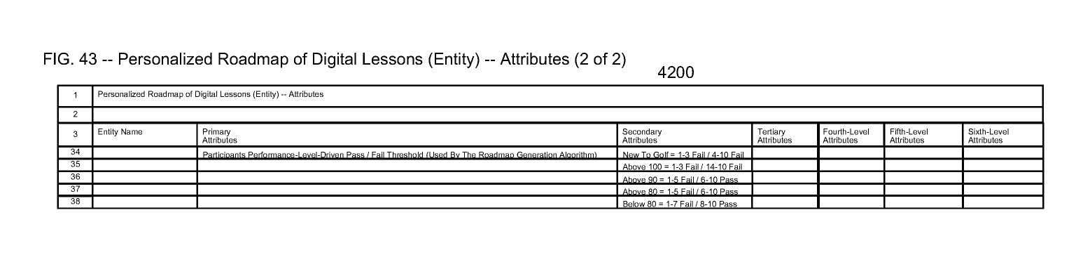

FIGS. 42-43 depict an example embodiment of a table defining the attributes of a personalized multi-lesson roadmap of digital lessons that may be required for the functioning of the method and system for providing physical activity instruction 4200. Attributes may include, for example, personalized list of lessons associated with movement subelements failed by individual participant and their associated subelement faults, numeric count of personalized lessons, locked/unlocked/current/completed statuses for each lesson; pass/fail statuses for each lesson, roadmap percent completion status, personalized percent improvement analysis, participant initial video scores, pass/fail statuses, and associated subelement fault (used by the roadmap generation algorithm), participant's performance-level-driven pass/fail threshold (used by the roadmap generation algorithm). Possible secondary, tertiary, and other attributes of these primary attributes are given in the table.

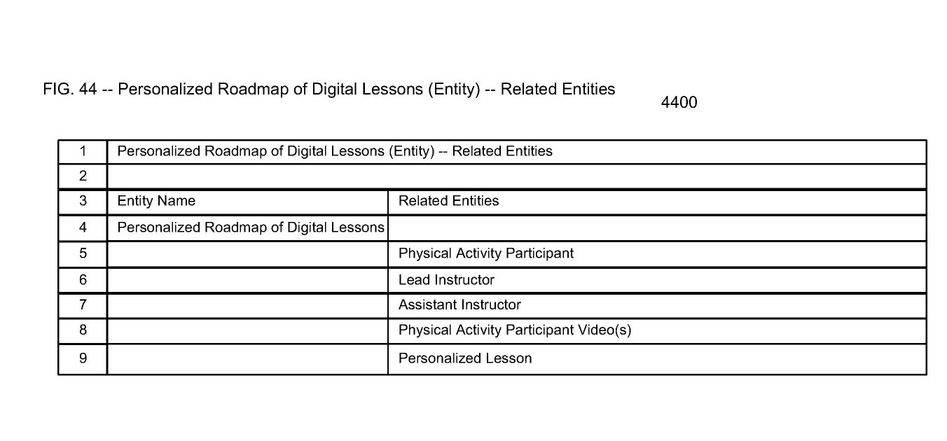

FIG. 44 depicts an example embodiment of a table defining the other entities related to a personalized multi-lesson roadmap of digital lessons that may be required for the functioning of the method and system for providing physical activity instruction 4400. Related entities may include, for example, physical activity participant, lead instructor, assistant instructor, physical activity participant video(s), personalized lesson.

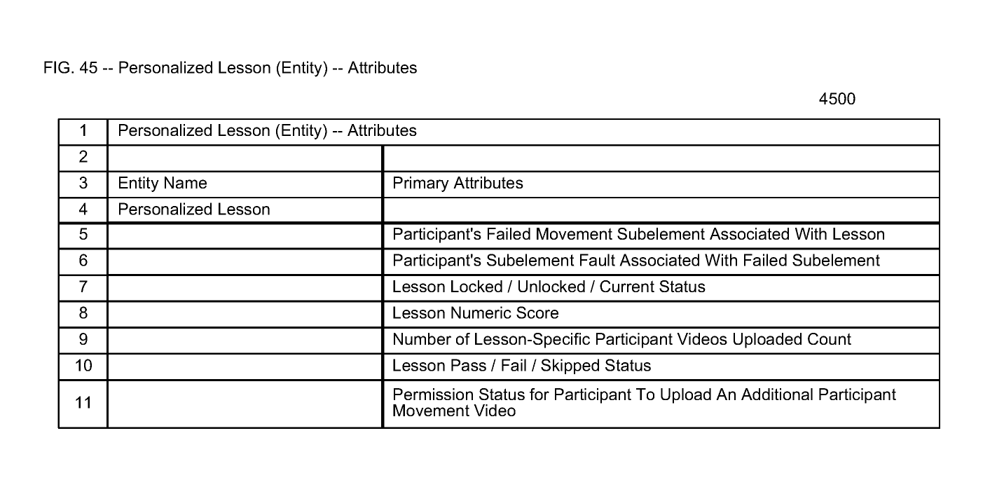

FIG. 45 depicts an example embodiment of a table defining the attributes of a personalized lesson that may be required for the functioning of the method and system for providing physical activity instruction 4500. Attributes may include, for example, participant's failed movement subelement associated with lesson, participant's subelement fault associated with the lesson, lesson locked/unlocked/current status, lesson numeric score, number of lesson-specific participant videos uploaded count, lesson pass/fail/skipped status, permission status for participant to upload an additional participant movement video.

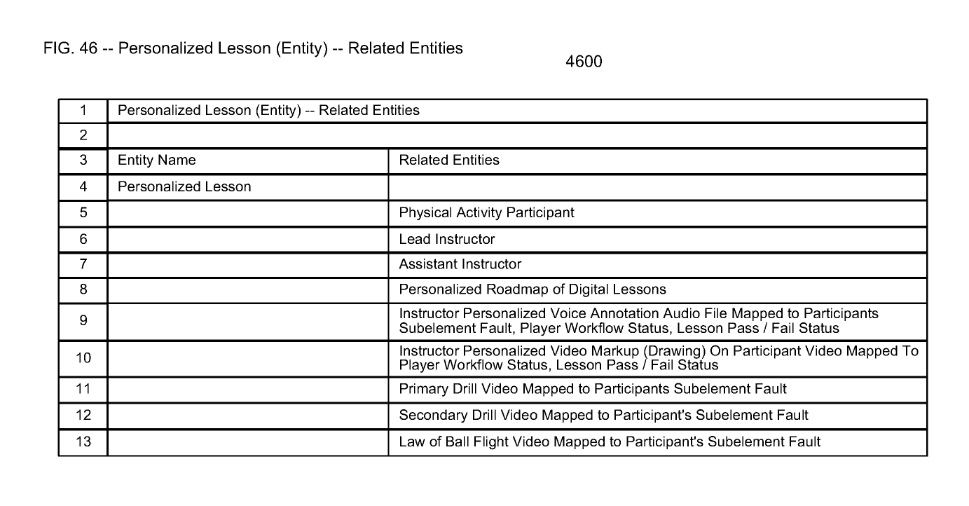

FIG. 46 depicts an example embodiment of a table defining the other entities related to a personalized lesson that may be required for the functioning of the method and system for providing physical activity instruction 4600. Related entities may include, for example, physical activity participant; lead instructor, assistant instructor; personalized roadmap of digital lessons; instructor personalized voice annotation audio file mapped to participant's subelement fault, participant workflow status, lesson pass/fail threshold; primary drill video mapped to participant's subelement fault in the lesson; secondary drill video mapped to participant's subelement fault in the lesson; law of ball flight video mapped to participant's subelement fault.

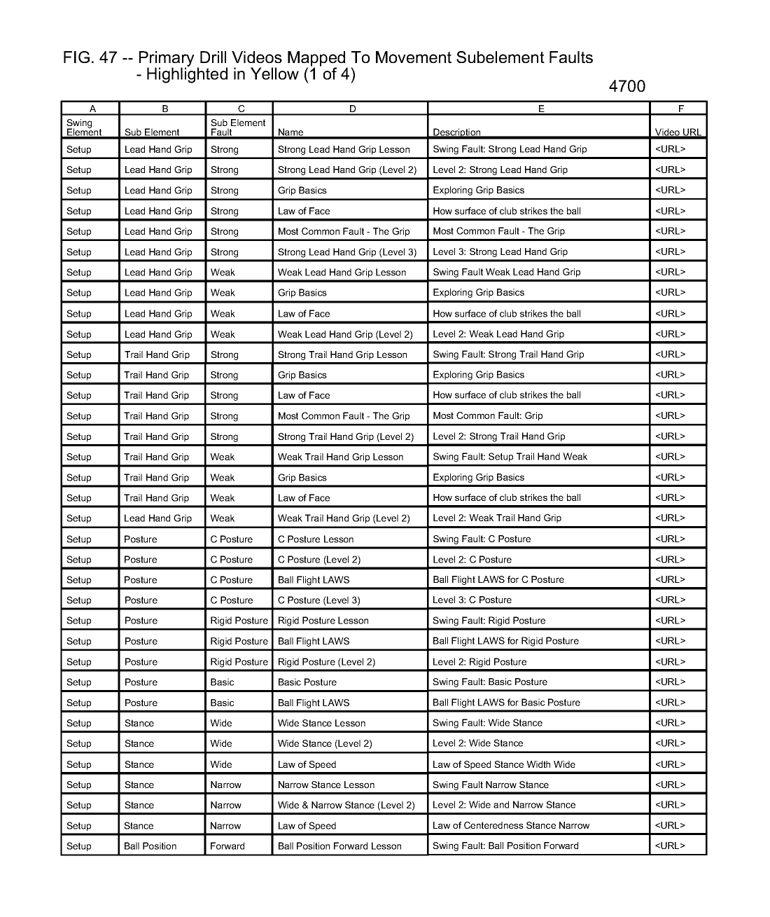

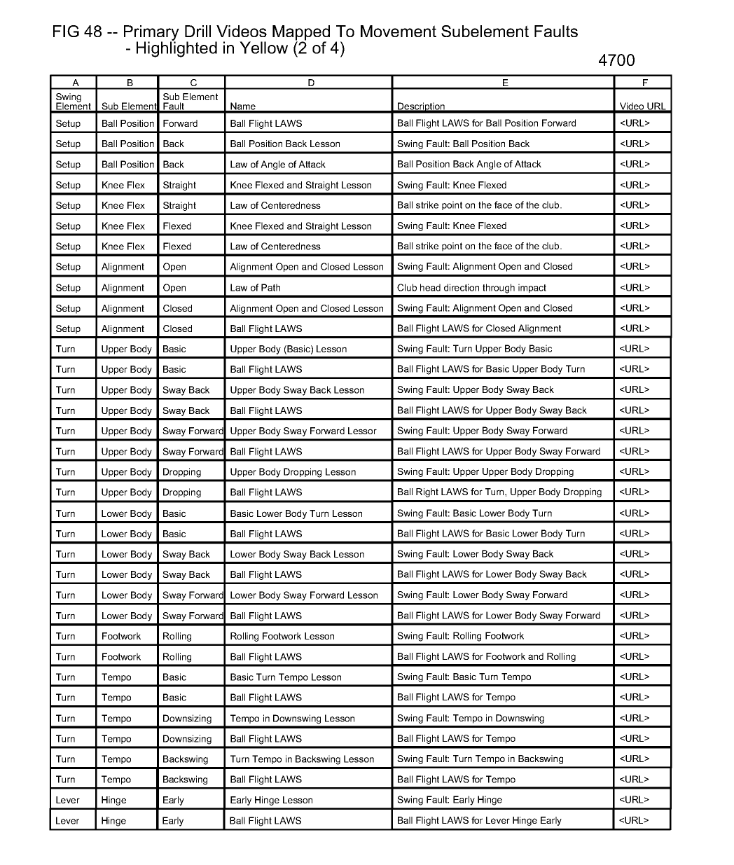

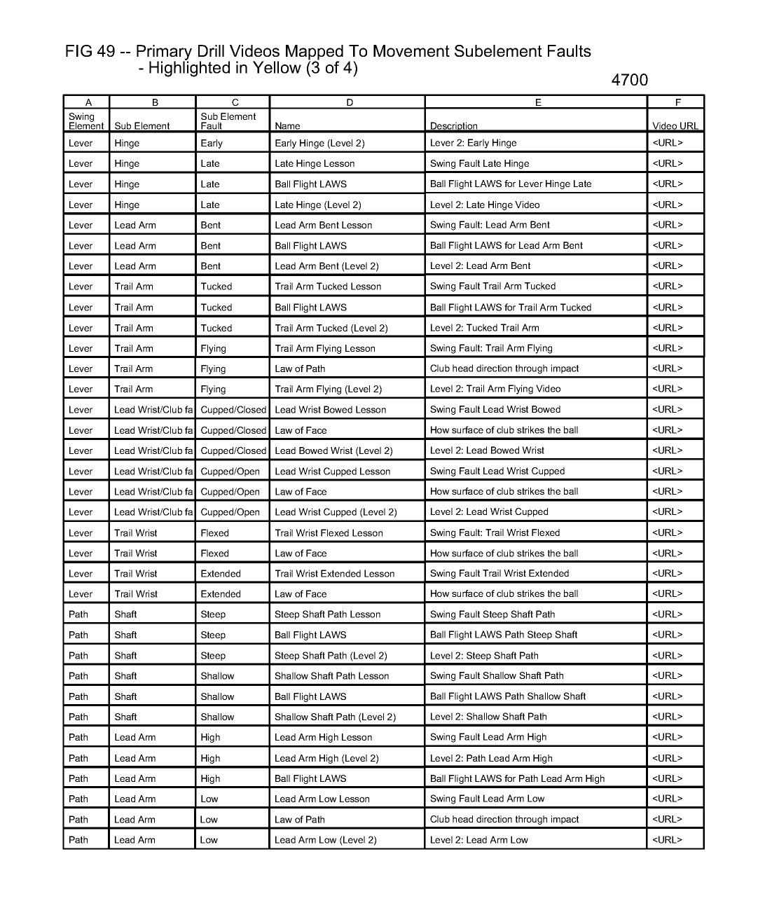

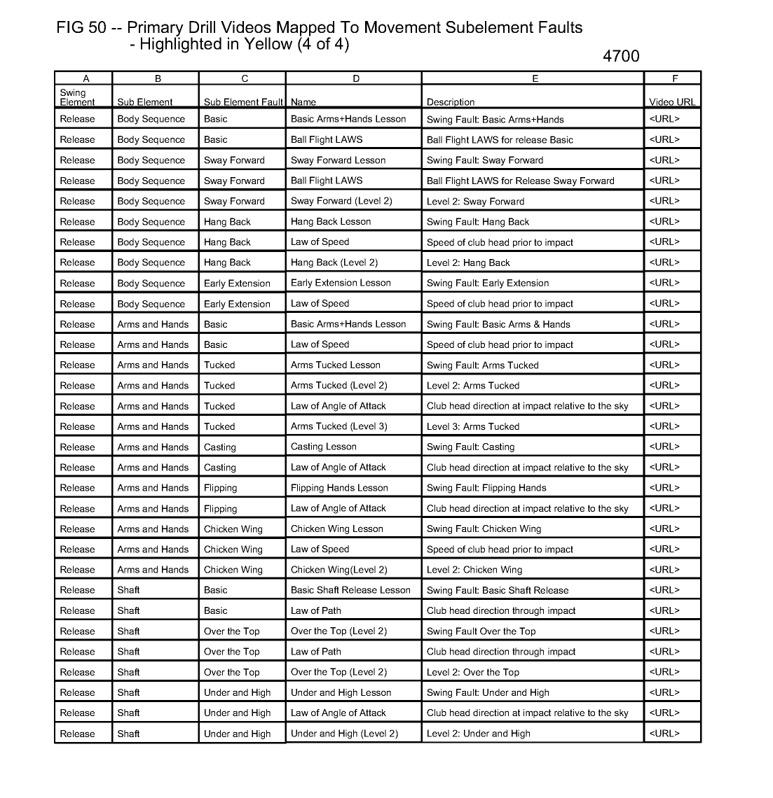

FIGS. 47-50 depict a mapping table with rows highlighted showing primary drill videos mapped to physical activity submovement faults 4700. The table may take unique subelement/fault combinations defined in Columns B and C and map each combination to a unique primary drill video whose name, description and video URL are given in Columns D, E and F respectively. This table may be used by the automated content aggregation engine in the generation of personalized lessons for the personalized multi-lesson roadmap of digital instruction of individual physical activity participants. FIG. 47 shows subelement/fault combinations through the subelement Setup>Ball Position and fault Forward. FIG. 48 shows subelement/fault combinations through the subelement Lever>Hinge and the fault Early. FIG. 49 shows subelement/fault combinations through the subelement Path>Lead Arm and the fault Low. FIG. 50 shows subelement/fault combinations through the subelement Release>Shaft and the fault Under and High.

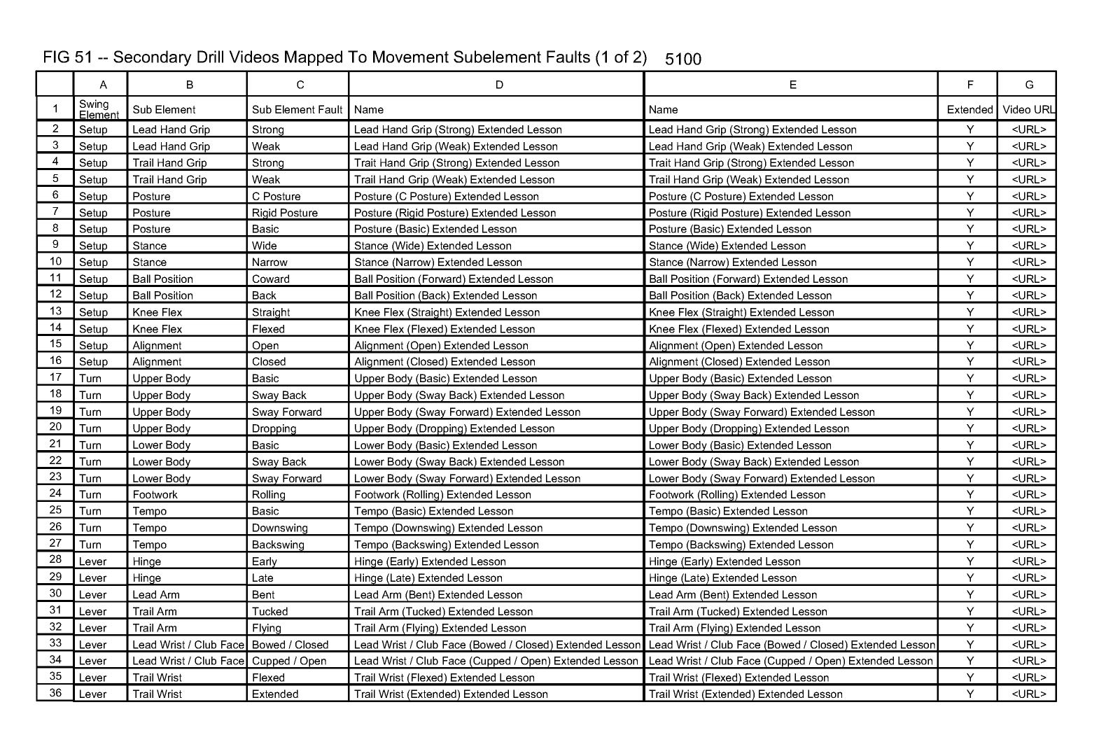

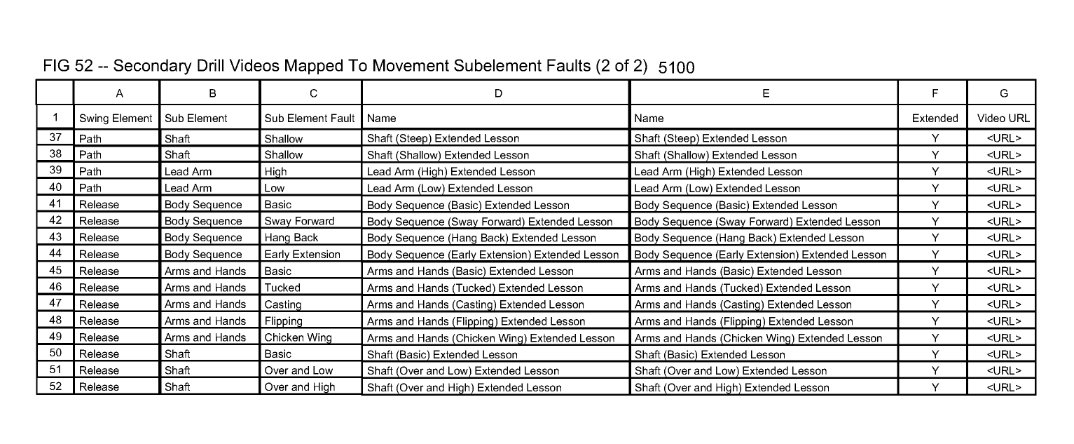

FIGS. 51-52 depict a mapping table showing secondary drill videos mapped to physical activity submovement faults 5100. The table may take unique subelement/fault combinations defined in Columns B and C and map each combination to a unique secondary drill video whose name, description, secondary (extended) designation, and video URL are given in Columns D, E, F and G respectively. This table may be used by the automated content aggregation engine in adding additional instructive content to a personalized lesson when a physical activity participant fails the first additional movement video that they transmit to their instructor for re-evaluation of a failed subelement associated with their lesson. FIG. 51 shows subelement/fault combinations through the subelement Lever>Trail Wrist and fault Extended. FIG. 52 shows subelement/fault combinations through the subelement Release>Shaft and the fault Over and High.

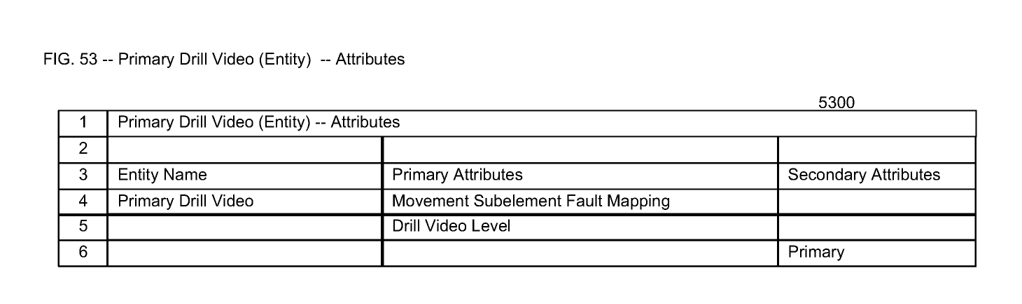

FIG. 53 depicts an example embodiment of a table defining the attributes of a primary drill video that may be required for the functioning of the method and system for providing physical activity instruction 5300. Attributes may include, for example, movement subelement fault mapping and drill video level. Possible secondary, tertiary and other attributes of these primary attributes are given in the table.

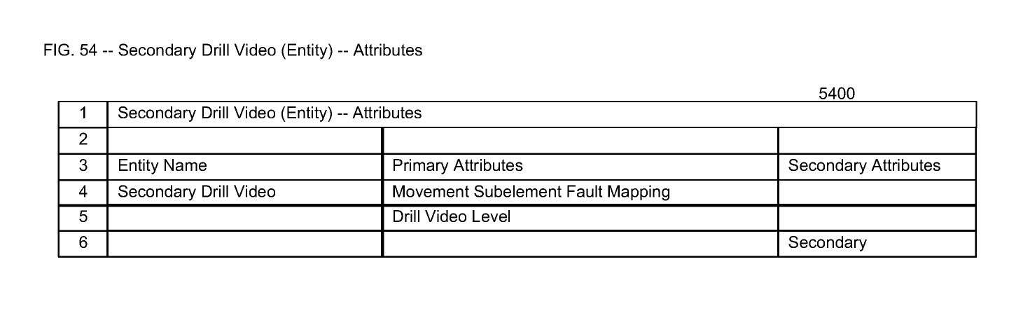

FIG. 54 depicts an example embodiment of a table defining the attributes of a secondary drill video that may be required for the functioning of the method and system for providing physical activity instruction 5400. Attributes may include, for example, movement subelement fault mapping and drill video level. Possible secondary, tertiary and other attributes of these primary attributes are given in the table.

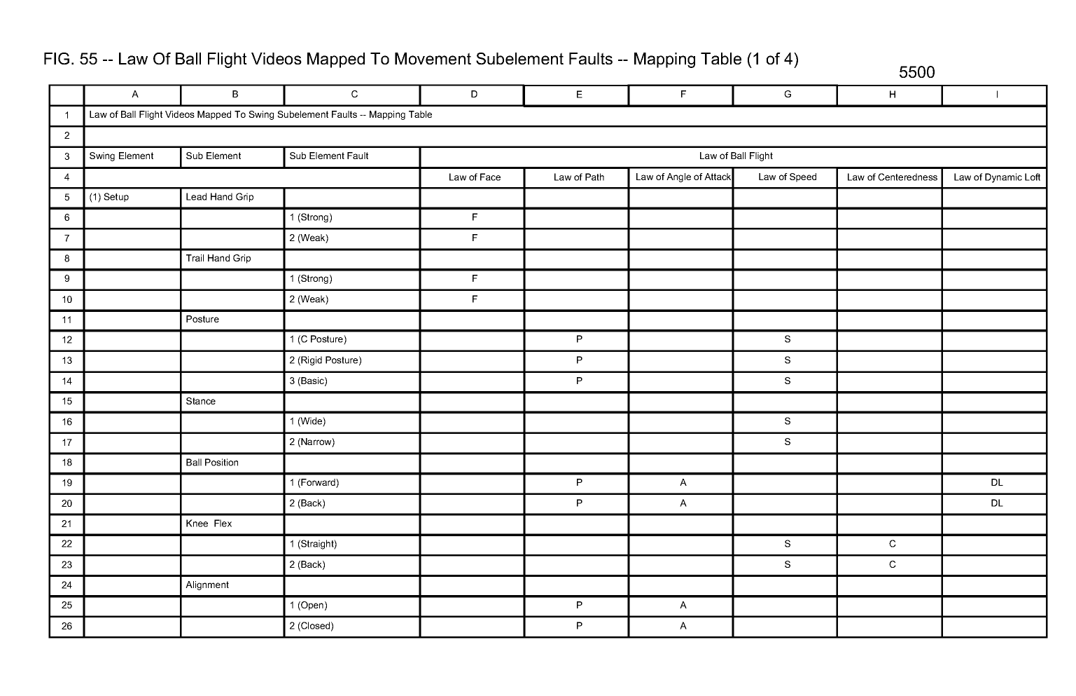

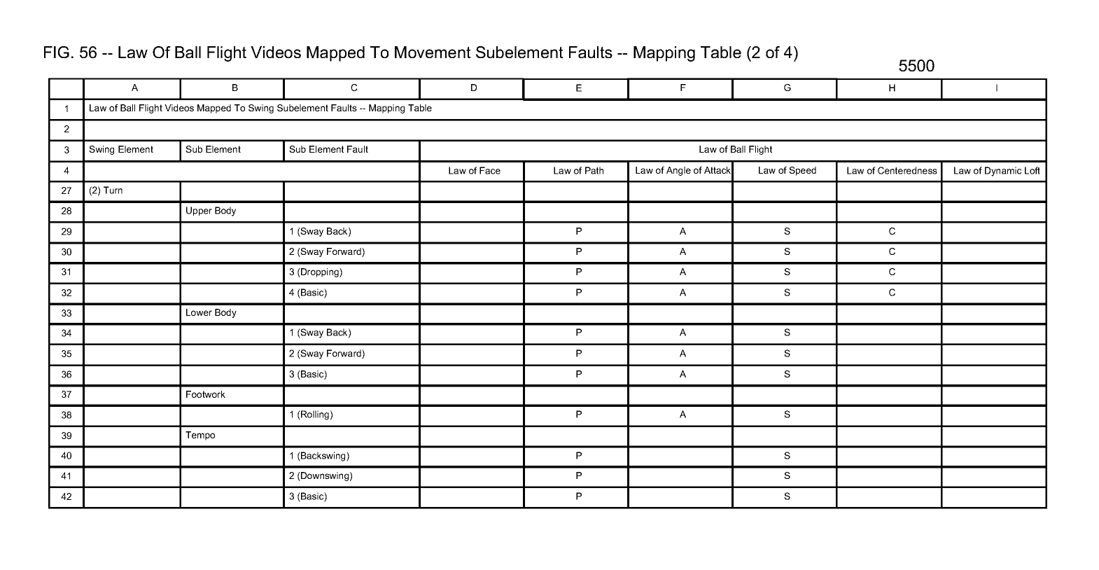

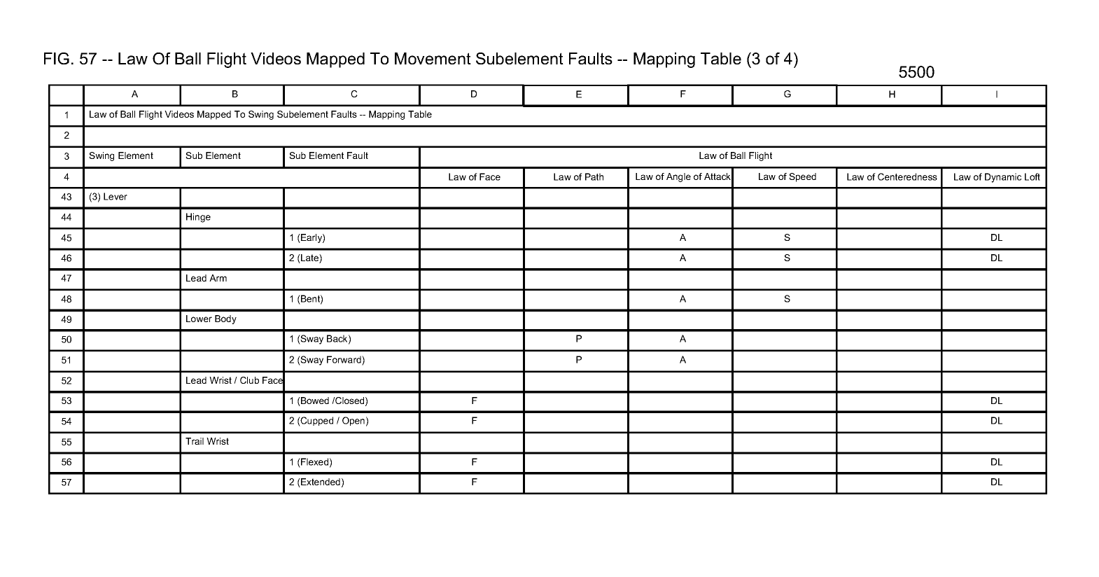

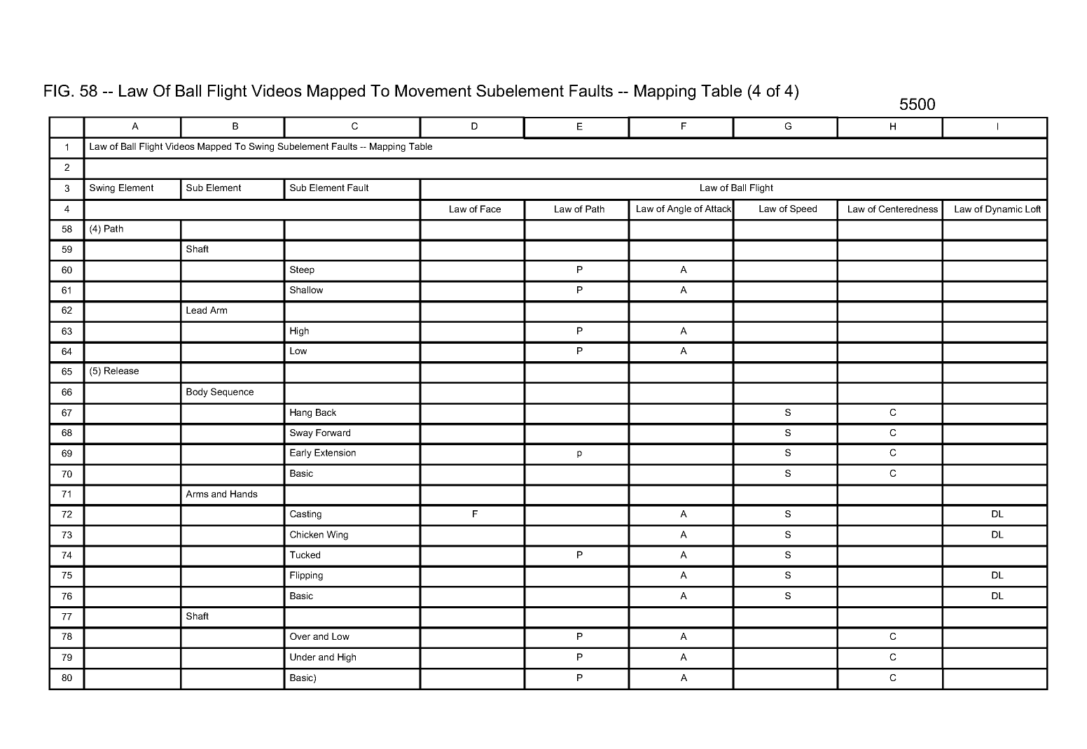

FIGS. 55-58 depict a mapping table of law of ball flight videos mapped to physical activity submovement faults 5500. The table may take unique subelement/fault combinations defined in Columns B and C and map each combination to a unique set of one or more laws of ball flight for which instructional videos have been produced. The laws of ball flight may include law of face, law of path, law of angle of attack, law of speed, law of centeredness, and law of dynamic loft shown in Columns D, E, F, G, H and I respectively. FIG. 55 shows subelement/fault combinations through the subelement Setup>Alignment and fault Closed. FIG. 56 shows subelement/fault combinations through the subelement Turn>Tempo and the fault Basic. FIG. 57 shows subelement/fault combinations through the subelement Lever>Trail Wrist and the fault Extended. FIG. 58 shows subelement/fault combinations through the subelement Release>Shaft and the fault Basic.

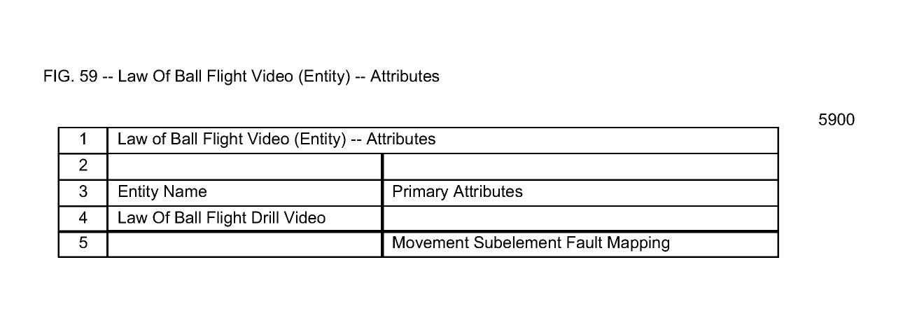

FIG. 59 depicts an example embodiment of a table defining the attributes of a law of ball flight video that may be required for the functioning of the method and system for providing physical activity instruction 5900. Attributes may include Movement Subelement Fault Mapping, for example.

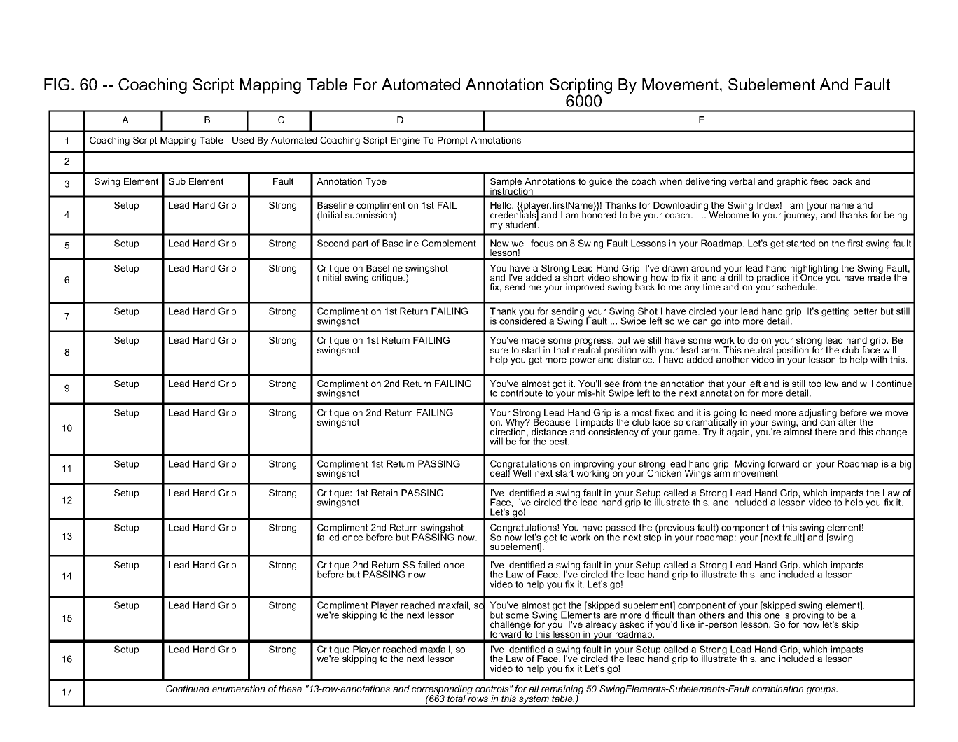

FIG. 60 depicts a mapping table of coaching scripts mapped to physical activity submovement faults and annotation types that may be used by the coaching script engine workflow (defined in FIG. 19 and its detailed description) to enable personalized coaching scripts that may be precisely matched to each participant's workflow state within a personalized lesson 6000. The coaching scripts mapping table and the coaching script engine workflow may function together to prompt instructors with coaching content within an individual participant's lesson that may be personalized for the participant's specific subelement fault, pass/fail status, numeric count of additional participant movement videos transmitted to the instructor within the lesson, and the maximum fail count status (a configurable rule, defined in FIG. 16 and its detailed description) that dictates that after being failed on a lesson by the instructor “N” number of times, a participant will be offered the chance to schedule a physical, in-person instruction session on the current failed movement subelement and skipped to the next digital lesson on the next failed movement subelement). The coaching script mapping table 6000 in the illustrated example may define 13 unique annotation types listed in Column D, rows 4-16 for a unique subelement/fault combination shown in Columns B and C. The 13 annotation types may be defined by the numeric count of additional movement videos transmitted from participant to instructor within a lesson, the pass/fail status of the lesson, whether the participant has reached the maximum fail count status, and whether the annotation is a compliment or a critique. Column E of the coaching script mapping table gives samples of coaching script annotation for each of these 13 annotation types text that may be presented to instructors to guide their personalized voice annotation recordings for participants. The same 13 annotation types may be repeated for each of the 51 subelement faults in the physical activity movement taxonomy with specialization for each. This generates 663 total rows in the full coaching script mapping table example. Only the primary 13 annotation types which repeat throughout are shown in FIG. 60.

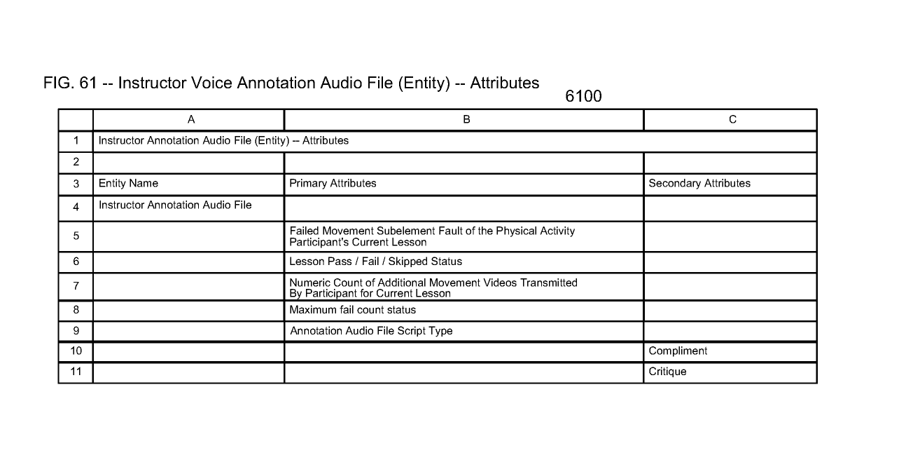

FIG. 61 depicts an example embodiment of a table defining the attributes of an instructor voice annotation audio file that may be required for the functioning of the method and system for providing physical activity instruction 6100. Attributes may include, for example, failed movement subelement fault of the physical activity participant's current lesson, lesson pass/fail/skipped status, numeric count of additional movement videos transmitted by participant for the current lesson, maximum fail count status, annotation audio file script type (compliment or critique).

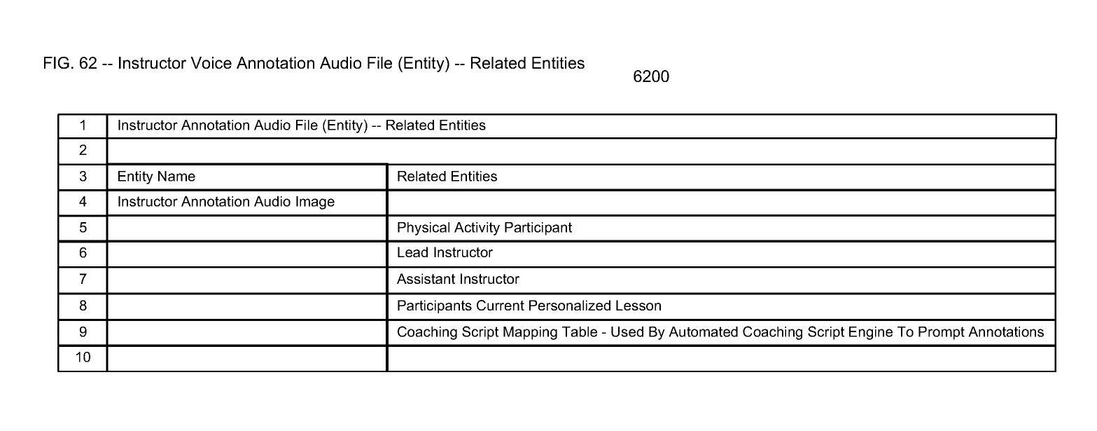

FIG. 62 depicts an example embodiment of a table defining other entities related to an instructor voice annotation audio file that may be required for the functioning of the method and system for providing physical activity instruction 6200. Related entities may include, for example, physical activity participant, lead instructor, assistant instructor, participant's current personalized lesson, coaching script mapping table (used by automated coaching script engine to prompt instructor with annotations).

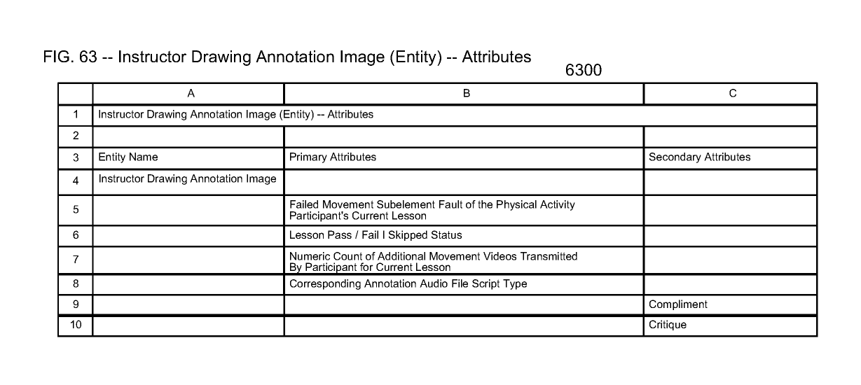

FIG. 63 depicts an example embodiment of a table defining the attributes of an instructor drawing annotation image file that may be required for the functioning of the method and system for providing physical activity instruction 6300. Attributes may include, for example, failed movement subelement fault of the physical activity participant's current lesson, lesson pass/fail/skipped status, numeric count of additional movement videos transmitted by participant for the current lesson, corresponding annotation script type (compliment or critique).

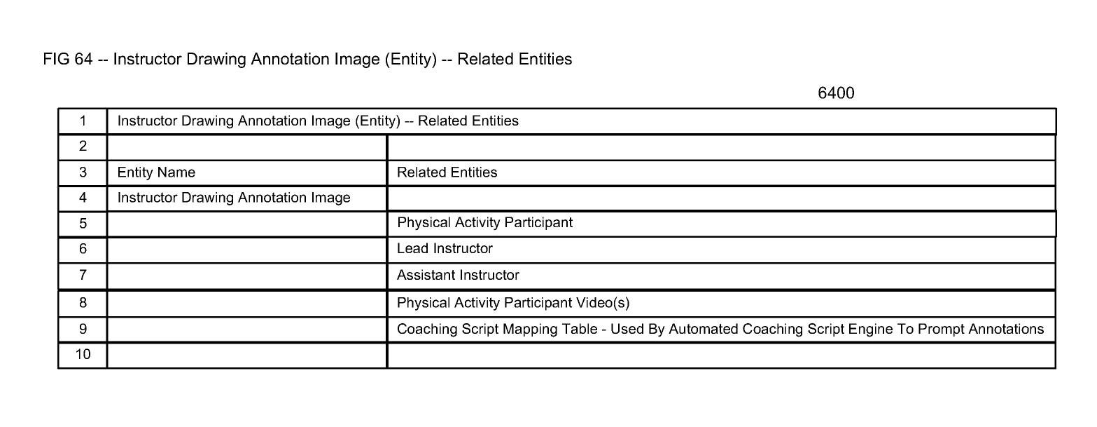

FIG. 64 depicts an example embodiment of a table defining other entities related to an instructor drawing annotation image file that may be required for the functioning of the method and system for providing physical activity instruction 6400. Related entities may include, for example, physical activity participant, lead instructor, assistant instructor, participant's current personalized lesson, coaching script mapping table (used by automated coaching script engine to prompt instructor with annotations).

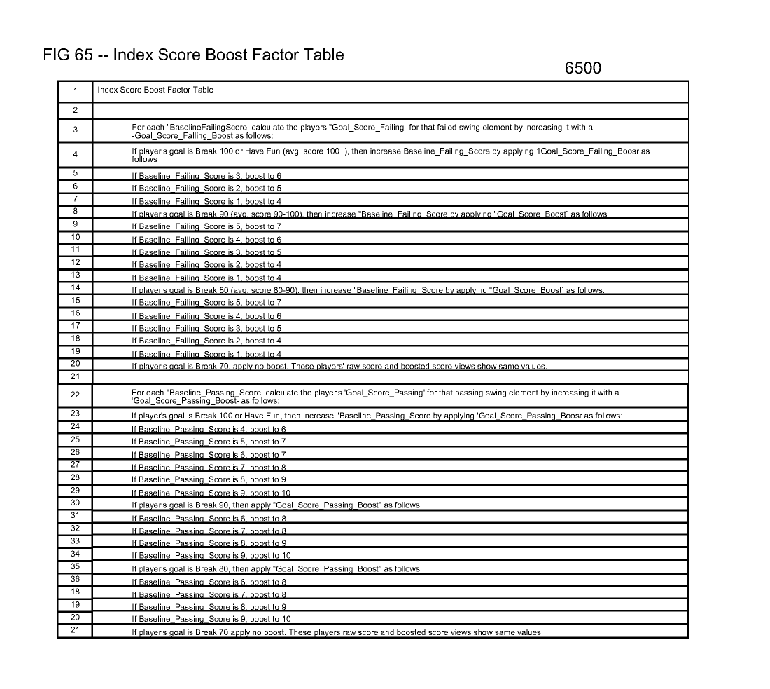

FIG. 65 depicts an index score boost factor table that may be utilized by the index score generation algorithm to calculate the goal-driven index score analytic for a physical activity participant 6500. The boost factors may be integers that the index score generation algorithm may add to a participant's raw numeric scores that are given to them by instructors on the subelements of their physical activity movement. Boost factors may be applied to subelement scores where a participant has been failed by an instructor according to the participant's goal. For example, for participants whose goal is “Break 100” or “Have Fun,” the boost factors for failing subelements are given in rows 5-7 of the table. For participants whose goal is “Break 90,” the boost factors for failing subelements are given in rows 9-13 of the table; for participants whose goal is “Break 80” the boost factors for failing subelements are given in rows 15-19 of the table. For participants whose goal is “Break 70,” no boost factor is applied to failing scores as noted on row 20 of the table. Boost factors may be applied to subelement scores where a participant has been passed by an instructor according to the participant's goal. For example, for participants whose goal is “Break 100” or “Have Fun,” the boost factors for passing subelements are given in rows 24-29 of the table. For participants whose goal is “Break 90,” the boost factors for passing subelements are given in rows 31-34 of the table. For participants whose goal is “Break 80,” the boost factors for failing subelements are given in rows 36-39 of the table. For participants whose goal is “Break 70,” no boost factor is applied to passing scores as noted on row 40 of the table.

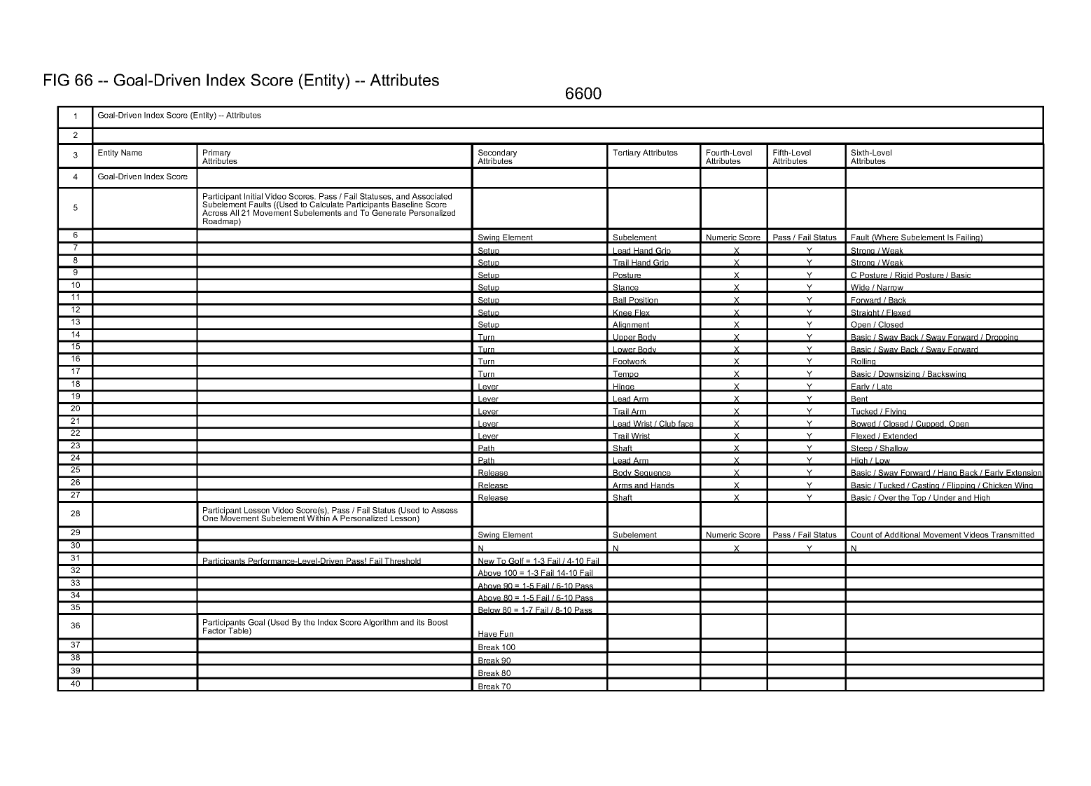

FIG. 66 depicts an example embodiment of a table defining the attributes of a goal-driven index score that may be required for the functioning of the method and system for providing physical activity instruction 6600. Attributes may include, for example, participant initial video scores; participant lesson video scores; participant's performance-level-driven pass/fail threshold; participant's goal; secondary, tertiary and other attributes of these primary attributes are given in the table.

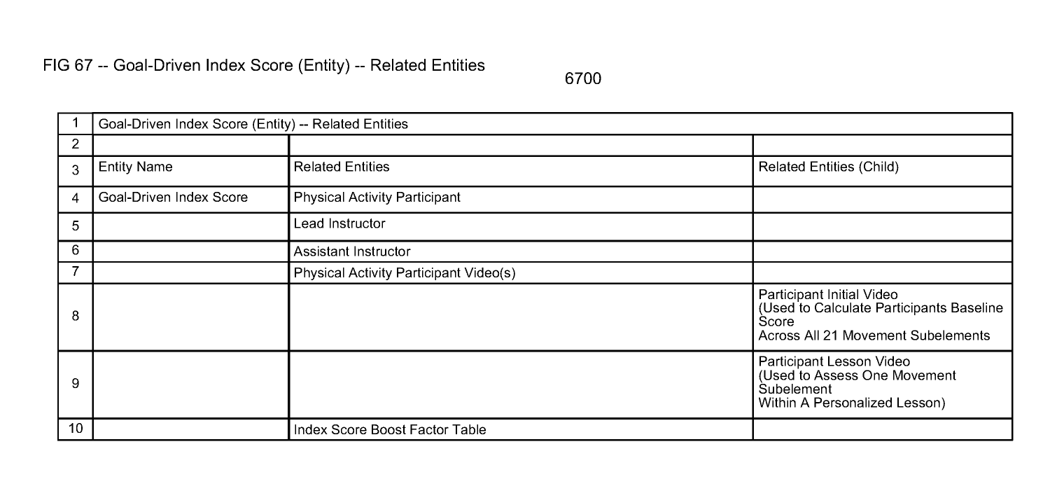

FIG. 67 depicts an example embodiment of a table defining the related entities of a goal-driven index score that may be required for the functioning of the method and system for providing physical activity instruction 6700. Related entities may include, for example, physical activity participant; lead instructor, assistant instructor; physical activity participant videos; index score boost factor table.

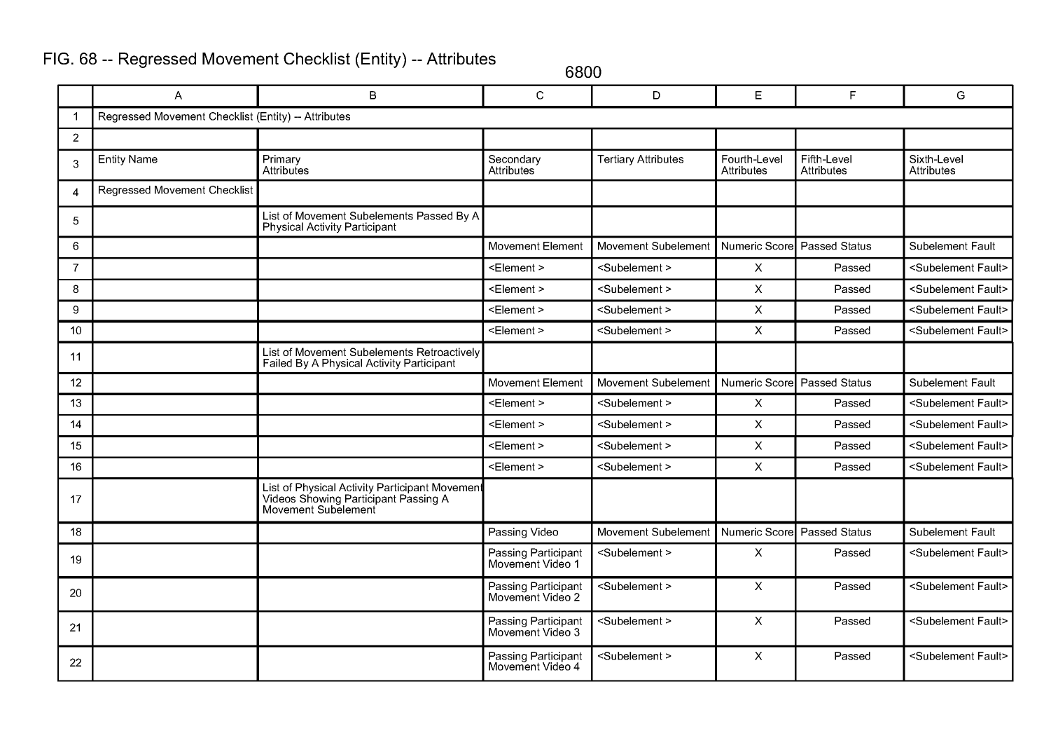

FIG. 68 depicts an example embodiment of a table defining the attributes of a regressed movement checklist that may be required for the functioning of the method and system for providing physical activity instruction 6800. Attributes may include, for example, list of movement subelements passed by a physical activity participant; list of movement subelements retroactively failed by a participant; list of participant movement videos showing participant passing a movement subelement.

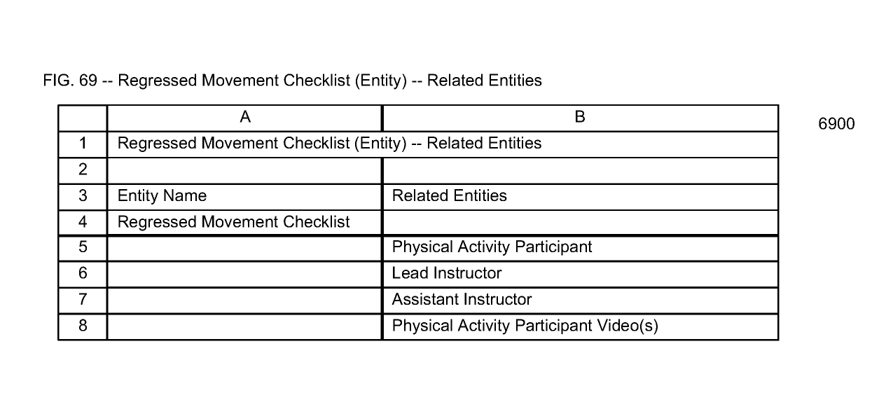

FIG. 69 depicts an example embodiment of a table defining other entities related to a regressed movement checklist that may be required for the functioning of the method and system for providing physical activity instruction 6900. Related entities may include, for example, physical activity participant, lead instructor, assistant instructor, physical activity participant videos;

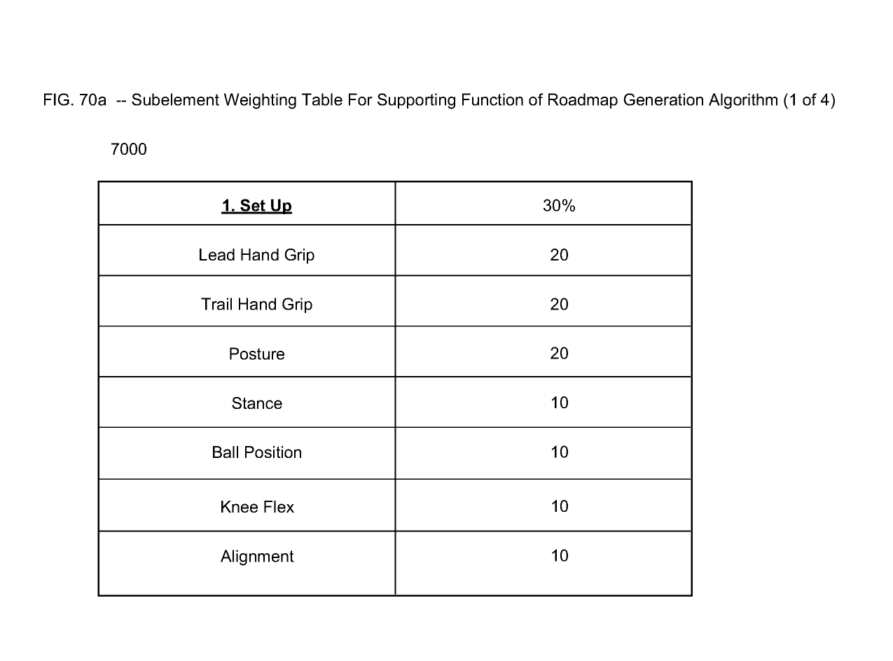

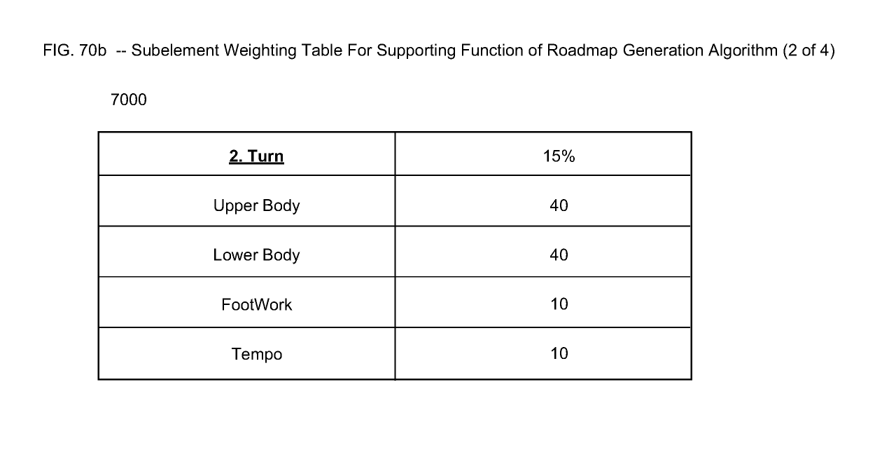

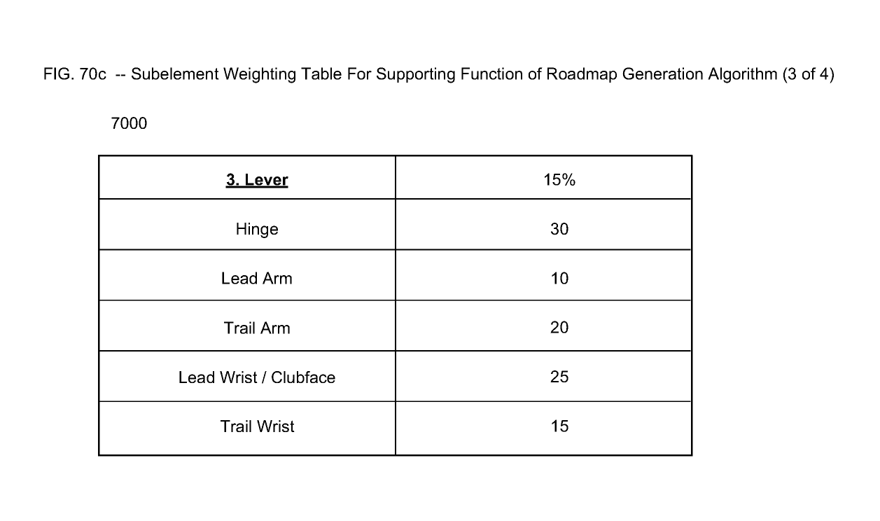

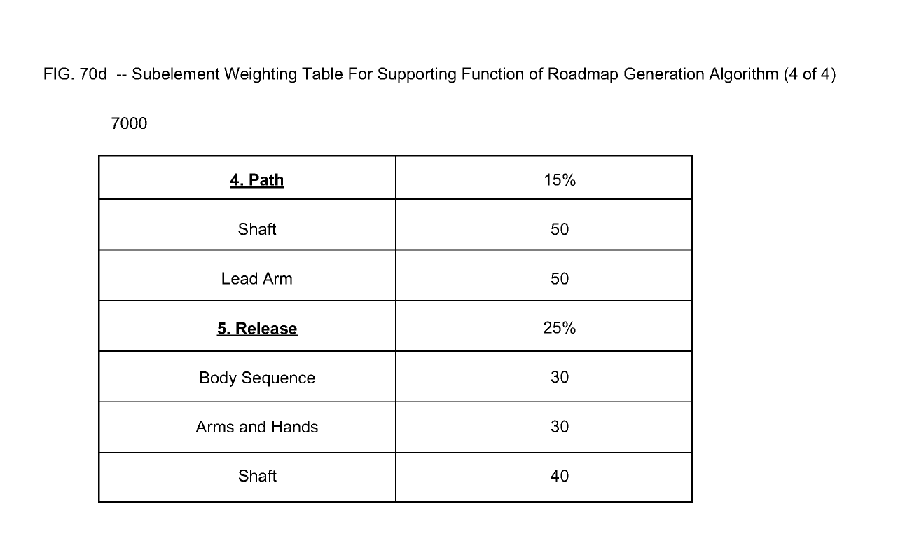

FIGS. 70A-70D depict an example embodiment of a movement subelement weighting table that may be utilized by a supporting function of the algorithm for generation of personalized roadmap of digital lessons called the swing improvement percentage pie chart (defined in FIGS. 15c and 15d and their detailed descriptions) 7000. FIG. 70A shows the swing improvement percentages for the subelements of the SetUp movement element. FIG. 70B shows the swing improvement percentages for the subelements of the Turn movement element. FIG. 70C shows the swing improvement percentages for the subelements of the Lever movement element. FIG. 70D shows the swing improvement percentages for the subelements of the Path and Release movement elements.

FIG. 71 depicts a computer system 7100 according to an embodiment of the disclosure. For example, computer system 7100 may function to provide the repository features described above, to provide interfaces to physical activity participants and/or instructors, and/or to communicate with other computer systems configured to provide interfaces to physical activity participants and/or instructors. The computer system 7100 may be implemented on any electronic device that runs software applications derived from compiled instructions, including without limitation personal computers, servers, smart phones, media players, electronic tablets, game consoles, email devices, etc. In some implementations, the computer system 7100 may include one or more processors 7102, one or more input devices 7104, one or more display devices 7106, one or more network interfaces 7108, and one or more computer-readable mediums 7110. Each of these components may be coupled by bus 7112, and in some embodiments, these components may be distributed among multiple physical locations and coupled by a network.

Display device 7106 may be any known display technology, including but not limited to display devices using Liquid Crystal Display (LCD) or Light Emitting Diode (LED) technology. Processor(s) 7102 may use any known processor technology, including but not limited to graphics processors and multi-core processors. Input device 7104 may be any known input device technology, including but not limited to a keyboard (including a virtual keyboard), mouse, track ball, and touch-sensitive pad or display. Bus 7112 may be any known internal or external bus technology, including but not limited to ISA, EISA, PCI, PCI Express, NuBus, USB, Serial ATA or FireWire. Computer-readable medium 7110 may be any medium that participates in providing instructions to processor(s) 7102 for execution, including without limitation, non-volatile storage media (e.g., optical disks, magnetic disks, flash drives, etc.), or volatile media (e.g., SDRAM, ROM, etc.).

Computer-readable medium 7110 may include various instructions 7114 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 7104; sending output to display device 7106; keeping track of files and directories on computer-readable medium 7110; controlling peripheral devices (e.g., disk drives, printers, etc.) which can be controlled directly or through an I/O controller; and managing traffic on bus 7112. Network communications instructions 7116 may establish and maintain network connections (e.g., software for implementing communication protocols, such as TCP/IP, HTTP, Ethernet, telephony, etc.).

Repository 7118 may include instructions for storing data as described above and/or may provide the data storage medium for the storage of the data. Application(s) 7120 may be an application that uses or implements the processes described herein and/or other processes. The processes may also be implemented in operating system 7114.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

FIG. 72 depicts a computer system 7200 according to an embodiment of the disclosure. For example, the computer system 7200 may function to provide the interfaces to physical activity participants and/or instructors as described above. The computer system 7200 may include a memory interface 7202, one or more data processors, image processors, and/or central processing units 7204, and a peripherals interface 7206. The memory interface 7202, the one or more processors 7204, and/or the peripherals interface 7206 may be separate components or may be integrated in one or more integrated circuits. The various components in computer system 7200 may be coupled by one or more communication buses or signal lines.

Sensors, devices, and subsystems may be coupled to the peripherals interface 7206 to facilitate multiple functionalities. For example, a motion sensor 7210, a light sensor 7212, and a proximity sensor 7214 may be coupled to the peripherals interface 7206 to facilitate orientation, lighting, and proximity functions. Other sensors 7216 may also be connected to the peripherals interface 7206, such as a global navigation satellite system (GNSS) (e.g., GPS receiver), a temperature sensor, a biometric sensor, magnetometer, or other sensing device, to facilitate related functionalities.

A camera subsystem 7220 and an optical sensor 7222, e.g., a charged coupled device (CCD) or a complementary metal-oxide semiconductor (CMOS) optical sensor, may be utilized to facilitate camera functions, such as recording photographs and video clips. The camera subsystem 7220 and the optical sensor 7222 may be used to collect images of a user to be used during authentication of a user, e.g., by performing facial recognition analysis.

Communication functions may be facilitated through one or more wireless communication subsystems 7224, which can include radio frequency receivers and transmitters and/or optical (e.g., infrared) receivers and transmitters. For example, the BTLE and/or WiFi communications described above may be handled by wireless communication subsystems 7224. The specific design and implementation of the communication subsystems 7224 may depend on the communication network(s) over which computer system 7200 may be intended to operate. For example, computer system 7200 may include communication subsystems 7224 designed to operate over a GSM network, a GPRS network, an EDGE network, a WiFi or WiMax network, and a Bluetooth™ network. For example, the wireless communication subsystems 7224 may include hosting protocols such that computer system 7200 can be configured as a base station for other wireless devices and/or to provide a WiFi service.

An audio subsystem 7226 may be coupled to a speaker 7228 and a microphone 7230 to facilitate voice-enabled functions, such as speaker recognition, voice replication, digital recording, and telephony functions. The audio subsystem 7226 may be configured to facilitate processing voice commands, voiceprinting, and voice authentication, for example.

The I/O subsystem 7240 may include a touch-surface controller 7242 and/or other I/O controller(s) 7244. The touch-surface controller 7242 may be coupled to a touch surface 7246. The touch surface 7246 and touch-surface controller 7242 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 7246.

The other I/O controller(s) 7244 may be coupled to other I/O/control devices 7248, such as one or more buttons, rocker switches, thumb-wheel, infrared port, USB port, and/or a pointer device such as a stylus. The one or more buttons (not shown) may include an up/down button for volume control of the speaker 7228 and/or the microphone 7230.

In some implementations, a pressing of the button for a first duration may disengage a lock of the touch surface 7246; and a pressing of the button for a second duration that is longer than the first duration may turn power to computer system 7200 on or off. Pressing the button for a third duration may activate a voice control, or voice command, module that enables the user to speak commands into the microphone 7230 to cause the device to execute the spoken command. The user may customize a functionality of one or more of the buttons. The touch surface 7246 can, for example, also be used to implement virtual or soft buttons and/or a keyboard.

In some implementations, computer system 7200 may present recorded audio and/or video files, such as MP3, AAC, and MPEG files. In some implementations, computer system 7200 may include the functionality of an MP3 player, such as an iPod™. Computer system 7200 may, therefore, include a 36-pin connector and/or 8-pin connector that is compatible with the iPod. Other input/output and control devices may also be used.

The memory interface 7202 may be coupled to memory 7250. The memory 7250 may include high-speed random access memory and/or non-volatile memory, such as one or more magnetic disk storage devices, one or more optical storage devices, and/or flash memory (e.g., NAND, NOR). The memory 7250 may store an operating system 7252, such as Darwin, RTXC, LINUX, UNIX, OS X, WINDOWS, or an embedded operating system such as VxWorks.

The operating system 7252 may include instructions for handling basic system services and for performing hardware dependent tasks. In some implementations, the operating system 7252 may be a kernel (e.g., UNIX kernel). In some implementations, the operating system 7252 may include instructions for performing voice authentication.

The memory 7250 may store communication instructions 7254 to facilitate communicating with one or more additional devices, one or more computers and/or one or more servers. The memory 7250 may include graphical user interface instructions 7256 to facilitate graphic user interface processing; sensor processing instructions 7258 to facilitate sensor-related processing and functions; phone instructions 7260 to facilitate phone-related processes and functions; electronic messaging instructions 7262 to facilitate electronic-messaging related processes and functions; web browsing instructions 7264 to facilitate web browsing-related processes and functions; media processing instructions 7266 to facilitate media processing-related processes and functions; GNSS/Navigation instructions 7268 to facilitate GNSS and navigation-related processes and instructions; and/or camera instructions 7270 to facilitate camera-related processes and functions.

The memory 7250 may store participant and/or instructor UI instructions 7272 to facilitate other processes and functions described herein. For example, participant and/or instructor UI instructions 7272 may include instructions for performing the interface-based processing and/or other processing as described above for one or more embodiments disclosed herein.

The memory 7250 may also store other software instructions 7274, such as web video instructions to facilitate web video-related processes and functions; and/or web shopping instructions to facilitate web shopping-related processes and functions. In some implementations, the media processing instructions 7266 may be divided into audio processing instructions and video processing instructions to facilitate audio processing-related processes and functions and video processing-related processes and functions, respectively.

Each of the above identified instructions and applications may correspond to a set of instructions for performing one or more functions described herein. These instructions need not be implemented as separate software programs, procedures, or modules. The memory 7250 may include additional instructions or fewer instructions. Furthermore, various functions of computer system 7200 may be implemented in hardware and/or in software, including in one or more signal processing and/or application specific integrated circuits.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method for providing a scalable capability for generating personalized analytics and a personalized multi-lesson roadmap of two-way interactive digital instruction for a physical activity for a multiplicity of physical activity participants by a multiplicity of physical activity instructors, the method comprising:
recording, by at least one processor, profile information for a plurality of physical activity participants in separate physical activity participant records for each of the plurality of physical activity participants, the profile information including a goal;
recording, by the at least one processor, participant movement videos generated by computing devices associated with each of the plurality of physical activity participants, the participant movement videos depicting attributes about the participant's movement, including a plurality of movement subelements;
for each physical activity participant, recording, by the at least one processor in a physical activity participant's record, inputs by a trained instructor about the participant's movements generated by a computing device associated with the trained instructor, the inputs including the instructor's scoring of all of the participant's movement subelements;
for each physical activity participant, performing, by the at least one processor, an algorithm and automated process to generate a goal-driven index score metric, wherein the index score is calculated based upon the instructor's scoring of all of the participant's movement subelements and is also based upon the participant's goal;
for each physical activity participant, performing, by the at least one processor, an algorithm and automated process to generate a personalized multi-lesson roadmap of two-way, interactive lessons, wherein each personalized lesson is automatically generated by the algorithm to address a unique failed movement subelement fault as evaluated by the instructor in scoring the participant's movements;
for each multi-lesson roadmap of two-way interactive lessons, performing, by the at least one processor, an automated content aggregation process that automatically compiles content components of each personalized digital lesson, including drill videos from a database of drill videos categorized by movement subelement fault that are matched to the subelement fault associated with the personalized lesson of each individual participant, law of ball flight videos from a database of law of ball flight videos categorized by movement subelement fault matched to the subelement fault associated with the personalized lesson, instructor voice annotations from a coaching script engine and its associated coaching script table with scripts categorized by movement subelement fault and by participant lesson pass/fail status and by the numeric count of additional movement videos transmitted from participant to instructor for the lesson with these scripts matched to the subelement fault associated with the personalized lesson of each individual participant; and instructor drawing (markup) annotations matched to the subelement fault associated with the personalized lesson of each individual participant;
for each multi-lesson roadmap of two-way interactive lessons, performing, by the at least one processor, an automated process for lesson distribution utilizing a workflow that controls sequential locking and unlocking of lessons according to specified rules, tracks lesson pass/fail/skip statuses, and tracks and enforces a number of additional participant movement videos that a participant can transmit to the instructor during a lesson; and
for each multi-lesson roadmap of two-way interactive lessons, performing, by the at least one processor, a rule-driven workflow governing the number of additional participant movement videos that that the participant can transmit to the instructor during the lesson, wherein the rules:
determine a configurable maximum number of additional participant motion videos that can be transmitted after an instructor scores the previous participant video as a fail, and
assign a skipped status to the participant, automatically offer a physical in-person lesson to the participant, and unlock the next digital lesson on the participant's personalized multi-lesson roadmap of digital instruction when the participant reaches a configurable maximum number of failed instructor evaluations on the movement videos transmitted from participant to instructor within a lesson.

2. The method of claim 1, wherein the record profile information includes information about each participant's goal, average performance score, most common mis-hit, or a combination thereof.

3. The method of claim 1, wherein the attributes about the participant's movement include club used as selected from a normalized taxonomy of clubs, what happened to the ball as selected from a normalized list of attributes including shot shape (left, straight, right), trajectory (high, medium, low) and contact (solid, poor), where the physical activity took place based on normalized data selection including golf course or practice range, geolocation where the swing took place, local weather conditions where the swing took place, or a combination thereof.

4. The method of claim 1, wherein the inputs by the trained instructor include numeric scores, pass/fail statuses and associated movement subelement faults for each of the movement elements and subelements in a hierarchical taxonomy of movements, movement subelements and subelement faults, or a combination thereof.

5. The method of claim 1, wherein the algorithm and automated process to generate the personalized multi-lesson roadmap includes an automated video instructional content aggregation function, a personalized instructor annotation function, a score and pass/fail status display function, a rules engine function to govern and track the number of additional participant movement videos a participant is permitted to upload to their instructor, and a workflow status function tracking and displaying the participant's interaction with the lesson, including statuses of locked, unlocked, current, passed, failed, skipped, or a combination thereof.

6. The method of claim 1, wherein the automatically compiled content includes drill videos from a database of drill videos categorized by movement subelement fault that are matched to the subelement fault associated with the personalized lesson of each individual participant, law of ball flight videos from a database of law of ball flight videos categorized by movement subelement fault matched to the subelement fault associated with the personalized lesson, instructor voice annotations from a coaching script engine and an associated coaching script table with scripts categorized by movement subelement fault and by participant lesson pass/fail status and by the numeric count of additional movement videos transmitted from participant to instructor for the lesson with these scripts matched to the subelement fault associated with the personalized lesson; and instructor drawing markup annotations matched to the subelement fault associated with the personalized lesson, or a combination thereof.

7. The method of claim 1, further comprising providing, by the at least one processor, a scalable, hierarchical resourcing capability configured to accept additional trained instructors recruited by the trained instructor, wherein input from the additional trained instructors is used to generate at least one of the goal-driven index score metrics.

8. The method of claim 1, further comprising performing, by the at least one processor, queueing of the participant movement videos and assigning them from the queue to separate ones of a plurality of trained instructors for providing the goal-driven index score metric.

9. The method of claim 8, wherein the participants and the instructors are each associated with regions, and wherein the queueing is performed by region.

10. The method of claim 1, wherein the taxonomy of physical activity movements includes the following within the sport of golf:
five swing elements: Setup, Turn, Lever, Path and Release;
21 swing subelements hierarchically nested within the five swing elements as follows:
for Setup: Lead Hand Grip, Trail Hand Grip, Posture, Stance, Ball Position, Knee Flex and Alignment,
for Turn: Upper Body, Lower Body, Footwork and Tempo,
for Lever: Hinge, Lead Arm, Trail Arm, Lead Wrist/Club Face and Trail Wrist,
for Path: Shaft and Lead Arm,
for Release: Body Sequence, Arms and Hands, Shaft; and
51 swing faults hierarchically nested within the 21 swing elements as follows:
Setup>Lead Hand Grip (Strong, Weak),
Setup>Trail Hand Grip (Strong, Weak),
Setup>Posture (C Posture, Rigid Posture, Basic),
Setup>Stance (Wide, Narrow),
Setup>Ball Position (Forward, Back),
Setup>Knee Flex (Straight, Flexed),
Setup>Alignment (Open, Closed),
Turn>Upper Body (Sway Back, Sway Forward, Dropping, Basic),
Turn>Lower Body (Sway Back, Sway Forward, Basic),
Turn>Footwork (Rolling),
Turn>Tempo (Backswing, Downswing, Basic),
Lever>Hinge (Early, Late),
Lever>Lead Arm (Bent),
Lever>Trail Arm (Tucked, Flying),
Lever>Lead Wrist/Club Face (Bowed/Closed, Cupped/Open),
Lever>Trail Wrist (Flexed, Extended),
Path>Shaft (Steep, Shallow),
Path>Lead Arm (High, Low),
Release>Body Sequence (Hang Back, Sway Forward, Early Extension, Basic),
Release>Arms and Hands (Casting, Chicken Wing, Tucked, Flipping, Basic),
Release>Shaft (Over and Low, Over and High, Basic).

11. The method of claim 1, wherein a numeric scoring scale for instructors to use in scoring the aptitude of participants on individual movement subelements is a scale from 1 to 10 where 10 represents the greatest aptitude and 1 represents the least aptitude;

12. The method of claim 1, wherein numeric scores assigned by an instructor to participant movement subelements are associated with a pass or fail status obtained from a mapping table mapping participants' normalized average performance score selection to a set of numeric scores associated with passing and a set of numeric score associated with failing; wherein a numeric threshold to pass is lower for players with poorer average performance scores than other players for whom numeric threshold to pass is higher.

13. The method of claim 1, wherein the index score improves each time the participant passes a personalized lesson on their multi-lesson roadmap of instruction.

14. The method of claim 1, further comprising retroactively failing, by the at least one processor, a lesson based on additional feedback from the trained instructor, wherein the retroactive failing locks previously unlocked lessons.

15. A system for providing a scalable capability for generating personalized analytics and a personalized multi-lesson roadmap of two-way interactive digital instruction for a physical activity for a multiplicity of physical activity participants by a multiplicity of physical activity instructors, the system comprising:
at least one memory; and
at least one processor in communication with the memory, with a plurality of computing devices associated with each of a plurality of physical activity participants, and with a computing device associated with a trained instructor, the at least one processor being configured to:
recording profile information for the plurality of physical activity participants in separate physical activity participant records in the at least one memory for each of the plurality of physical activity participants, the profile information including a goal;
record participant movement videos generated by the computing devices associated with each of the plurality of physical activity participants, the participant movement videos depicting attributes about the participant's movement, including a plurality of movement subelements;
for each physical activity participant, record, in a physical activity participant's record, inputs by the trained instructor about the participant's movements generated by the computing device associated with the trained instructor, the inputs including the instructor's scoring of all of the participant's movement subelements;
for each physical activity participant, perform an algorithm and automated process to generate a goal-driven index score metric, wherein the index score is calculated based upon the instructor's scoring of all of the participant's movement subelements and is also based upon the participant's goal;
for each physical activity participant, perform an algorithm and automated process to generate a personalized multi-lesson roadmap of two-way, interactive lessons, wherein each personalized lesson is automatically generated by the algorithm to address a unique failed movement subelement fault as evaluated by the instructor in scoring the participant's movements;
for each multi-lesson roadmap of two-way interactive lessons, perform an automated content aggregation process that automatically compiles content components of each personalized digital lesson, including drill videos from a database of drill videos categorized by movement subelement fault that are matched to the subelement fault associated with the personalized lesson of each individual participant, law of ball flight videos from a database of law of ball flight videos categorized by movement subelement fault matched to the subelement fault associated with the personalized lesson, instructor voice annotations from a coaching script engine and its associated coaching script table with scripts categorized by movement subelement fault and by participant lesson pass/fail status and by the numeric count of additional movement videos transmitted from participant to instructor for the lesson with these scripts matched to the subelement fault associated with the personalized lesson of each individual participant; and instructor drawing (markup) annotations matched to the subelement fault associated with the personalized lesson of each individual participant;
for each multi-lesson roadmap of two-way interactive lessons, perform an automated process for lesson distribution utilizing a workflow that controls sequential locking and unlocking of lessons according to specified rules, tracks lesson pass/fail/skip statuses, and tracks and enforces a number of additional participant movement videos that a participant can transmit to the instructor during a lesson; and
for each multi-lesson roadmap of two-way interactive lessons, perform a rule-driven workflow governing the number of additional participant movement videos that that the participant can transmit to the instructor during the lesson, wherein the rules:
determine a configurable maximum number of additional participant motion videos that can be transmitted after an instructor scores the previous participant video as a fail, and
assign a skipped status to the participant, automatically offer a physical in-person lesson to the participant, and unlock the next digital lesson on the participant's personalized multi-lesson roadmap of digital instruction when the participant reaches a configurable maximum number of failed instructor evaluations on the movement videos transmitted from participant to instructor within a lesson.

16. The system of claim 15, wherein the record profile information includes information about each participant's goal, average performance score, most common mis-hit, or a combination thereof.

17. The system of claim 15, wherein the attributes about the participant's movement include club used as selected from a normalized taxonomy of clubs, what happened to the ball as selected from a normalized list of attributes including shot shape (left, straight, right), trajectory (high, medium, low) and contact (solid, poor), where the physical activity took place based on normalized data selection including golf course or practice range, geolocation where the swing took place, local weather conditions where the swing took place, or a combination thereof.

18. The system of claim 15, wherein the inputs by the trained instructor include numeric scores, pass/fail statuses and associated movement subelement faults for each of the movement elements and subelements in a hierarchical taxonomy of movements, movement subelements and subelement faults, or a combination thereof.

19. The system of claim 15, wherein the algorithm and automated process to generate the personalized multi-lesson roadmap includes an automated video instructional content aggregation function, a personalized instructor annotation function, a score and pass/fail status display function, a rules engine function to govern and track the number of additional participant movement videos a participant is permitted to upload to their instructor, and a workflow status function tracking and displaying the participant's interaction with the lesson, including statuses of locked, unlocked, current, passed, failed, skipped, or a combination thereof.

20. The system of claim 15, wherein the automatically compiled content includes drill videos from a database of drill videos categorized by movement subelement fault that are matched to the subelement fault associated with the personalized lesson of each individual participant, law of ball flight videos from a database of law of ball flight videos categorized by movement subelement fault matched to the subelement fault associated with the personalized lesson, instructor voice annotations from a coaching script engine and an associated coaching script table with scripts categorized by movement subelement fault and by participant lesson pass/fail status and by the numeric count of additional movement videos transmitted from participant to instructor for the lesson with these scripts matched to the subelement fault associated with the personalized lesson; and instructor drawing markup annotations matched to the subelement fault associated with the personalized lesson, or a combination thereof.

21. The system of claim 15, wherein the at least one processor is further configured to provide a scalable, hierarchical resourcing capability configured to accept additional trained instructors recruited by the trained instructor, wherein input from the additional trained instructors is used to generate at least one of the goal-driven index score metrics.

22. The system of claim 15, wherein the at least one processor is further configured to perform queueing of the participant movement videos and assigning them from the queue to separate ones of a plurality of trained instructors for providing the goal-driven index score metric.

23. The system of claim 22, wherein the participants and the instructors are each associated with regions, and wherein the queueing is performed by region.

24. The system of claim 15, wherein the taxonomy of physical activity movements includes the following within the sport of golf:
five swing elements: Setup, Turn, Lever, Path and Release;
21 swing subelements hierarchically nested within the five swing elements as follows:
for Setup: Lead Hand Grip, Trail Hand Grip, Posture, Stance, Ball Position, Knee Flex and Alignment,
for Turn: Upper Body, Lower Body, Footwork and Tempo,
for Lever: Hinge, Lead Arm, Trail Arm, Lead Wrist/Club Face and Trail Wrist,
for Path: Shaft and Lead Arm,
for Release: Body Sequence, Arms and Hands, Shaft; and
51 swing faults hierarchically nested within the 21 swing elements as follows:
Setup>Lead Hand Grip (Strong, Weak),
Setup>Trail Hand Grip (Strong, Weak),
Setup>Posture (C Posture, Rigid Posture, Basic),
Setup>Stance (Wide, Narrow),
Setup>Ball Position (Forward, Back),
Setup>Knee Flex (Straight, Flexed),
Setup>Alignment (Open, Closed),
Turn>Upper Body (Sway Back, Sway Forward, Dropping, Basic),
Turn>Lower Body (Sway Back, Sway Forward, Basic),
Turn>Footwork (Rolling),
Turn>Tempo (Backswing, Downswing, Basic),
Lever>Hinge (Early, Late),
Lever>Lead Arm (Bent),
Lever>Trail Arm (Tucked, Flying),
Lever>Lead Wrist/Club Face (Bowed/Closed, Cupped/Open),
Lever>Trail Wrist (Flexed, Extended),
Path>Shaft (Steep, Shallow),
Path>Lead Arm (High, Low),
Release>Body Sequence (Hang Back, Sway Forward, Early Extension, Basic),
Release>Arms and Hands (Casting, Chicken Wing, Tucked, Flipping, Basic),
Release>Shaft (Over and Low, Over and High, Basic).

25. The system of claim 15, wherein a numeric scoring scale for instructors to use in scoring the aptitude of participants on individual movement subelements is a scale from 1 to 10 where 10 represents the greatest aptitude and 1 represents the least aptitude;

26. The system of claim 15, wherein numeric scores assigned by an instructor to participant movement subelements are associated with a pass or fail status obtained from a mapping table mapping participants' normalized average performance score selection to a set of numeric scores associated with passing and a set of numeric score associated with failing; wherein a numeric threshold to pass is lower for players with poorer average performance scores than other players for whom numeric threshold to pass is higher.

27. The system of claim 15, wherein the index score improves each time the participant passes a personalized lesson on their multi-lesson roadmap of instruction.

28. The system of claim 15, wherein the at least one processor is further configured to retroactively fail a lesson based on additional feedback from the trained instructor, wherein the retroactive failing locks previously unlocked lessons.
